(19) United States
(12) Patent Application Publication
(10) Pub. No.: US 2012/0236821 A1
(43) Pub. Date: Sep. 20, 2012

(54) RADIO BASE STATION APPARATUS, AND DATA FORWARDING METHOD IN RADIO BASE STATION APPARATUS

(75) Inventors: Tadashi YAMADA, Kawasaki (JP); Takeshi Kunugi, Kawasaki (JP); Reiko Hattori, Kawasaki (JP); Noboru Hasegawa, Kawasaki (JP)

(73) Assignee: FUJITSU LIMITED, Kawasaki-shi (JP)

(21) Appl. No.: 13/358,613

(22) Filed: Jan. 26, 2012

(30) Foreign Application Priority Data
Mar. 17, 2011 (JP) 2011-58940
Sep. 14, 2011 (JP) 2011-200450

(51) Int. Cl. H04W 36/00

(52) U.S. Cl. 370/331

(57) ABSTRACT

A radio base station apparatus for performing radio communication with a mobile terminal apparatus, the radio base station apparatus including: a forwarding data determination unit which determines forwarding data which is to be forwarded to a handover destination radio base station apparatus, based on the presence or absence of retransmission of data to the mobile terminal apparatus; and a data forwarding processing unit which forwards the determined forwarding data to the handover destination radio base station apparatus.

### CROSS-REFERENCE TO RELATED APPLICATIONS

This application is based upon and claims the benefit of priority of the prior Japanese Patent Application No. 2011-058940, filed on Mar. 17, 2011, and the Japanese Patent Application No. 2011-200450, filed on Sep. 14, 2011, the entire contents of which are incorporated herein by reference.

### FIELD

The embodiments discussed herein are related to a radio base station apparatus, and a data forwarding method in the radio base station apparatus.

### BACKGROUND

At present, radio communication systems, such as mobile telephone systems or radio LANs (Local Area Networks), and the like, are used widely. Furthermore, in the field of radio communication, there are continuous discussions about next-generation communication technology in order to further improve communication speed and communication capacity. For example, the 3GPP (3rd Generation Partnership Project), which is one standardization group, is proposed a radio communication system called LTE (Long Term Evolution) and a radio communication system known as LTE-A (Long Term Evolution-Advanced), which is a development of LTE.

In the radio communication system, there is technology known as a handover. The handover is a technology for switching the radio base station apparatus (Evolved UTRAN NodeB (ENB), hereinafter called “base station”) to which a mobile terminal apparatus (Mobile Station, hereinafter called “terminal”) is connected. By this means, the terminal is able to perform a radio communication in a continuous fashion, by switching connection to another base station, when the received radio wave becomes weaker than a prescribed value.

In the handover, there are cases where data is not transmitted to the terminal from a handover source base station and the data is forwarded to a handover destination base station. By means of the forwarding, for example, the terminal is able to continue receiving data in a continuous fashion from the handover destination base station, when the terminal is switched connection to the handover destination base station.

There are, for instance, two methods for forwarding data between base stations by the handover. The first method is a method which forwards data that does not transmit to the terminal as forwarding data, to the handover destination base station (this method is called “mode 1” below). Furthermore, the second method is a method which forwards data for which an Ack signal (or a reception confirmation notification) does not receive from the terminal, as forwarding data, to the handover destination base station (this method is called “mode 2” below).

FIG. 29 and FIG. 30 are sequence diagrams which respectively illustrate operational examples of the forwarding method in the mode 1 and mode 2. In both of these examples, the terminal UE is connected to the serving base station S-ENB and performs handover to a target base station T-ENB as a handover destination. Furthermore, in both of these cases, it is supposed that the serving base station S-ENB receives three SDUs (Service Data Units, SDU-A to SDU-C) from a gateway GW, and of these transmits the data in SDU-A to the terminal UE. SDU-A includes PDUs (Protocol Data Units) having sequence numbers SN1 to SN6, and SDU-B includes PDUs having sequence numbers SN7 to SN13. In both of the examples, it is supposed that the serving base station S-ENB transmits PDUs having sequence numbers SN1 to SN6 to the terminal UE, and receives Ack signals relating to the PDUs having sequence numbers SN1 to SN3.

Under circumstances such as these, in mode 1, untransmission data is set as forwarding data regardless of the presence or absence of an Ack signal, and therefore in the example in FIG. 29, the PDUs from SN7 onwards which belong to the SDU-B are set as forwarding data. In this case, the serving base station S-ENB reports the sequence number SN7 to the target base station T-ENB (S104), and forwards SDU-B and SDU-C (S105). The base station T-ENB transmits PDUs from sequence number SN7 onwards to the terminal UE (S106).

On the other hand, in mode 2, the data for which an Ack signal does not be received is set as forwarding data, and therefore in the example in FIG. 30, the PDUs from sequence number SN4 onwards are set as forwarding data. In this case, the serving base station S-ENB reports the sequence number SN4 to the target base station T-ENB (S110), and forwards the data of SDU-A, SDU-B and SDU-C including the PDU having sequence number SN4 (S111). The base station T-ENB transmits the PDUs from sequence number SN4 onwards, to the terminal UE (S106).
Patent Document 1: Japanese Laid-open Patent Publication No. 2009-267840
Patent Document 2: Japanese Laid-open Patent Publication No. 2000-69522
Patent Document 3: Japanese Laid-open Paten Publication No. 2006-217219
Patent Document 4: Japanese Laid-open Patent Publication No. 2007-96968

However, in the case of mode 1, data which the terminal UE may not be able to receive is not forwarded from the serving base station S-ENB to the target base station T-ENB, and hence there are cases where loss of data occurs at the terminal UE.

For example, in the example in FIG. 29, the serving base station S-ENB does not confirm reception of Ack signals in respect of the PDUs having sequence numbers SN4 to SN6. Consequently, there is a possibility that the terminal UE does not be able to receive the PDUs having sequence numbers SN4 to SN6. In a situation such as this, even if the serving base station S-ENB forwards the sequence number SN7 onwards, it does not forward the PDUs having sequence numbers SN4 to SN6 which may possibly not be received by the terminal UE, and therefore the terminal UE is not able to receive the PDUs having sequence numbers SN4 to SN6. Consequently, in the case of mode 1, there are situations were the PDUs having sequence numbers SN4 to SN5 are lost at the terminal UE.

On the other hand, in the case of mode 2, there are situations where data for which the terminal UE may transmits an Ack signal is forwarded from the serving base station S-ENB to the target base station T-ENB. Accordingly, there are cases where the base station T-ENB transmits data to the terminal UE in a duplicated fashion, and the terminal UE receives the data in a duplicated fashion.

For instance, in the example in FIG. 30, since the serving base station S-ENB does not receive an Ack signal in respect of the PDUs having sequence numbers SN4 to SN6, then the serving base station S-ENB forwards the PDUs having sequence numbers from SN4 onwards, to the target base station T-ENB. In cases such as these, for example, the terminal UE may receives the PDUs having sequence numbers SN4 to SN6 correctly and transmitted Ack signals. There are cases where the serving base station S-ENB makes a handover decision and forwards data before confirming reception of the Ack signals. In a situation such as this, even though the serving base station S-ENB forwards the PDUs having sequence numbers from SN4 onwards to the target base station T-ENB, the PDUs having sequence numbers SN4 to SN6 which may receive by the terminal UE, are also forwarded. Therefore, the base station T-ENB transmits the PDUs having sequence numbers SN4 to SN6 in duplicated fashion to the terminal UE, and the terminal UE also receives the PDUs having sequence numbers SN4 to SN6 in duplicated fashion. If the terminal UE receives data in a duplicated fashion, then the terminal needs to perform unnecessary processing, such as processing for discarding this data, and the like.

### SUMMARY

According to an aspect of the invention, a radio base station apparatus for performing radio communication with a mobile terminal apparatus, the radio base station apparatus including: a forwarding data determination unit which determines forwarding data which is to be forwarded to a handover destination radio base station apparatus, based on the presence or absence of retransmission of data to the mobile terminal apparatus; and a data forwarding processing unit which forwards the determined forwarding data to the handover destination radio base station apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the composition of a radio communication system;

FIG. 2 is a diagram illustrating an example of the composition of a radio communication system;

FIG. 3 is a diagram illustrating an example of the composition of a radio base station apparatus;

FIG. 4 is a diagram illustrating an example of the composition of a mobile terminal apparatus;

FIG. 5 is a sequence diagram illustrating an operational example in a radio communication system;

FIG. 6 is a diagram illustrating an example of a retransmission information table;

FIG. 7 is a sequence diagram illustrating an operational example in a radio communication system;

FIG. 8 is a sequence diagram illustrating an operational example in a radio communication system;

FIG. 9A and FIG. 9B are flowcharts illustrating operational examples of a forwarding data determination process;

FIG. 10A and FIG. 10B are sequence diagrams illustrating an operational example in a radio communication system;

FIG. 11 is a sequence diagram illustrating an operational example in a radio communication system;

FIG. 12 is a sequence diagram illustrating an operational example in a radio communication system;

FIG. 13A is a diagram illustrating an example of a statistical information table and FIG. 13B is a diagram illustrating an example of judgment of radio quality;

FIG. 14 is a diagram illustrating an example of the composition of a cell;

FIG. 15 is a sequence diagram illustrating an operational example in a radio communication system;

FIG. 16 is a sequence diagram illustrating an operational example in a radio communication system;

FIG. 17A is a diagram illustrating an example of a radio wave condition table and FIG. 17B is a diagram illustrating an example of judgment of radio quality;

FIG. 18 is a diagram illustrating an example of the composition of a cell;

FIG. 19 is a sequence diagram illustrating an operational example in a radio communication system;

FIG. 20 is a sequence diagram illustrating an operational example in a radio communication system;

FIG. 21 is a flowchart illustrating an operational example of a forwarding data determination process;

FIG. 22 is a diagram illustrating an example of forwarding data;

FIG. 23 is a sequence diagram illustrating an operational example in a radio communication system;

FIG. 24 is a diagram illustrating an example of forwarding data;

FIG. 25 is a sequence diagram illustrating an operational example in a radio communication system;

FIG. 26 is a sequence diagram illustrating an operational example in a radio communication system;

FIG. 27 is a sequence diagram illustrating an operational example in a radio communication system;

FIG. 28 is a diagram illustrating an example of the composition of a radio communication system;

FIG. 29 is a sequence diagram illustrating an operational example in a radio communication system;

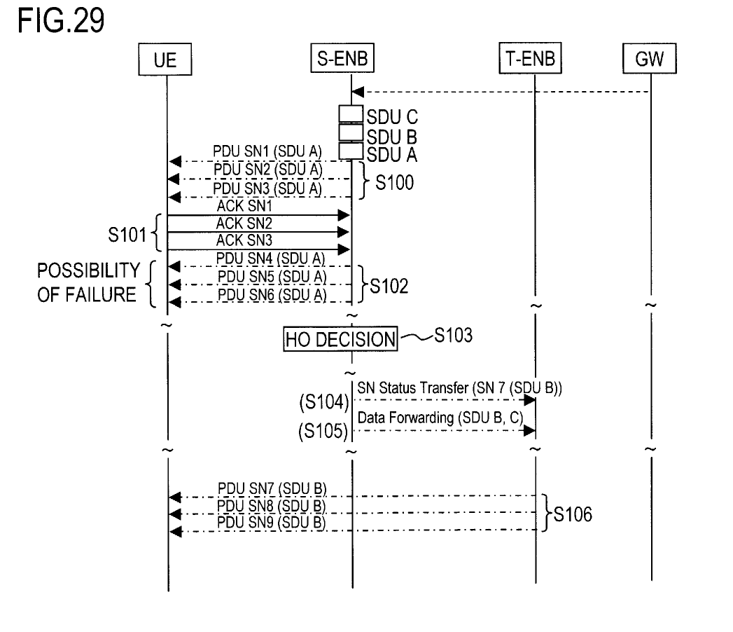

FIG. 30 is a sequence diagram illustrating an operational example in a radio communication system;

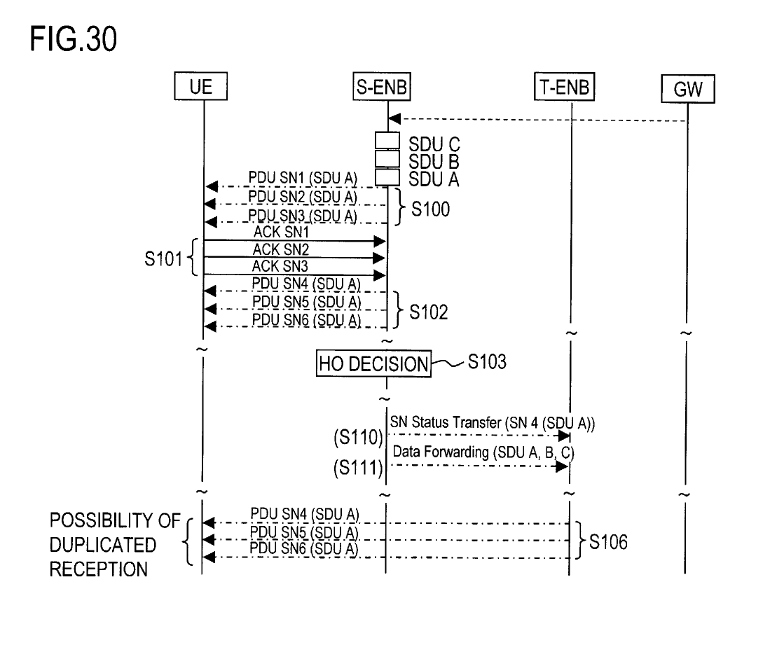

FIG. 31 is a sequence diagram illustrating an operational example in a radio communication system;

FIG. 32 is a diagram illustrating an example of SDUs to be forwarded;

FIG. 33 is a sequence diagram illustrating an operational example in a radio communication system;

FIG. 34 is a diagram illustrating an example of a retransmission information table;

FIG. 35 is a flowchart illustrating an example of transmission possible/not possible judgment processing;

FIG. 36A and FIG. 36B are sequence diagrams respectively illustrating operational examples in a radio communication system;

FIG. 37 is a flowchart illustrating an operational example of a forwarding data determination process;

FIG. 38 is a sequence diagram illustrating an operational example in a radio communication system;

FIG. 39 is a flowchart illustrating an operational example of a forwarding data determination process;

FIG. 40 is a sequence diagram illustrating an operational example in a radio communication system;

FIG. 41 is a sequence diagram illustrating an operational example in a radio communication system;

FIG. 42 is a flowchart illustrating an operational example of a forwarding data determination process;

FIG. 43 is a diagram illustrating an example of forwarding data;

FIG. 44 is a sequence diagram illustrating an operational example in a radio communication system;

FIG. 45 is a sequence diagram illustrating an operational example in a radio communication system;

FIG. 46 is a sequence diagram illustrating an operational example in a radio communication system;

FIG. 47 is a sequence diagram illustrating an operational example in a radio communication system;

FIG. 48 is a sequence diagram illustrating an operational example in a radio communication system;

FIG. 49 is a sequence diagram illustrating an operational example in a radio communication system;

FIG. 50 is a sequence diagram illustrating an operational example in a radio communication system;

FIG. 51 is a sequence diagram illustrating an operational example in a radio communication system;

FIG. 52 is a sequence diagram illustrating an operational example in a radio communication system;

FIG. 53 is a sequence diagram illustrating an operational example in a radio communication system;

FIG. 54 is a sequence diagram illustrating an operational example in a radio communication system;

FIG. 55 is a sequence diagram illustrating an operational example in a radio communication system; and

FIG. 56 is a diagram illustrating an example of forwarding data.

### DESCRIPTION OF EMBODIMENTS

Below, embodiments of the present invention will be described.

### First Embodiment

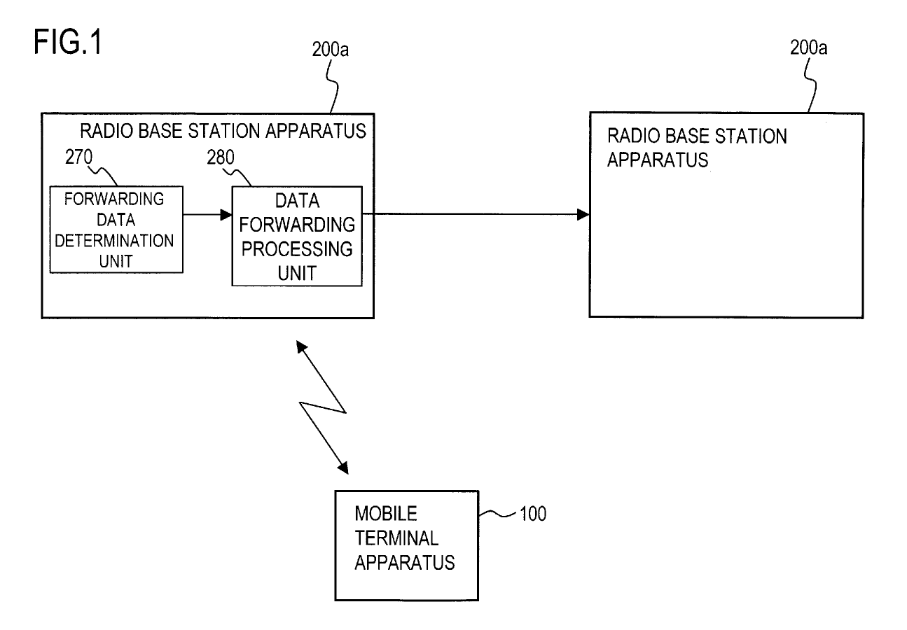

To begin, a first embodiment of the invention will be described. FIG. 1 is a diagram illustrating an example of the composition of a radio communication system 10 according to a first embodiment. The radio communication system 10 includes the radio base station apparatuses 200a and 200b and a mobile terminal apparatus 100.

The mobile terminal apparatus 100 is able to perform radio communication with the radio base station apparatuses 200a and 200b, and is able to switch a radio connection from the handover source radio base station apparatus 200a to the handover destination radio base station apparatus 200b.

The radio base station apparatus 200a includes a forwarding data determination unit 270 and a data forwarding processing unit 280.

The forwarding data determination unit 270 can determine forwarding data which is to be forwarded to the handover destination radio base station apparatus 200b, based on the presence or absence of a data retransmission to the mobile terminal apparatus 100. Furthermore, the forwarding data determination unit 270 can also determine forwarding data to be forwarded to the handover destination radio base station apparatus 200b, based on the radio quality in relation to the mobile terminal apparatus 100. Moreover, the forwarding data determination unit 270 is also able to determine forwarding data to be forwarded to the handover destination radio base station apparatus 200b, based on the presence or absence of the data retransmission to the mobile terminal apparatus 100 and the radio quality in relation to the mobile terminal apparatus 100.

The data forwarding processing unit 280 is able to forward the determined forwarding data to the handover destination radio base station apparatus 200b.

In this way, the radio base station apparatus 200a determines forwarding data to be forwarded to the handover destination radio base station apparatus 200b, based on the presence or absence of the data retransmission to the mobile terminal apparatus 100. Consequently, for example, when the data retransmission is performed, the data which is the object of the retransmission (retransmission data) is set as forwarding data, and therefore the mobile terminal apparatus 100 is also able to receive the retransmission data from the handover destination radio base station apparatus 200b and loss of data can be prevented. Furthermore, if the data retransmission does not be performed, for instance, then data which does not be transmitted from the radio base station apparatus 200a to the mobile terminal apparatus 100 is set as forwarding data, and it is possible to prevent duplicated transmission of data by the radio base station apparatus 200b and duplicated reception of data by the mobile terminal apparatus 100.

Furthermore, the radio base station apparatus 200a determines forwarding data to be forwarded to the handover destination radio base station apparatus 200b, based on the radio quality in relation to the mobile terminal apparatus 100. Consequently, if the radio quality is not good, for example, then data which is transmitted from the radio base station apparatus 200a is also set as forwarding data, and therefore it is possible to prevent loss of data, because the mobile terminal apparatus 100 receives this data from the handover destination radio base station apparatus 200b. Furthermore, if the radio quality is good, for example, then data which does not be transmitted from the radio base station apparatus 200a to the mobile terminal apparatus 100 is set as forwarding data, and thus it is possible to prevent duplicated transmission of data by the radio base station apparatus 200b and duplicated reception of data by the mobile terminal apparatus 100.

Moreover, the radio base station apparatus 200a determines forwarding data to be forwarded to the handover destination radio base station apparatus 200b, based on the presence or absence of the data retransmission to the mobile terminal apparatus 100 and the radio quality in relation to the mobile terminal apparatus 100. Consequently, if the data retransmission does not be performed and the radio quality is good, for example, then data which does not be transmitted from the radio base station apparatus 200a to the mobile terminal apparatus 100 is set as forwarding data. Accordingly, it is possible to prevent duplicated transmission of data by the radio base station apparatus 200b and duplicated reception of data by the mobile terminal apparatus 100. Furthermore, if the data retransmission does not be performed but the radio quality is not good, or if the data retransmission is performed, for example, then the data transmitted from the radio base station apparatus 200a is set as forwarding data. Accordingly, the mobile terminal apparatus 100 receives this data from the handover destination radio base station apparatus 200b and hence it is possible to prevent loss of data.

### Second Embodiment

### Example of General Composition

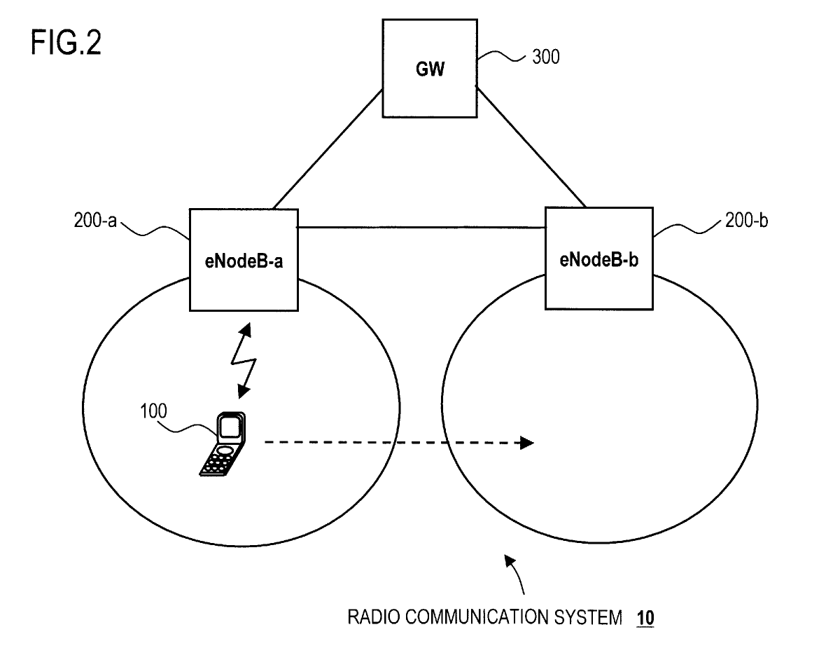

Next, a second embodiment will be described. FIG. 2 is a diagram illustrating an example of the composition of a radio communication system 10. The radio communication system 10 includes a mobile terminal apparatus (Mobile Station, hereinafter called “terminal”) 100, radio base station apparatuses (Evolved UTRAN NodeB (ENB), hereinafter called “base station”) 200a and 200b, and a serving gateway (hereinafter called “gateway”) 300.

The base stations 200a and 200b are radio communication apparatuses which perform radio communication with the terminal 100. The base stations 200a and 200b are connected by wire to the gateway 300, and are able to transmit and receive data signals (hereinafter, called “data”) to and from the gateway 300 and the terminal 100. Furthermore, the base stations 200a and 200b are also able to forward data between each other. In the example in FIG. 1, two base stations 200a and 200b are depicted, but there may be three or more base stations.

The terminal 100 is a radio communication apparatus, such as a mobile telephone, portable information terminal apparatus, or the like, which carries out radio communication by radio connection with the base stations 200a and 200b. The terminal 100 is able to receive data transmitted from the base stations 200a and 200b, by radio communication. Furthermore, the terminal 100 is also able to transmit data to the base stations 200a and 200b, by radio communication. In the present specification, the direction from the base stations 200a and 200b to the terminal 100 is a called a “down link” (DL) and the direction from the terminal 100 to the base stations 200a and 200b is called an “up link” (UL). In the example in FIG. 1, only one terminal 100 is depicted, but there may also be a plurality of terminals 100 which have a radio connection with the base station 200a, and one or a plurality of terminals 100 which have a radio connection with the base station 200b.

In the example in FIG. 1, the two base stations 200a and 200b both have the same composition, and are described as base station 200, unless determined otherwise. The example in FIG. 1 depicts a situation where the terminal 100 performs radio communication with the base station 200a in the range of the cell of the base station 200a, and moves to the range of the cell of the base station 200b, which is an adjacent base station.

<Examples of Composition of Base Station 200 and Terminal 100>

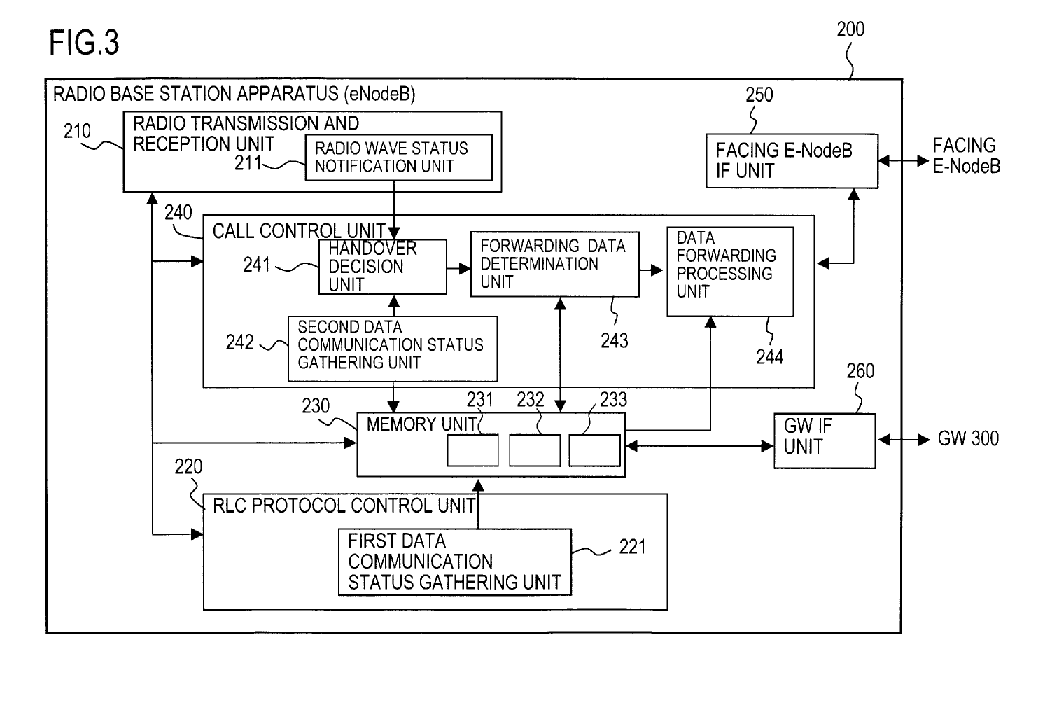

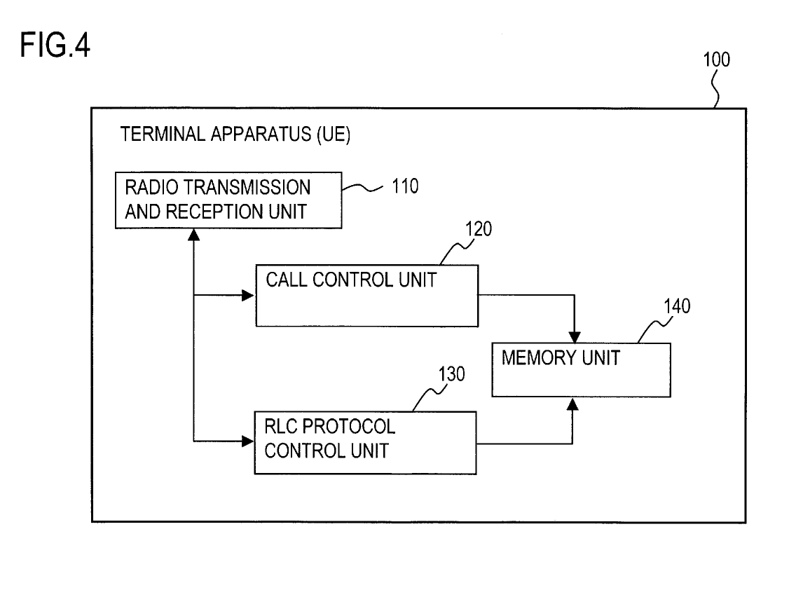

Next, respective examples of the composition of the base station 200 and the terminal 100 will be described. FIG. 3 is a diagram illustrating the base station 200 relating to the second embodiment of the invention, and FIG. 4 is a diagram illustrating an example of the composition of the terminal 100.

The base station 200 includes a radio transmission and reception unit 210, an RLC protocol control unit 220, a memory unit 230, a call control unit 240, a facing E-NodeB IF unit (hereinafter, called “facing ENB IF unit”) 250, and a GW IF unit 260.

The radio transmission and reception unit 210 transmits a radio signal to the terminal 100 and receives a radio signal transmitted from the terminal 100. The radio transmission and reception unit 210, for example, is able to read out data stored in the memory unit 230, convert the data to a radio signal by applying error correction encoding processing, modulation processing, frequency conversion processing, and the like, to the data, and then transmit the radio signal to the terminal 100. Furthermore, upon receiving a radio signal from the terminal 100, for example, the radio transmission and reception unit 210 is able to extract data by applying frequency conversion process, demodulation processing and error correction decoding processing, and the like, to the radio signal, and then output this data to the RLC protocol control unit 220. Moreover, if the radio signal received from the terminal 100 is an Ack signal (reception notification), then the radio transmission and reception unit 210 is able to output the Ack signal to the RLC protocol control unit 220. The Ack signal is, for example, a response signal when data transmitted from a transmitter side, or the like, is received correctly on a receiver side, and may also be called an affirmative response or a confirmation response, or the like. For example, besides being a response signal relating to data, the Ack signal may also be a response signal relating to a control signal transmitted by the base station 200 to the terminal 100.

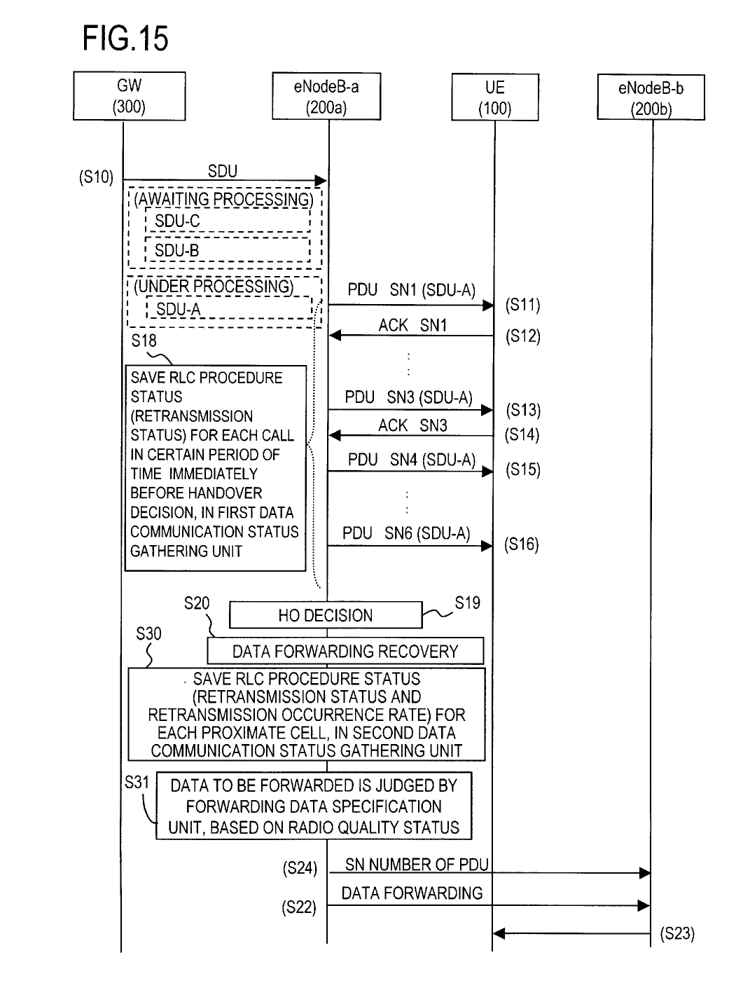

Furthermore, the radio transmission and reception unit 210 includes a radio wave condition notification unit 211. When the base station 200 is received a signal (or message) indicating “Measurement Reports” transmitted from the terminal 100, for example, the radio wave condition notification unit 211 extracts the radio quality between terminal 100 and the base station 200. The radio wave information notification unit 211 reports the extracted radio quality to the handover decision unit 241. Furthermore, the radio wave information notification unit 211 is also able to hold the extracted radio quality in a radio wave condition table 233 which is stored in the memory unit 230. Alternatively, the radio wave condition notification unit 211 is able to measure the radio quality of each adjacent cell (or adjacent area), based on the radio signal of the Ack signal, or the like, which is received from the terminal 100, and hold the measured radio quality in the radio wave condition table 233 in the memory unit 230. For example, the radio wave condition notification unit 211 is able to hold the radio quality in terms of the electrical power of a received radio signal, or the noise in relation to this power, in the radio wave condition table 233. FIG. 15 illustrates an example of a radio wave condition table 233, the details of which are described hereinafter.

The RLC protocol control unit 220 stores the data output from the radio transmission and reception unit 210, in the memory unit 230, judges whether or not there is the data retransmission, based on an Ack signal output from the radio transmission and reception unit 210, and implements retransmission control if there is to be the retransmission. For example, if an Ack signal is input from the radio transmission and reception unit 210 within a first threshold time period after the radio transmission and reception unit 210 is transmitted data to the mobile terminal apparatus 100, then the RLC protocol control unit 220 decides not to perform the data retransmission. On the other hand, if an Ack signal was not received within a first threshold time period after the data is transmitted, then the RLC protocol control unit 220 decides to perform the data retransmission. Upon deciding to perform the data retransmission, the RLC protocol control unit 220 reads out the retransmission data from the memory unit 230 and outputs the data to the radio transmission and reception unit 210, whereby the data is transmitted (or retransmitted) to the terminal 100.

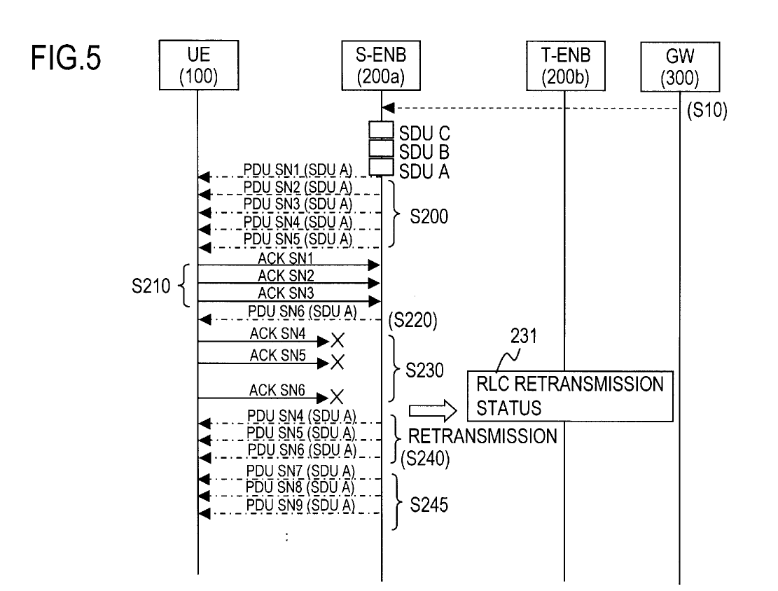

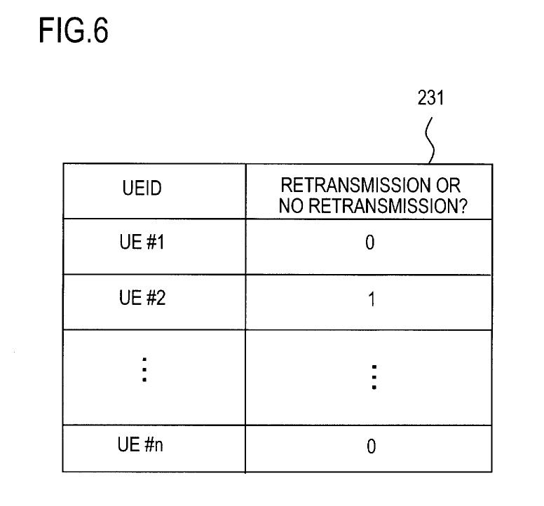

Moreover, the RLC protocol control unit 220 also includes a first data communication condition gathering unit 221. The first data communication condition gathering unit 221 saves the condition in which the retransmission occurred, for each call, in a retransmission information table 231 inside the memory unit 230. FIG. 5 illustrates an example of a situation where the retransmission is occurred, and FIG. 6 illustrates an example of the retransmission information table 231.

In the example in FIG. 5, the serving base station (S-ENB) 200a receives data of SDU-A to SDU-C from the gateway (GW) 300 (S10), and the serving base station 200a transmits the respective data of SDU-A to SDU-C to the terminal 100, in PDU units. An SDU is a unit of data which is, for example, transmitted from the gateway 300 to the base station 200a or transmitted between the base stations 200a and 200b. One or a plurality of PDUs are included in a SDU, and the base station 200a, for example, is able to transmit data to the terminal 100 in PDU units. In the present specification, one SDU includes six PDUs, and SDU-A includes PDUs having sequence numbers SN1 to SN6, SDU-B includes PDUs having sequence numbers SN7 to SN13, and SDU-C includes PDUs having sequence numbers SN14 to SN20. For example, since each SDU includes one or a plurality of PDUs, then an SDU can be regarded as a data group. In the following description, where appropriate, a base station which is the source of a handover, to which a terminal 100 is connected, is called a serving base station, and a base station which is the destination of the handover, is called a target base station. When the terminal 100 is switched base station connection by means of a handover, then the target base station becomes the serving base station.

In the example in FIG. 5, the base station 200a transmits the PDUs having sequence numbers SN1 to SN6, to the terminal 100 (S200, S220), and receives Ack signals corresponding to the PDUs having sequence numbers SN1 to SN3 (S210). Here, the base station 200a does not be able to detect reception of Ack signals for the sequence numbers SN4 to SN6 within a first threshold time period (S230), and is therefore retransmitted PDUs having sequence numbers SN4 to SN6 (S240). The control of undetected Ack signals and retransmitting of PDUs is implemented by the RLC protocol control unit 220.

FIG. 6 is a diagram illustrating an example of the retransmission information table 231 created by the first data communication condition gathering unit 221, in a situation such as this. A flag indicating whether or not a retransmission is occurred is stored for each call (or each terminal 100), in the retransmission information table 231. In the example in FIG. 6, an identification ID of the terminal 100 and a flag indicating the presence or absence of the retransmission are stored; a flag indicating that the retransmission does not be performed (for example, “0”) is stored in respect of the terminal UEID#1, and a flag indicating that the retransmission is performed (for example, “1”) is stored in respect of the terminal UEID#2. It is also possible to store the presence or absence of the retransmission within a monitoring period in the retransmission information table 231. In this case, for example, the first data communication condition gathering unit 221 is able to store the presence or absence of the retransmission for each call in the memory unit 230, read out the presence or absence of the retransmission during a monitoring time period back in time from the handover decision, and store this information in the retransmission information table 231.

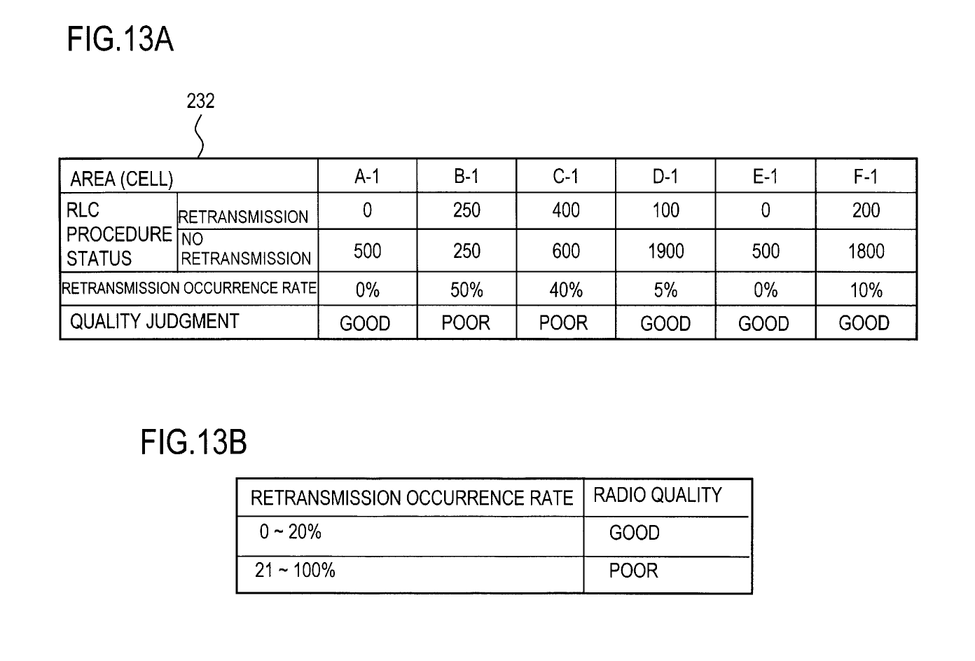

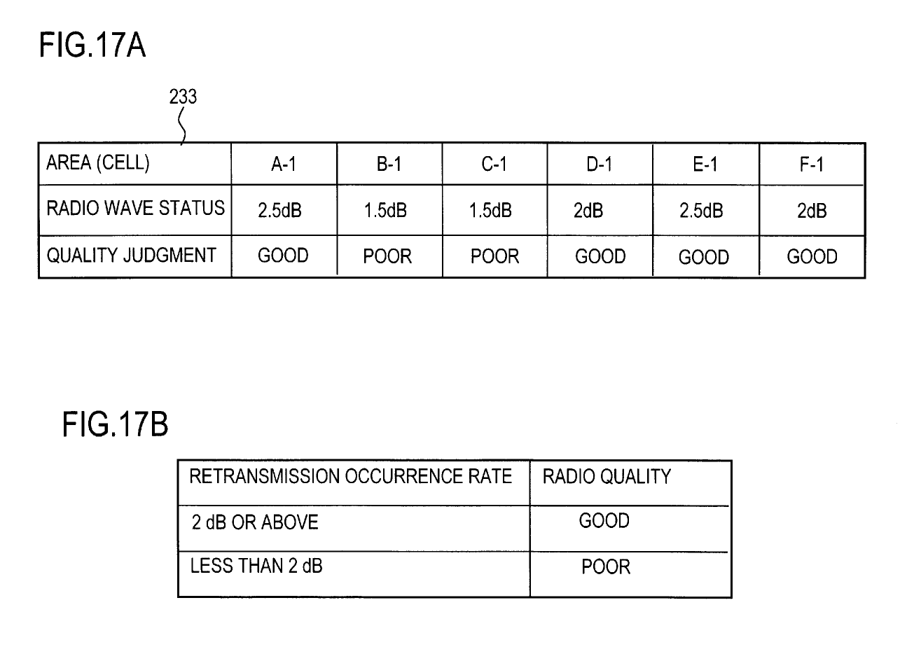

Returning to FIG. 3, the memory unit 230 stores data received by the radio transmission and reception unit 210 via the RLC protocol control unit 220, and data forwarded respectively from an adjacent base station or the gateway 300 via the GW IF unit 260 or the facing ENB IF unit 250, and the like. The stored data is read out as and when appropriate and transmitted from the radio transmission and reception unit 210 to the terminal 100, or forwarded from the data forwarding processing unit 244 to the target base station 200b which is the handover destination. As described above, the memory unit 230 stores the retransmission information table 231 (for example, FIG. 6), a statistical information table 232 (for example, FIG. 13A), and a radio wave condition table 233 (for example, FIG. 17A). The details of the statistical information table 232 and the radio wave condition table 233 are described hereinafter.

The call control unit 240 controls the transmission, reception and forwarding of data, and the like, between the terminal 100 and the gateway 300, and an adjacent base station 200. Furthermore, the call control unit 240 is able to read out (or recover) data from the memory unit 230, for example, and forward data to the adjacent base station 200b via the facing ENB IF unit 250. The call control unit 240 includes a handover decision unit 241, a second data communication condition gathering unit 242, a forwarding data determination unit 243 and a data forwarding processing unit 244.

The forwarding data determination unit 270 in the first embodiment corresponds, for example, to the radio wave condition notification unit 211, the first data communication condition gathering unit 221, and the second data communication condition gathering unit 242. Furthermore, the data forwarding processing unit 280 in the first embodiment corresponds to the data forwarding processing unit 244 and the facing ENB IF unit 250, for instance.

The handover decision unit 241 decides whether or not handover is necessary, and the handover destination, and the like, based on the radio quality reported by the radio wave condition notification unit 211. The handover decision unit 241 decides that handover is to be performed, if the reception power value measured by the terminal 100 as the radio quality is equal to or less than a second threshold value. Furthermore, the handover decision unit 241 determines the base station 200 having the highest reception power value, of the reception power values in the other base stations 200 measured by the terminal 100, as the handover destination base station 200b. The handover decision unit 241 outputs the identification information of the handover destination base station 200b, and the like, to the forwarding data determination unit 243.

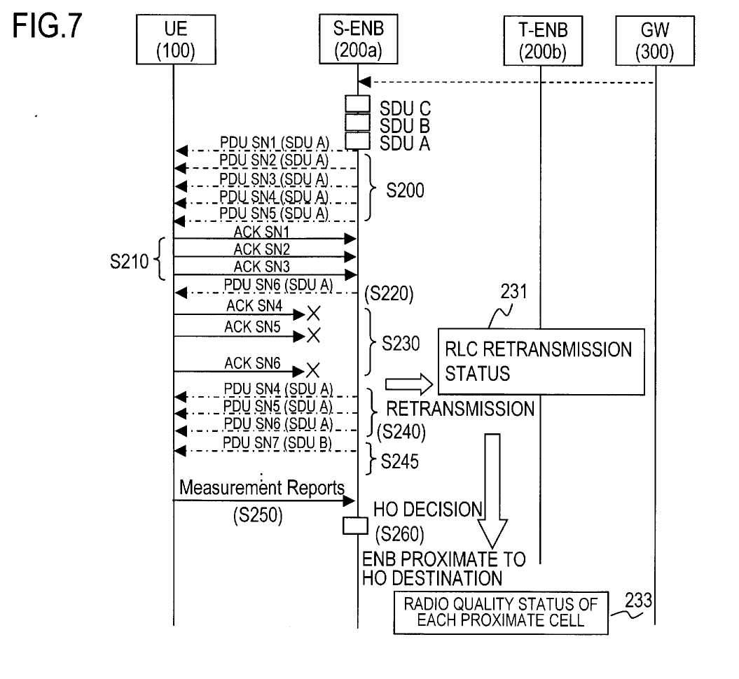

The second data communication condition gathering unit 242 gathers a data communication condition for each cell belonging to an adjacent base station 200 (hereinafter, called “adjacent cells”), and saves the gathered data communication condition as statistical information in the statistical information table 232 in the memory unit 230. FIG. 7 is a diagram illustrating an example of a situation where a statistical information table 232 is created. Similarly to the example in FIG. 5, the base station 200 retransmits the PDUs having sequence numbers SN4 to SN6 (S200 to S240). Thereupon, the base station 200 receives “Measurement Reports”, decides to carry out handover (S250, S260), and stores the data communication condition in the statistical information table 232, for each adjacent cell according to the retransmission information table 231. FIG. 13A illustrates an example of the statistical information table 232, and the details thereof are described hereinafter. For instance, if the retransmission is performed before a handover decision, then the second data communication condition gathering unit 242 counts up the “retransmission” items relating to the “cell” item of the handover destination. On the other hand, if the retransmission does not be performed before the handover decision, then the second data communication condition gathering unit 242 counts up the “no retransmission” items relating to that “cell” item.

Returning to FIG. 3, the forwarding data determination unit 243 determines the forwarding data that is to be forwarded to the handover destination base station 200b, by means of any one of the retransmission information table 231, the statistical information table 232 or the radio wave condition table 233, or a combination of these tables 231 to 233. The kind of data which is determined by the forwarding data determination unit 243 as forwarding data is described hereinafter. The forwarding data determination unit 243 outputs information relating to the determined forwarding data, such as an SDU identification number, for example, to the data forwarding processing unit 244.

The data forwarding processing unit 244 reads out the corresponding forwarding data from the memory unit 230 based on information relating to the forwarding data determined by the forwarding data determination unit 243, and outputs this forwarding data to the facing ENB IF unit 250.

The facing ENB IF unit 250 is an interface which is used when data, and the like, is transmitted and received to and from an adjacent base station 200b. The facing ENB IF unit 250 can, for example, convert the forwarding data output from the data forwarding processing unit 244 into a signal of a format that can be forwarded to the adjacent base station 200b (for example, an X2 format signal), and transmits the converted signal. Moreover, the facing ENB IF unit 250 can also receive a signal of this format transmitted from the adjacent base station 200b, extract data, and the like, and output this data to the call control unit 240.

The GW IF unit 260 is an interface which is used when data, and the like, is transmitted and received to and from the gateway 300. The GW IF unit 260 can, for example, convert data stored in the memory unit 230 into a signal of a format that can be forwarded to the gateway 300 (for example, the S1 format signal) and transmits this signal. Furthermore, the GW IF unit 260 is able to receive a signal of this format transmitted from the gateway 300, extract the data, and store the data in the memory unit 230.

Next, an example of the composition of the terminal 100 will be described. As illustrated in FIG. 4, for instance, the terminal 100 includes a radio transmission and reception unit 110, a call control unit 120, a RLC protocol control unit 130 and a memory 140.

The radio transmission and reception unit 110 is able to receive a radio signal transmitted from the base station 200, and is also able to transmit a radio signal to the base station 200. The radio transmission and reception unit 110, for example, receives a radio signal transmitted from the base station 200, applies frequency conversion processing, demodulation processing, error correction decoding processing, and the like, to the received radio signal, and extracts data, a control signal, and the like, from the radio signal. Furthermore, the radio transmission and reception unit 110 applies error correction encoding processing, modulation processing, frequency conversion processing, and the like, to the data, and the like, output from the call control unit 120, and converts the data to a radio signal.

The call control unit 120 decides what kind of data to transmit to the base station 200, and the like. The call control unit 120 can store the data output from the radio transmission and reception unit 110, for example, in the memory unit 140, and can also read out data to be transmitted to the base station 200, from the memory unit 140, and output this data to the radio transmission and reception unit 110.

The RLC protocol control unit 130 judges whether or not it is possible to correctly decode the data or control signal received by the radio transmission and reception unit 110, based on an error detection code, such as a CRC (Cyclic Redundancy Check), which is appended to the data, for example. For instance, if the RLC protocol control unit 130 judged that the data or signal is decoded correctly, then it generates an Ack signal and instructs the radio transmission and reception unit 110 to transmit this Ack signal to the base station 200. By this means, the terminal 100 is able to transmit an Ack signal to the base station 200. If the RLC protocol control unit 130 judges that the data or signal could not be decoded correctly, then it does not perform any particular action. In this case, it is possible to transmit a Nack signal, but from the viewpoint of making efficient use of radio resources, for example, it is supposed that the base station 200 does not transmit a Nack signal. Incidentally, a Nack signal is a response signal which is transmitted in cases where it does not be possible to receive data transmitted from the transmitter side, correctly on the receiver side, for example, and this signal may also be called a negative response, or the like.

The memory unit 140 is able to store data output from the call control unit 120 or to store whether or not an Ack signal output from the RLC protocol control unit 130 is transmitted. Data stored in the memory unit 140 can be read out as appropriate from the call control unit 120, or the like.

<Operational Examples>

Next, operational examples will be described. In these operational examples, as illustrated in FIG. 2, for instance, a serving base station 200a which is a handover source base station determines handover of a terminal 100, forwards data to a target base station 200b, which is a handover destination base station, and transmits the data to the terminal 100. In this example, the serving base station 200a decides to perform handover and the terminal 100 switches connection destination to the base station 200b in a situation where data that ought to be transmitted to the terminal 100 has not yet been transmitted. There are the following four patterns in the operational example. More specifically:

1) When forwarding data is determined based on the retransmission status which is held for each call;
2) When forwarding data is determined based on a data communication condition, such as the retransmission occurrence rate, which is held for each adjacent cell;
3) When forwarding data is determined based on the radio wave condition between the handover source base station 200a and the terminal 100; and
4) A combination of 1) to 3) above.
In 1) above, the serving base station 200a determines forwarding data by using the retransmission information table 231, in 2) the serving base station 200a determines forwarding data by using the statistical information table 232, and in 3) the serving base station 200a determines forwarding data by using the radio wave condition table 233. Moreover, in 4) the serving base station 200a determines the forwarding data based on a combination of the retransmission information table 231, the statistical information table 232 and the radio wave condition table 233. Below, these four operational examples are described independently (as first to fourth operational examples).

<First Operational Example>

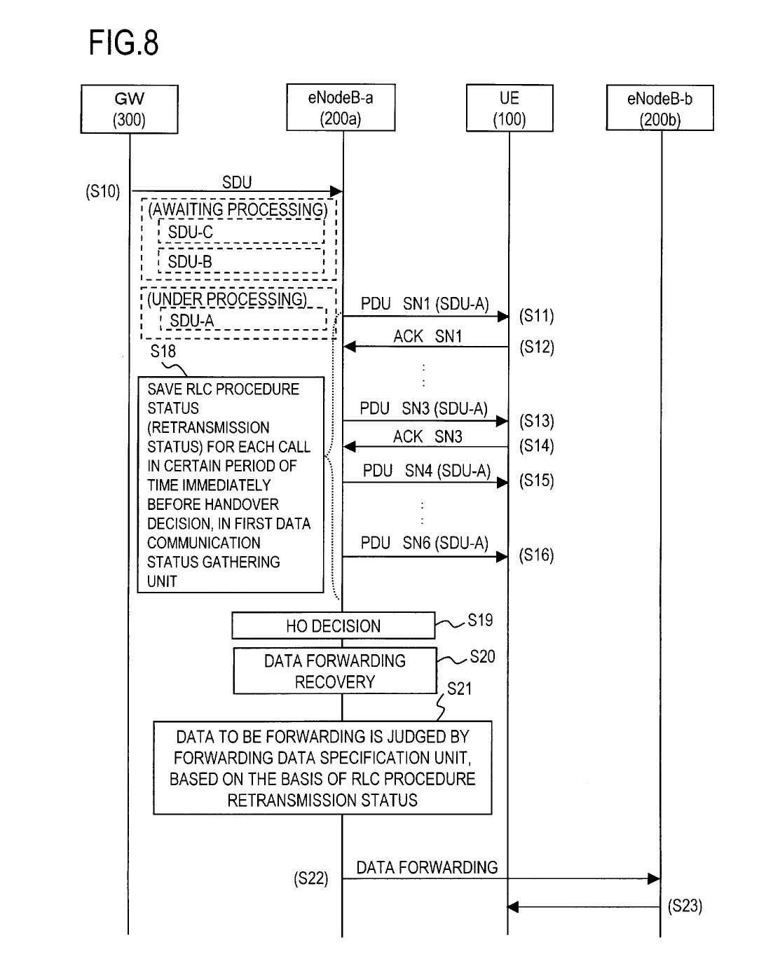

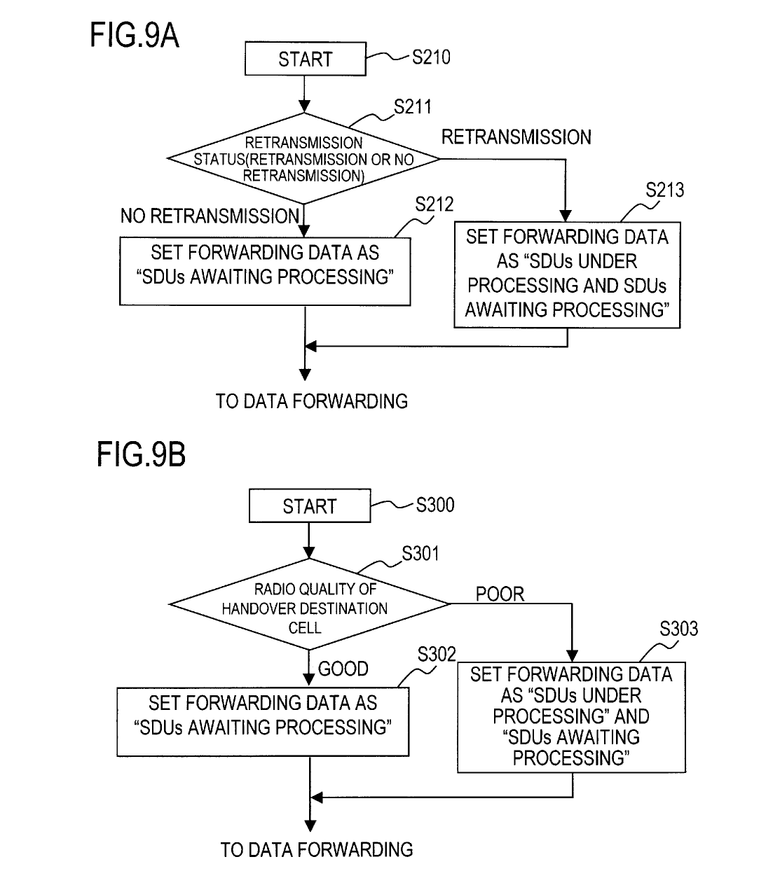

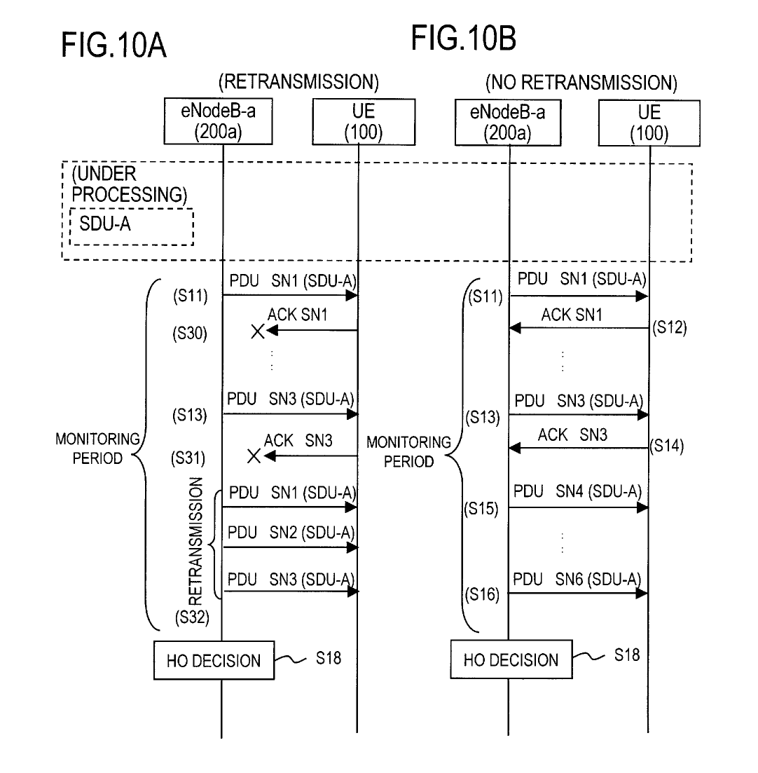

The first operational example is an example of operation in a case where forwarding data is determined based on the retransmission status which is held by the serving base station 200a for each call. FIG. 8, FIG. 9A and FIG. 10A and FIG. 10B respectively illustrate a sequence diagram or a flowchart of the first operational example. Of these, FIG. 8 illustrates a sequence diagram of the first operational example. The first operational example is now described with reference to FIG. 8.

Firstly, the serving base station (eNode-B) 200a receives data from SDU-A to SDU-C, from the gateway 300 (S10). In this case, the serving base station 200a stores the data of SDU-A to SDU-C in the memory unit 230, via the GW IF unit 260. Upon receiving an Ack signal in respect of a PDU transmitted to the terminal 100, for example, the RLC protocol control unit 220 of the serving base station 200a can delete the PDU corresponding to the Ack signal from the memory unit 230.

The serving base station 200a which is received the data of SDU-A to SDU-C transmits the data of SDU-A to the terminal (UE: User Equipment) 100, and sets the data of SDU-B and SDU-C to a state of awaiting processing. More specifically, the serving base station 200a transmits, to the terminal apparatus 100, PDUs having sequence numbers SN1 to SN6 which belong to SDU-A (S11, S13, S15 and S16), and receives Ack signals for sequence numbers SN1 to SN3 from the terminal 100 (S12 and S14). Furthermore, it is supposed that the serving base station 200a does not receive Ack signals for sequence numbers SN4 to SN6 from the terminal 100.

In a state such as this, the serving base station 200a saves the retransmission status of each call in the retransmission information table 231 (see FIG. 6, for example) during a monitoring period immediately before the handover decision (S18). As described above, for example, the first data communication condition gathering unit 221 stores information indicating whether or not the retransmission does not be performed, for each terminal 100, in the retransmission information table 231. The indication of whether or not there is the retransmission is made by means of the first data communication condition gathering unit 221 storing a “retransmission” flag in the retransmission information table 231, in respect of a call (or terminal 100) for which retransmission control is performed, when the retransmission control is performed by the RLC protocol control unit 220.

Next, the serving base station 200a decides to carry out handover (S19). For example, the handover decision unit 241 decides to carry out handover based on the radio quality included in a “Measurement Reports” message.

Thereupon, the serving base station 200a performs recovery of data forwarding (S20). For example, the call control unit 240 performs this processing by reading out data from the RLC protocol control unit 220 via the memory unit 230. The processing in this step S20 may be carried out after the forwarding data is determined by the processing in step S21.

Next, the serving base station 200a determines the forwarding data based on the retransmission status held for each call (S21). The forwarding data is determined based on the retransmission information table 231 by the forwarding data determination unit 243. FIG. 9A is a flowchart illustrating an example of operation in a forwarding data determination process according to the present operational example. This process is carried out by the serving base station 200a when transferred to the processing in S21.

Upon starting the forwarding data determination process (S210), the forwarding data determination unit 243 judges the retransmission status (S211). For example, in the retransmission information table 231 if a retransmission information flag is on in respect of the terminal 100 in question, then the forwarding data determination unit 243 determines that the retransmission is performed for that terminal 100 and returns a judgment of “retransmission”. On the other hand, in the retransmission information table 231 if the retransmission information flag is not on in respect of the terminal 100 in question, then the forwarding data determination unit 243 returns a judgment of “no retransmission”.

FIG. 10A illustrates a sequence example in the case of the “retransmission”, and FIG. 10B illustrates a sequence example in the case of “no retransmission”. In the example in FIG. 10A, the serving base station 200a was not able to confirm reception of an Ack signal in relation to the PDUs having sequence numbers SN1 to SN3, during the first threshold time period, and therefore is performed the retransmission in respect of the PDUs having sequence numbers SN1 to SN3 (S30 to S32). In this case, the retransmission information flag “1” is stored in the retransmission information table 231, and the forwarding data determination unit 243 returns the “retransmission” judgment.

On the other hand, in FIG. 10B, the serving base station 200a does not be confirmed reception of an Ack signal in respect of sequence numbers SN4 to SN6, but an actual retransmission does not be performed. This is the same situation as steps S11 to S16 in FIG. 8. In this case, the retransmission information flag in the retransmission information table 231 is “0”, and the forwarding data determination unit 243 judges “no retransmission”.

Returning to FIG. 9A, if the retransmission status is judged to be “no retransmission” (“no retransmission” at S211), then the serving base station 200a sets the “SDUs awaiting processing” which are scheduled to be transmitted subsequently to the data under processing, as the forwarding data (S212). In the case of “no retransmission”, for example, this indicates that the retransmission does not be performed in respect of all of the PDUs in the SDU, and the SDUs which are “awaiting processing” and for which processing for transmission to the terminal 200 has not yet been carried out may be forwarded to the target base station 200b. In the example in FIG. 10B, the retransmission does not be performed in respect of any of the sequence numbers SN1 to SN6, and therefore the forwarding data determination unit 243 sets “SDU-B” and the “SDU-C” as forwarding data. If the retransmission does not be performed, then the base station 200a determines that the data transmitted to the terminal 100 was received correctly in the terminal 100, and the serving base station 200a determines the data stored in the memory unit 230 which is to be transmitted to the terminal 100, as the forwarding data.

On the other hand, if the retransmission status is judged to be “retransmission” (“retransmission” at S211), then the serving base station 200a sets SDUs which are under processing and SDUs which are awaiting processing as the forwarding data (S213). For example, in the example in FIG. 10A, the forwarding data determination unit 243 sets “SDU-A”, which is an SDU under processing and “SDU-B” and “SDU-C”, which are SDUs awaiting processing, as the forwarding data. If the retransmission does not be performed, then the terminal 100 will not necessarily receive all of the PDUs included in the SDU after the retransmission. In cases such as these, the serving base station 200a sets SDUs which are under transmission processing or under retransmission processing, as forwarding data.

Returning to FIG. 8, when the serving base station 200a determines the forwarding data (S21), the forwarding data is forwarded to the target base station (eNodeB-b) 200b of the handover destination (S22). For example, the forwarding data determination unit 243 reports information about the determined forwarding data (for example, information identifying the SDUs, such as SDU-A and SDU-B), to the data forwarding processing unit 244, and the data forwarding processing unit 244 reads out the forwarding data from the memory unit 230. The recovery of data forwarding (S20) described above may be carried out by the processing in S21, for example. In the example (“retransmission”) in FIG. 10A, the serving base station 200a reads out the data of “SDU-A”, “SDU-B” and “SDU-C” from the memory unit 230, and transmits this data to the target base station 200b. Furthermore, in the example in FIG. 10B or FIG. 8 (“not retransmission”), the serving base station 200a reads out the data of “SDU-B” and “SDU-C” from the memory unit 230 and transmits this data to the target base station 200b.

Thereupon, the terminal 100 switches connection destination to the base station 200b, and the base station 200b which changes from a target base station to a serving base station transmits the forwarding data to the terminal 100 (S23). For instance, when the base station 200b receives forwarding data from the handover source base station 200a, the base station 200b stores the forwarding data in the memory unit 230 via the facing ENB IF unit 250 and the call control unit 240. The radio transmission and reception unit 210 reads out the forwarding data from the memory unit 230 and transmits this data to the terminal 100 by radio communication. In the case of the examples in FIG. 10A and FIG. 10B, for instance, if the data of SDU-A to SDU-C is forwarded as the “retransmission”, then the base station 200b sequentially transmits data from the sequence number SN1 of SDU-A, to the terminal 100, by radio communication. On the other hand, if the data of SDU-B and SDU-C is forwarded as “no retransmission”, for instance, then the base station 200b sequentially transmits data from sequence number SN7 of SDU-B, to the terminal 100, by radio communication.

In this way, in the first operational example, when the retransmission is performed, the data of sequence number SN1 belonging to SDU-A onwards, for example, is forwarded to the target base station 200b, and therefore, after handover, the terminal 100 is able to receive the data of sequence number SN1 onwards, from the base station 200b. Consequently, if the retransmission is performed, then the data that was the object of the retransmission is also forwarded, and therefore no data loss occurs, even if a handover is performed since the terminal 100 can receive the data subjected to the object of the retransmission from the handover base station 200b. Moreover, when the retransmission does not be performed, then data from the sequence number SN7 awaiting processing onwards is forwarded and transmitted to the terminal 100, and therefore the sequence numbers SN4 to SN6, for example, are not transmitted again from the base station 200b at the handover destination. Consequently, the PDUs having sequence numbers SN4 to SN6 are not transmitted in a duplicated fashion from the base station 200b, and the terminal 100 does not receive these PDUs in a duplicated fashion from the base station 200b.

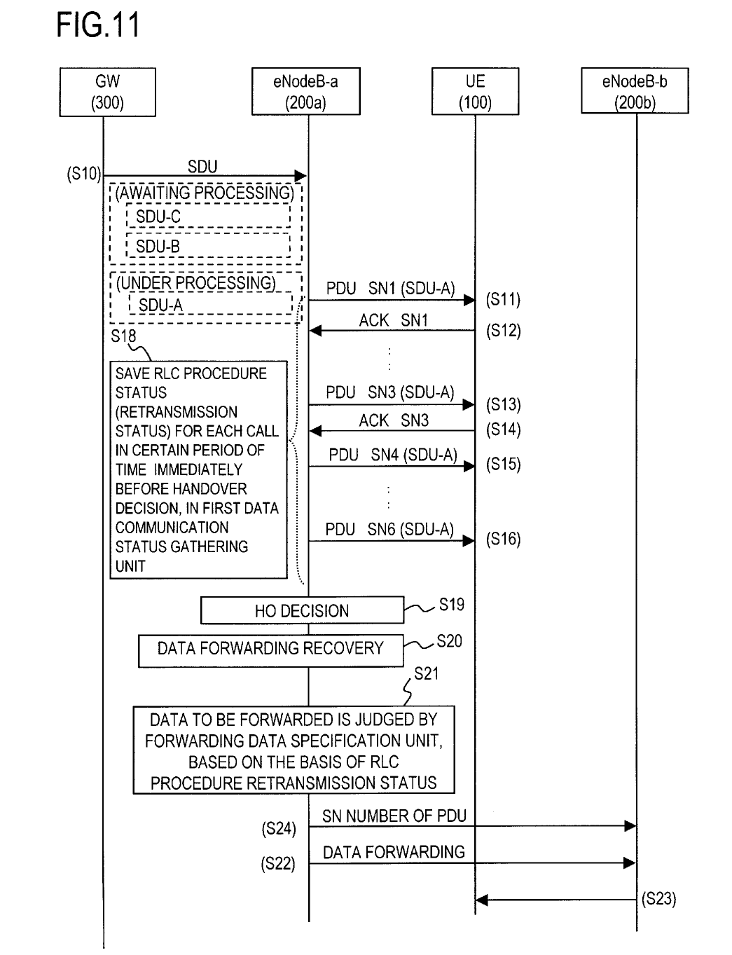

In the first operational example, when the serving base station 200a determines forwarding data and forwarded the data (S22), the sequence number of a PDU may also be reported. FIG. 11 is a diagram illustrating an example of a sequence when a sequence number is reported. The reported PDU sequence number (S24) represents, for example, the sequence number of the PDU from which the handover destination base station 200b starts transmission.

In this case, the first data communication condition gathering unit 221 stores the presence or absence of the retransmission, and the sequence number of PDUs which are the object of an Ack signal, in the retransmission information table 231. The forwarding data determination unit 243 reads out the presence or absence of the retransmission, and the sequence number of the PDU which is the object of the last Ack signal to be received before the handover decision, from the retransmission information table 231, and sets the sequence number following this sequence number as the sequence number to be reported.

For example, in the example in FIG. 10A (the “retransmission” example), the sequence number of the PDU for which the last Ack signal was received before the handover decision is SN0, and therefore the sequence number SN1 which follows this is set as the sequence number to be reported.

On the other hand, in the case of “no retransmission”, SDUs awaiting processing are set as the forwarding data, and therefore the SDU which is to be transmitted to the terminal 100 first among the SDUs awaiting processing is set as the object SDU and the first sequence number belonging to this object SDU may be set as the sequence number to be reported. For example, in the example in FIG. 10B, SDU-B is the SDU which is transmitted first to the terminal 100, from among the forwarding data, and therefore the sequence number SN7 of the first PDU belonging to SDU-B may be set as the sequence number to be reported. The sequence of each PDU belonging to each of the SDUs is determined in advance and stored in the memory unit 230, or the like, and therefore the forwarding data determination unit 243 is able to use this information to determine the sequence numbers.

In this way, since the serving base station 200a reports the sequence number to the target base station 200b, then the handover destination base station 200b is able to transmit PDUs sequentially from the sequence number, to the terminal 100. Therefore, the base station 200b and the terminal 100 are able to further prevent duplicated transmission, duplicated reception and data loss, by confirming the sequence number, and so on.

<Second Operational Example>

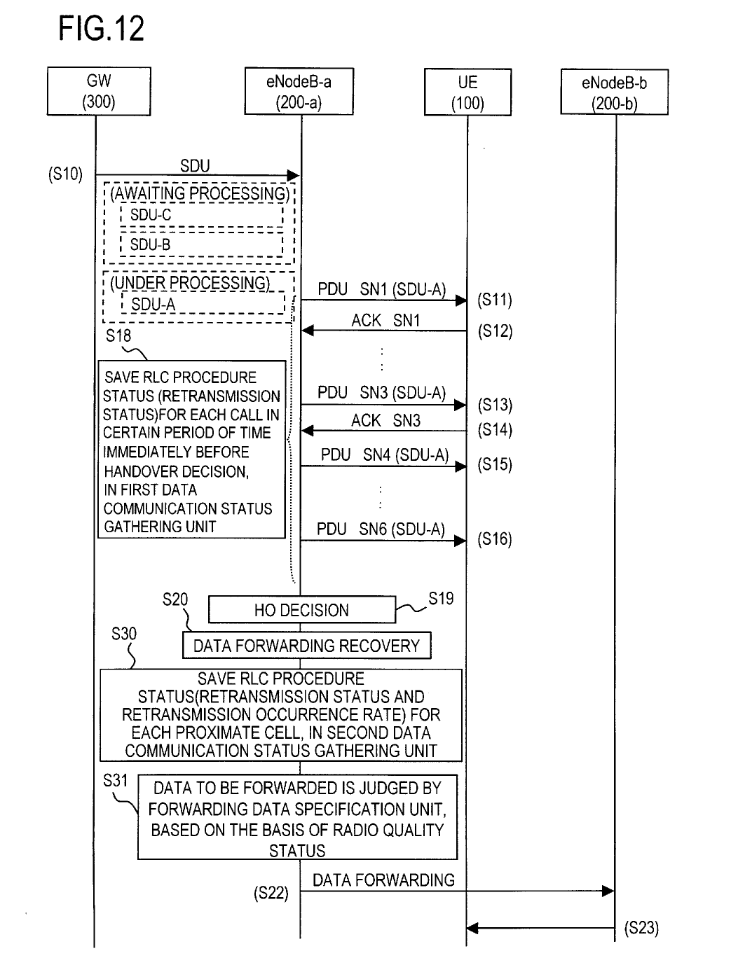

Next, a second operational example is described, which is an example of operation in a case where forwarding data is determined based on a data communication condition, such as the retransmission occurrence rate for each adjacent cell. In the second operational example, the statistical information table 232 is used. FIG. 9B, and FIG. 12 to FIG. 14 are diagrams illustrating examples, such as sequence examples based on the operational examples. Of these, FIG. 12 illustrates a sequence example of the second operational example, and hence the second operational example will be described with reference to FIG. 12.

As illustrated in FIG. 12, processing in relation to the data transmission status is similar to the first operational example described above. More specifically, the serving base station 200a transmits PDUs having sequence numbers SN1 to SN6, to the terminal 100, and of these, receives Ack signals in relation to the PDUs having sequence numbers SN1 to SN3. Moreover, the serving base station 200a is in a state where sequence numbers SN4 to SN6 are not resent (S10 to S16). Moreover, the serving base station 200a holds the retransmission status for each call in the retransmission information table 231 (S18).

Furthermore, similarly to the first operational example, the serving base station 200a decides to perform handover in respect of the terminal 100 (S19) and carries out data recovery (S20).

Moreover, the serving base station 200a stores the retransmission status and the retransmission occurrence rate for each adjacent cell in the statistical information table 232 (S30). This processing is carried out by the second data communication condition gathering unit 242, for example.

FIG. 13A is a diagram illustrating an example of a statistical information table 232. The statistical information table 232 includes the respective items of “RLC procedure status” (“retransmission” and “no retransmission”), “retransmission occurrence rate” and “quality judgment result”, for each adjacent area (or cell, hereinafter called “adjacent cell”).

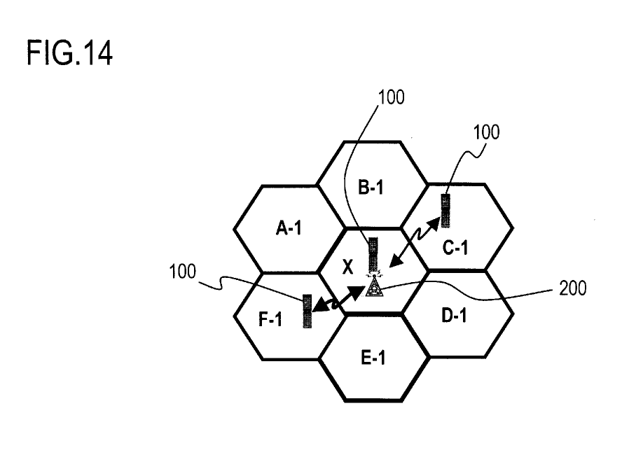

In relation to the adjacent cells, a cell of an adjacent base station to which it is possible to transfer by handover from the target base station 200a is stored as an “adjacent cell” in the statistical information table 232. FIG. 14 is a diagram illustrating an example of the relationship of adjacent cells to a cell X of the serving base station 200a. As expressed in FIG. 14, the adjacent cells relating to cell X are cells A-1, B-1, C-1, D-1, E-1 and F-1.

A numerical value corresponding to the presence or absence of the retransmission is stored in the “RLC procedure status” item, when there is a handover to the respective target base stations of the adjacent cells A-1 to F-1, for instance. For example, the second data communication condition gathering unit 242 refers to the retransmission information table 231 stored in the memory unit 230 and confirms whether or not the flag indicating the retransmission is set to on in respect of the terminal which is being handed over. If the retransmission flag is on, then the second data communication condition gathering unit 242 counts up the numerical values stored in the “retransmission” item of the “RLC procedure status”, and stores the value of this count. Furthermore, if the retransmission flag is off, then the second data communication condition gathering unit 242 counts up the numerical values stored in the “no retransmission” item and stores the value of this count. In the example in FIG. 13A, when the terminal 100 is handed over from the serving base station 200a in cell X to the base station in cell A-1, then the number of times that the retransmission is performed to the base station 200a within the monitoring time period is “0” times, and the number of times that no retransmission is performed is “500” times. For example, the terminal 100 is situated in the vicinity of the boundary between cell X and cell A-1, and the retransmission status when communicating with the base station 200a in cell X is stored in the statistical information table 232.

The “retransmission occurrence rate” item stores the ratio of times that the retransmission is performed in radio communication carried out with the handover source base station, when handover is made to the base station of the adjacent cell, based on the “RLC procedure status”, for example. In this calculation, the “retransmission occurrence rate” is a numerical value which expresses the ratio of the number of “retransmission” times with respect to the sum total of the respective counts of “retransmission” and “no retransmission”. In the example in FIG. 13A, the number of “retransmission” times for the adjacent cell A-1 is “0”, the sum total of the number of “retransmission” and “no retransmission” times for the adjacent cell A-1 is “100”, and therefore the retransmission occurrence rate is “0%”. The number of “retransmission” times for the adjacent cell B-1 is “250”, the sum total is “500”, and therefore the retransmission occurrence rate is “50%”. The “retransmission occurrence rate” is calculated by reading out the values of the respective items which is stored as the “RLC procedure status” by the second data communication condition gathering unit 242, for example, and the calculation result is stored in the statistical information table 232 as the “retransmission occurrence rate” item.

A radio quality corresponding to the adjacent cells A-1 to F-1 which is judged based on the retransmission occurrence rate, for example, is stored in the “quality judgment” item. In the example in FIG. 13B, if the “retransmission occurrence rate” is 0% to 20%, then the radio quality is judged to be “good”, and if the “retransmission occurrence rate” is 20% to 100%, then the radio quality is judged to be “poor”; a “good” or “poor” radio quality is stored accordingly in the “quality judgment” item of the statistical information table 232. Thus, a third threshold value is provided in relation to the “retransmission occurrence rate”, and if the “retransmission occurrence rate” is equal to or less than the third threshold value, then the radio quality is judged to be “good” and if the “retransmission occurrence rate” is greater than the third threshold value, then the radio quality is judged to be “poor”. In the example in FIG. 13B, the third threshold value is set to “20%”. In the example in FIG. 13A and FIG. 14, for instance, the radio quality when it is decided to hand over the terminal 100 to the base station in cell A-1 and when the terminal 100 is situated in the range of the cell X in the vicinity of the boundary between cell X and cell A-1 is judged to be “good”, because the retransmission occurrence rate is equal to or less than the third threshold value. Furthermore, the radio quality when it is decided to hand over the terminal 100 to the base station in cell B-1 and when the terminal 100 is situated in the range of cell X in the vicinity of the boundary between cell X and cell B-1 is judged to be “poor”, because the retransmission occurrence rate is greater than the third threshold value. In FIG. 13B, the third threshold value is set to “20%”, but it may be a different value, taking account of various conditions, standards, and the like. For example, the second data communication condition gathering unit 242 reads out the value stored for the “retransmission occurrence rate” in the statistical information table 232, compares this value with the third threshold value, and stores either a “good” or a “poor” radio quality in the “quality judgment” item, depending on which value is larger.

In this way, the statistical information table 232 stores the number of presence or absence of retransmission performed until the current time, for each adjacent cell, and includes statistical information relating to the presence and absence of the retransmission for each adjacent cell; the radio quality is judged based on this statistical information.

Returning to FIG. 12, the serving base station 200a then determines forwarding data based on the radio quality status (S31). The forwarding data determination process for determining the forwarding data is carried out by means of the flowchart illustrated in FIG. 9B, for instance. For example, the forwarding data determination unit 243 determines the forwarding data by using the statistical information table 232 stored in the memory unit 230.

When the forwarding data determination process starts (S300), the forwarding data determination unit 243 judges the radio quality of the handover destination cell (S301). This judgment is carried out by means of the forwarding data determination unit 243 reading out the value (“good” or “poor”) stored for the “quality judgment” item in the statistical information table 232.

If the radio quality of the handover destination is “good” (“good in S301), then the forwarding data determination unit 243 sets the “SDUs awaiting processing” as the forwarding data (S302). For instance, in the example in FIG. 12, when the serving base station 200a decides on handover to a base station in the adjacent cell A-1, then the forwarding data determination unit 243 judges that the “quality judgment” of the adjacent cell A-1 is “good”, based on the statistical information table 232. The forwarding data determination unit 243 determines the respective data of “SDU-B” and “SDU-C” which are awaiting processing, as the forwarding data.

In this case, the serving base station 200a does not receive an Ack signal corresponding to the PDUs having sequence numbers SN4 to SN6. However, the serving base station 200a judges that the radio quality when moving from cell X to cell A-1 is “good”. In a case such as this, the forwarding data determination unit 243 judges that the PDUs having sequence numbers SN4 to SN6 is received correctly by the terminal 100, and sets “SDU-B” which starts from the sequence number SN7 and “SDU-C”, as the forwarding data.

Returning to FIG. 9B, on the other hand, if the forwarding data determination unit 243 judges that the radio quality of the handover destination is “poor” (“poor” at S301), then the “SDUs under processing and SDUs awaiting processing” are set as forwarding data (S303). For instance, in the example in FIG. 12, if the serving base station 200a decides a base station having cell B-1 as the handover destination (S19), then the forwarding data determination unit 243 judges the “quality judgment” of the adjacent cell B-1 to be “poor”, based on the statistical information table 232. The forwarding data determination unit 243 determines the respective data of “SDU-A” which is under processing and “SDU-B” and “SDU-C” which are awaiting processing, as the forwarding data.

In this case, the serving base station 200a does not receive an Ack signal corresponding to the PDUs having sequence numbers SN4 to SN6. Furthermore, the serving base station 200a judges the radio quality when moving from cell X to cell B to be “poor”. In a case such as this, the forwarding data determination unit 243 judges that it does not be possible to receive the PDUs having sequence numbers SN4 to SN6 correctly in the terminal 100, and sets the SDUs from “SDU-A” onwards which include sequence numbers SN4 to SN6, as the forwarding data.

Returning to FIG. 12, the serving base station 200a transmits the determined forwarding data to the handover destination base station 200b (S22), and the handover destination base station 200b transmits the forwarding data to the terminal 100 (S23). For instance, if the radio quality is “good” (“good” at S301 in FIG. 9B), then the serving base station 200a forwards the respective data of “SDU-B” and “SDU-C” which are awaiting processing, to the target base station 200b. The base station 200b then transmits the data sequentially to the terminal 100, by radio communication, from the PDU having sequence number SN7. On the other hand, if the radio quality is “poor” (“poor” at step S301 in FIG. 9B), then the serving base station 200a transmits “SDU-A” which is under processing, and “SDU-B” and “SDU-C” which are awaiting processing, to the target base station 200b. The base station 200b then transmits the data sequentially to the terminal 100, by radio communication, from the PDU having sequence number SN1 (S23).

In this way, in the present operational example, the serving base station 200a calculates the retransmission occurrence rate based on statistical information relating to the presence or absence of the retransmission for each adjacent cell, and judges the radio quality for each adjacent cell based on the retransmission occurrence rate. If the radio quality is judged to be “good”, then the serving base station 200a judges that the data under processing could be received correctly in the terminal 100, and the data awaiting processing is set as forwarding data. Consequently, the base station 200b of the handover destination does not transmit the data under processing in a duplicated fashion, and the terminal 100 does not receive the data under processing in a duplicated fashion from the handover destination base station 200b.

On the other hand, if the radio quality is judged to be “poor”, then the serving base station 200a judges that the data under processing could not be received correctly in the terminal 100, and the data under processing and the data awaiting processing are set as the forwarding data. Consequently, since the data under processing in the handover source base station 200a is transmitted to the terminal 100 by the handover destination base station 200b, then there is no loss of data in the terminal 100.

Similarly to the first operational example described above, the serving base station 200a may report the sequence number of the PDU which represents the start of transmission, to the target base station 200b. FIG. 15 is a sequence diagram illustrating an operational example in a case where a sequence number is reported. In this case also, similarly to the first operational example, the first data communication condition gathering unit 221, for instance, stores the presence or absence of retransmission in the retransmission information table 231 and stores the sequence numbers of PDUs that are the object of a received Ack signal. The forwarding data determination unit 243 reads out the sequence number of the PDU that was the object of the last Ack signal received before the handover decision, from the retransmission information table 231, sets the sequence number following this sequence number as the sequence number to be reported, and then reports this number (S24). By reporting the sequence number, the handover destination base station 200b is able to transmit the PDU having the reported sequence number to the terminal 100, and therefore it is possible to further prevent duplicated transmission, duplicated reception and data loss.

<Third Operational Example>

Next, a third operational example, which is an example of a case where forwarding data is determined based on the radio wave condition, will be described. FIG. 16 to FIG. 19 and FIG. 9B illustrates examples of sequence diagrams, and the like, according to this operational example.

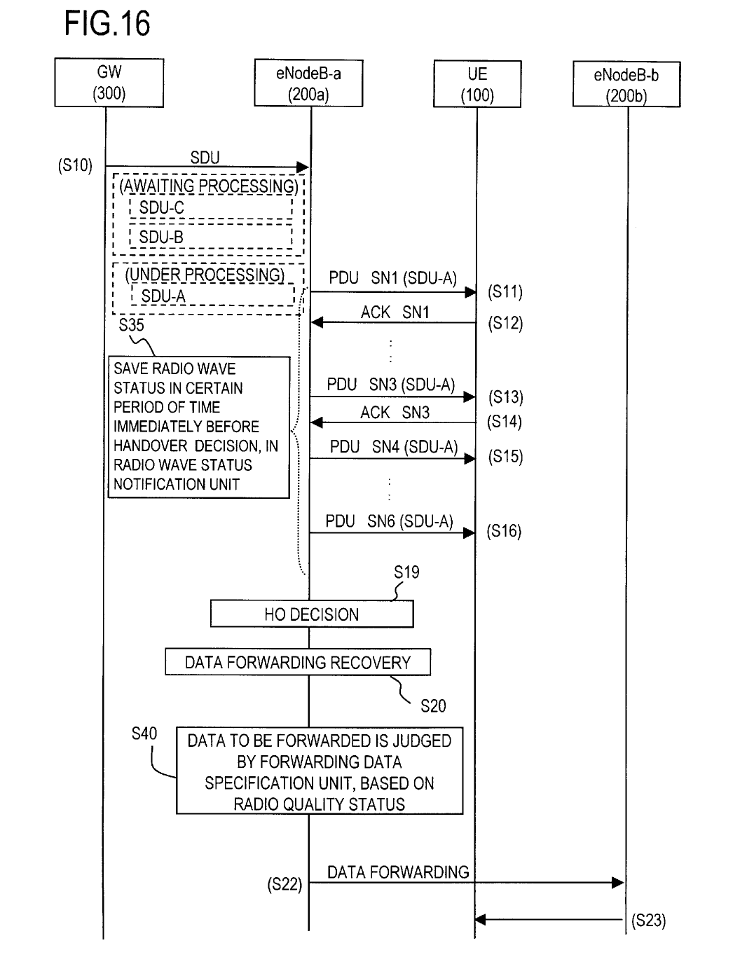

FIG. 16 is a diagram illustrating a sequence example according to the third operational example. In this third operational example, similarly to the first and second operational examples, the serving base station 200a receives Ack signals in relation to the PDUs having sequence numbers SN1 to SN3, and does not perform the retransmission of the PDUs having sequence numbers SN4 to SN6 (S10 to S16).

In the third operational example, the serving base station 200a measures the radio quality between the serving base station 200a and the terminal 100, based on the signal received from the terminal 100, and stores the measured radio quality in the radio wave condition table 233 as a radio wave condition (S35). For example, the radio wave condition notification unit 211 measures the reception power of the Ack signal received from the terminal 100, and the noise in relation to this reception power, and the like, as the radio quality, and stores this in the radio wave condition table 233. Alternatively, upon receiving a “Measurement Reports” message including a radio quality measured at the terminal 100, the radio wave condition notification unit 211 extracts the radio quality included in the message and stores this information as the radio wave condition in the radio wave condition table 233.

FIG. 17A is a diagram illustrating an example of a radio wave condition table 233. The radio wave condition table 233 includes the items “radio wave condition” and “quality judgment”, for each adjacent cell.

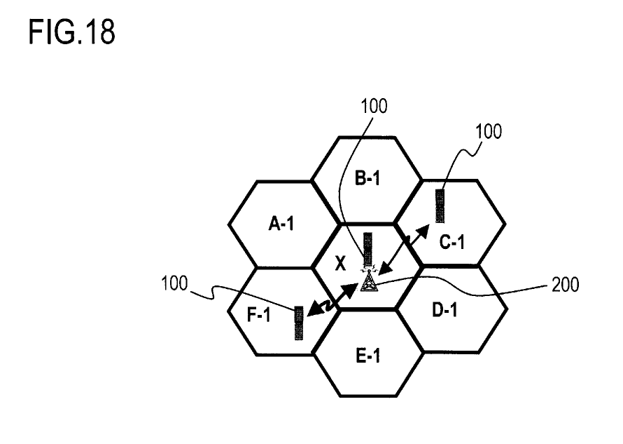

If the terminal 100 is located in cell X of the serving base station 200a, as illustrated in FIG. 18, for example, then the adjacent cells are the cells A-1 to F-1 of the base stations to which the terminal can be handed over from the serving base station 200a.

The radio quality measured or extracted by the serving base station 200a is stored in the “radio wave condition” item. For example, in the example in FIG. 17A, the information stored as the “radio wave condition” for cell “A-1” is the radio quality between the terminal 100 and the serving base station 200a when the terminal 100 is located in the cell X in the vicinity of the boundary between the cell X and the cell A-1. Alternatively, the radio wave condition notification unit 211 extracts the radio quality and cell ID included in the received “Measurement Reports” message, and stores the extracted radio quality in the corresponding “radio wave condition” item.

The “quality judgment” item is stored as “good” when the measured radio quality is equal to or higher than a fourth threshold value, and is stored as “poor” when the measured radio quality is lower than the fourth threshold value, respectively for each adjacent cell. In FIG. 17B, the fourth threshold value is set to “2 dB”, and the radio wave condition for the adjacent cell B-1 is “1.5 dB”, which is smaller than “2 dB”, and therefore a quality judgment of “poor” is stored, whereas the radio wave condition for the adjacent cell A-1 is “2.5 dB”, which is larger than “2 dB”, and therefore a quality judgment of “good” is stored.

Returning to FIG. 16, in this way, the radio quality is stored in the radio wave condition table 233 of the serving base station 200a (S35). In this case, similarly to the first operational example, for instance, it is possible to store the radio quality which is measured or extracted during a monitoring time period before the handover decision. For example, the radio wave condition notification unit 211 stores the measured or extracted radio quality in the memory unit 230, and then reads out the radio quality corresponding to the monitoring period before the handover decision (S19), from the memory unit 230, and stores this radio quality in the radio wave condition table 233.

Thereupon, the serving base station 200a decides to carry out handover (S19), performs data recovery (S20), and then determines the forwarding data (S40). The forwarding data determination process can be implemented in accordance with the flowchart illustrated in FIG. 9B, for example, similarly to the second operational example described above.

When the forwarding data determination process starts (S300), the forwarding data determination unit 243 judges the radio quality (S301). For example, the forwarding data determination unit 243 judges the radio quality based on whether “good” or “poor” is stored in the “quality judgment” item corresponding to the “adjacent cell” belonging to the base station which is the handover destination, in the radio wave condition table 233 (S301).

If the radio quality of the handover destination is “good” (“good” at step S301), then the forwarding data determination unit 243 sets “SDUs awaiting processing” as the forwarding data (S302). In this case, similarly to the second operational example described above, provided that the radio quality is “good”, then it is probable that the terminal 100 will be able to correctly receive data under processing which is transmitted, even if the serving base station 200a does not confirm reception of an Ack signal, and in this case, “SDUs awaiting processing” are set as the forwarding data. In the example in FIG. 16 and FIG. 17A, the serving base station 200a does not receive Ack signals in respect of the sequence numbers SN4 to SN6, when the terminal 100 is handed over to a base station having the adjacent cell “A-1”. However, since the radio quality of the adjacent cell “A-1” is “good”, then the serving base station 200a sets “SDU-B” which starts from sequence number SN7, and “SDU-C” which follows “SDU-B”, as the forwarding data.

On the other hand, if the radio quality of the handover destination is “poor” (“poor” at S302), then the forwarding data determination unit 243 sets the “SDU under processing and SDUs awaiting processing” as the forwarding data (S303). In this case, similarly to the second operational example described above, if the radio quality is “poor”, then the possibility that the data under processing was received correctly even if the serving base station 200a does not confirm reception of an Ack signal, is low compared to a case where the radio quality is “good”. In this case, the forwarding data is set to include the “SDU under processing”, which includes data for which reception of an Ack signal does not be confirmed, and the “SDUs awaiting processing” which follow the SDU under processing. In the example in FIG. 16 and FIG. 17A, when the terminal 100 is handed over to the base station having adjacent cell “B-1”, the radio quality of the adjacent cell “B-1” is “poor”, and therefore the serving base station 200a sets the “SDU-A under processing” and the “SDUs awaiting processing” as the forwarding data.

Upon having determined the forwarding data (S40), the serving base station 200a transmits the data to the target base station 200b which is the handover destination (S22). The serving base station 200a forwards the “SDUs awaiting processing” when the radio quality is “good”, and forwards the “SDU under processing and SDUs awaiting processing” when the radio quality is “poor”.

The handover destination base station 200b transmits the forwarded data to the terminal 100 (S23).

In this way, in the third operational example, the serving base station 200a judges the radio quality for each adjacent cell based on the radio wave condition of each adjacent cell. Similarly to the second operational example, if the radio quality is judged to be “good”, the base station 200a judges that the data under processing could be received correctly in the terminal 100 and the data awaiting processing is set as the forwarding data. Consequently, the handover destination base station 200b does not transmit the data under processing in a duplicated fashion, and the terminal 100 does not receive the data under processing which already is received, in a duplicated fashion, from the handover destination base station 200b.

Furthermore, if the radio quality is judged to be “poor”, then the serving base station 200a judges that the data under processing could not be received correctly by the terminal 100, and sets the data under processing and the data awaiting processing as the forwarding data. Consequently, the handover destination base station 200b is able to transmit the data which is under processing in the handover source base station 200a, to the terminal 100, and therefore no data loss occurs in the terminal 100.

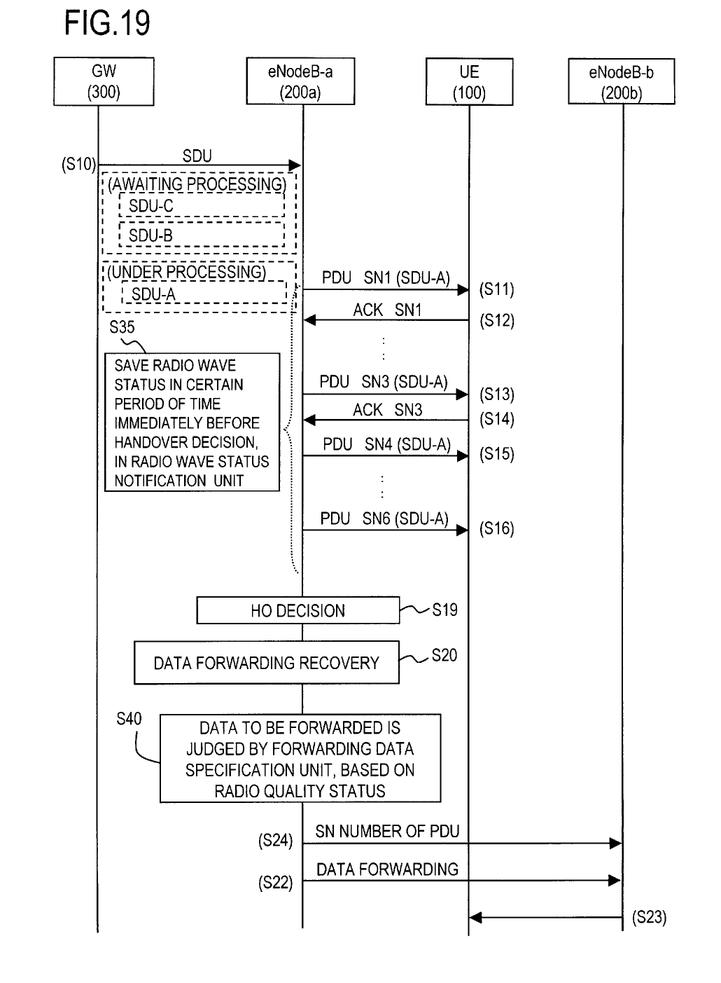

In the third operational example also, similarly to the first and second operational examples, the serving base station 200a may report the sequence number of the PDU which represents the start of transmission. FIG. 19 is a sequence diagram illustrating an operational example in a case where the sequence number is reported. In this case also, similarly to the first and second operational examples, the first data communication condition gathering unit 221 stores the presence or absence of the retransmission, and the sequence numbers of PDUs which are the object of received Ack signals, in the retransmission information table 231. The forwarding data determination unit 243 then reads out the sequence number of the PDU which is the object of the last Ack signal received before the handover decision, from the retransmission information table 231, sets the sequence number following this sequence number as the sequence number to be reported, and then reports this sequence number (S24). By reporting the sequence number, the handover destination base station 200b can transmit the PDU of the reported sequence number, to the terminal 100, and it is possible to further prevent duplicated transmission, duplicated reception and data loss. These examples will be explained consecutively in the following.

<Fourth Operational Example>

Next, a fourth operational example, in other words, a combination of the first to third operational examples will be described. The fourth operational example is a method which determines forwarding data by means of a combination of the retransmission status for each call (first operational example), and the radio quality status (second or third operational example). In the case of a combination of this kind, there are two possible operational examples. The first is one where forwarding data is determined by a combination of the first operational example (the retransmission status of each call) and the second operational example (the radio quality status based on retransmission occurrence rate). The second is one where forwarding data is determined by a combination of the first operational example (the retransmission status of each call) and the third operational example (the radio quality status based on the radio wave condition).

<1. Combination of First Operational Example and Second Operational Example>

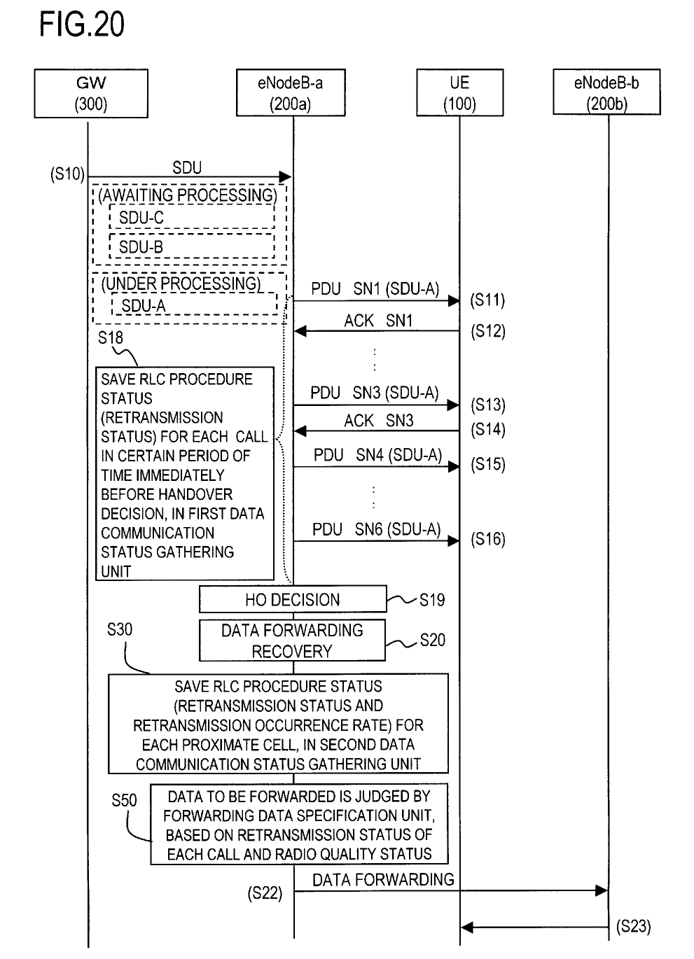

Firstly, an example which combines the first and second operational examples will be described. FIG. 20 to FIG. 24 are diagrams illustrating sequence diagrams or flowcharts of this operational example, and the like. Parts which perform the same processing as the first and second operational examples are labeled with the same reference numerals.

Of these, FIG. 20 is a sequence diagram of the present operational example. This operational example is now described with reference to FIG. 20. In the present operational example, similarly to the first to third operational examples, the serving base station 200a transmits PDUs having sequence numbers SN1 to SN6 which are included in the SDU-A, to the terminal 100, and receives Ack signals corresponding to the PDUs having sequence numbers SN1 to SN3, from the terminal 100 (S10 to S16).

Similarly to the first operational example, the serving base station 200a holds the retransmission status for each call, in the retransmission information table 231 (S18). For example, as illustrated in FIG. 6, the first data communication condition gathering unit 221 stores the presence or absence of the retransmission for each terminal 100, in the retransmission information table 231.

Thereupon, the serving base station 200a carries out the determination of handover execution and data recovery (S19 and S20).

Thereupon, similarly to the second operational example, the serving base station 200a stores the retransmission status and the retransmission occurrence rate for each adjacent cell, in the statistical information table 232 (S30). For instance, the second data communication condition gathering unit 242 stores the number of retransmission and the number of no retransmission in the “retransmission” or “no retransmission” items of the statistical information table 232, based on the retransmission status of each call, as illustrated in FIG. 13A and FIG. 13B. The second data communication condition gathering unit 242 calculates the retransmission occurrence rate from the stored number of times and stores the calculated rate in the “retransmission occurrence rate” item. Moreover, the second data communication condition gathering unit 242 compares the retransmission occurrence rate with the third threshold value and stores “good” or “poor” indicating the radio quality, as a “quality judgment” in the statistical information table 232.

Next, the serving base station 200a determines the forwarding data based on the retransmission status of each call and the radio quality status (S50). For example, the forwarding data determination unit 243 determines forwarding data based on the retransmission information table 231 and the statistical information table 232 stored in the memory unit 230.

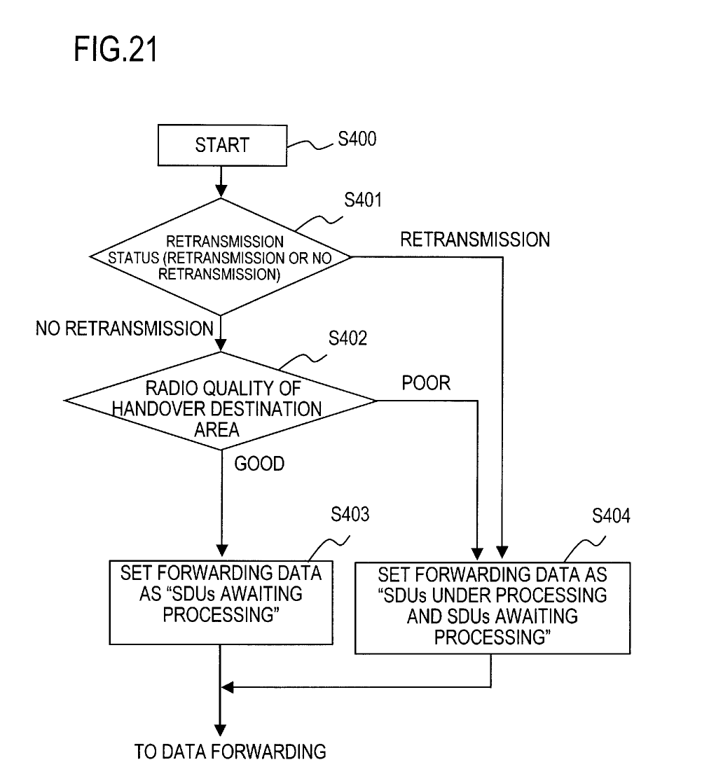

FIG. 21 is a flowchart illustrating an example of a forwarding data determination process according to the present operational example. When processing is started (S400), similarly to the first operational example (S211), the forwarding data determination unit 243 judges the presence or absence of the retransmission to the terminal 100 for which it is decided to perform handover, based on the retransmission information table 231 (S401). For instance, the forwarding data determination unit 243 judges “retransmission” if the “retransmission or no retransmission” item in the retransmission information table 231 is on (“1”), and judges “no retransmission” if the “retransmission or no retransmission” item is off (“0”).

If the retransmission does not be performed (“no retransmission” at step S401), then the forwarding data determination unit 243 judges the radio quality of the handover destination cell (S402). Similarly to the second operational example (S301), the forwarding data determination unit 243 judges the radio quality based on the statistical information table 232 stored in step S30. More specifically, the forwarding data determination unit 243 judges the radio quality to be “good” if “good” is stored as the “quality judgment” in the statistical information table 232, and judges the radio quality to be “poor” if “poor” is stored as the “quality judgment” in the statistical information table 232.

If the radio quality of the handover destination cell is “good” (“good” in S402), then the forwarding data determination unit 243 sets the “SDUs awaiting processing” which are scheduled to be transmitted after the data under processing, as the forwarding data (S403). In this case, if the retransmission does not be performed in respect of the data under processing (“no retransmission” at S401) and the radio quality of the handover destination is “good” (“good” at S402), then it can be judged that the terminal 100 will probably be able to correctly receive the data under processing, even if an Ack signal does not be received from the terminal 100, for example. In cases such as this, the serving base station 200a determines the “SDUs awaiting processing” which are scheduled to be transmitted to the terminal 100 after the data under processing, as the forwarding data.

On the other hand, if the radio quality of the handover destination cell is “poor” (“poor” at S402), then the forwarding data determination unit 243 determines the data under processing (“SDU under processing”) and the “SDUs awaiting processing” which are scheduled to be transmitted after the data under processing, as the forwarding data (S404). In this case, if the radio quality of the handover destination is “poor”, then the possibility that the data under processing is received correctly in the terminal 100 even though an Ack signal does not be received from the terminal 100 is low compared to a case were the radio quality is “good”. In cases such as this, the serving base station 200a determines the data under processing (“SDU under processing”) and the “SDUs awaiting processing” as the forwarding data.

Furthermore, when the retransmission is performed (“retransmission” at S401), the forwarding data determination unit 243 determines the “SDU under processing” and the “SDUs awaiting processing” as the forwarding data (S404). This is because in conditions where the retransmission is performed, there is a high possibility that the retransmission will be performed again compared to conditions where the retransmission is not performed, even if the serving base station 200a does not receive an Ack signal in respect of the retransmitted data. Therefore, if the retransmission is performed, then the “SDU under processing” which is transmitted is set as forwarding data, regardless of whether or not an Ack signal is received in respect of the retransmitted data.

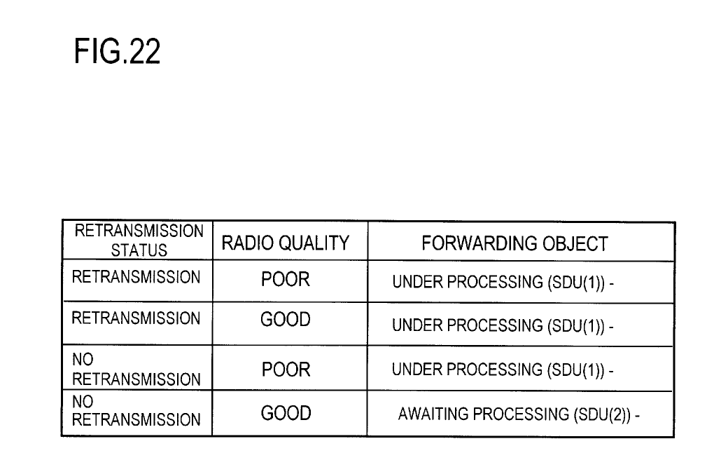

FIG. 22 is a diagram illustrating an example of the kind of data that is set as forwarding data in conditions where PDUs having sequence numbers SN1 to SN6 is transmitted to the terminal 100, as in FIG. 20, and where an Ack signal is transmitted in respect of the PDUs having sequence numbers SN1 to SN3. If there is no retransmission and the radio quality is “good”, then the “SDU-B” and “SDU-C”, which are “SDUs awaiting processing” are set as the forwarding data. In other cases, “SDU-A” to “SDU-C” are set as the forwarding data.

Returning to FIG. 20, the serving base station 200a forwards the determined forwarding data to the base station 200b of the handover destination (S22), and the base station 200b of the handover destination transmits the forwarded data to the terminal 100 (S23).

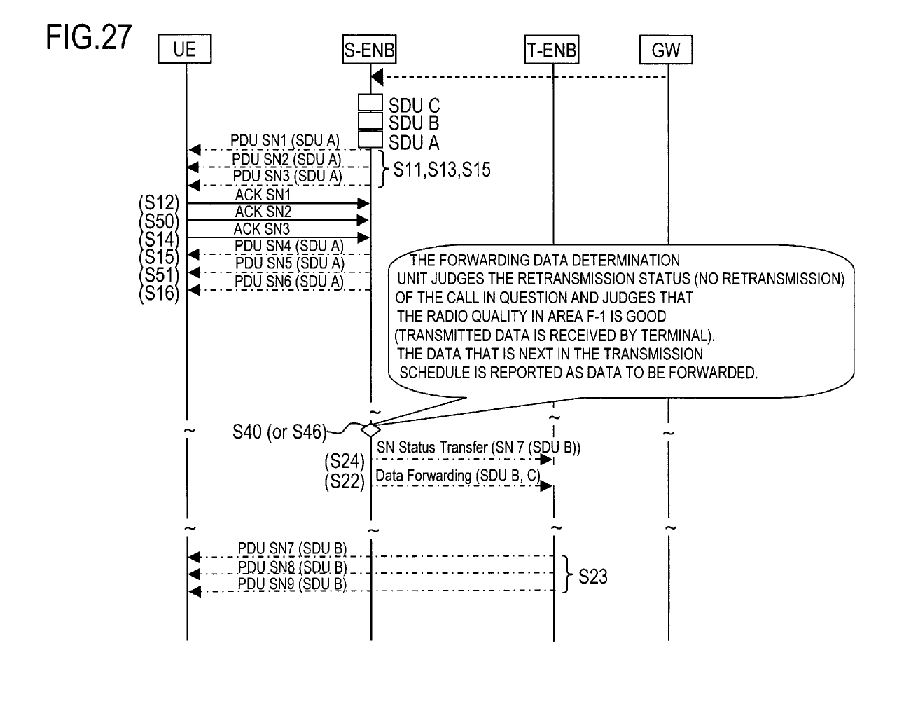

FIG. 27 is a diagram illustrating an example of a sequence when a handover is performed to a base station of an adjacent cell which has “good” radio quality, without the retransmission being performed, under the conditions in FIG. 20. In this example, the forwarding data is the data from sequence number SN7 onwards, and the PDUs from sequence number SN7 onwards are transmitted from the handover destination base station 200b.

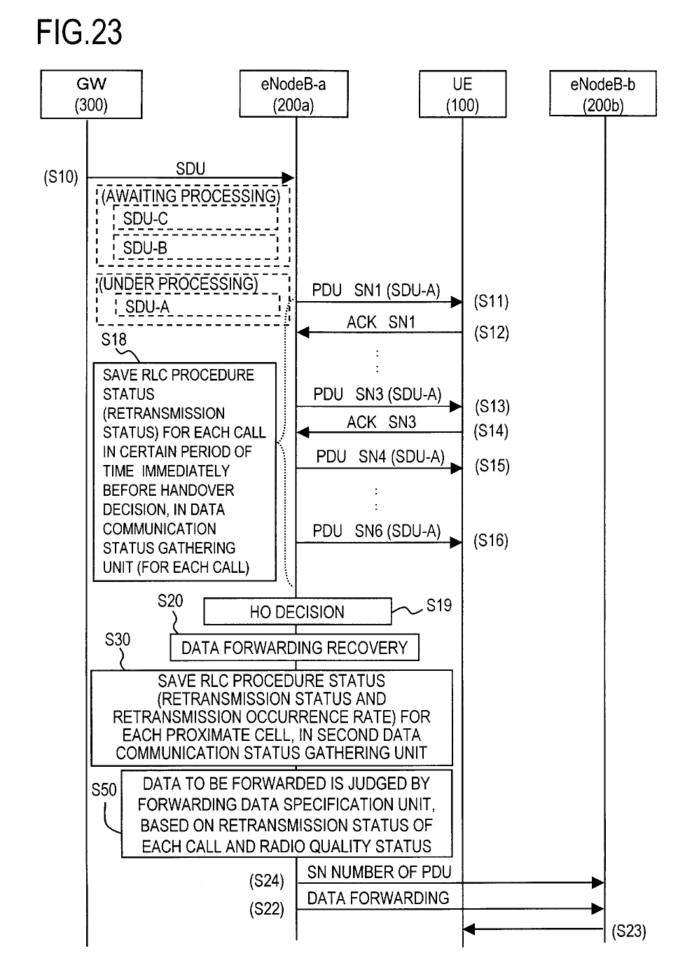

In this operational example also, similarly to the first to third operational examples, the serving base station 200a may transmit a sequence number to the target base station 200b. FIG. 23 is a diagram illustrating a sequence example including the reporting of a sequence number. In this example also, the first data communication condition gathering unit 221 stores sequence numbers of PDUs which are the object of a received Ack signal, in the retransmission information table 231, for instance, and the forwarding data determination unit 243 determines the sequence number to report based on the determined forwarding data and the stored sequence numbers. For example, in a situation such as that in FIG. 23, when the forwarding data determination unit 243 determines the “SDU under processing and SDUs awaiting processing” as the forwarding data, the sequence number “SN4” may be reported. Furthermore, if the forwarding data determination unit 243 determines the “SDUs awaiting processing” as the forwarding data, then the sequence number “SN7” may be reported.

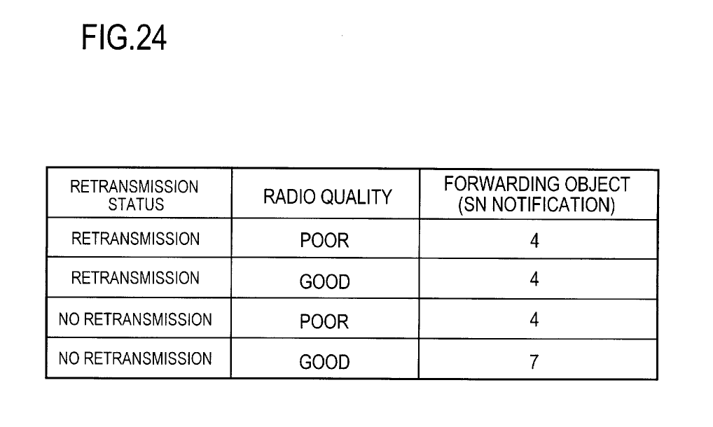

FIG. 24 is a diagram illustrating an example of sequence numbers which are reported in situations of this kind. If the retransmission status is “no retransmission”, and the radio quality is “good”, then the reported sequence number is SN“7”, which his the first sequence number of the PDU belonging to SDU-B which is “awaiting processing”. If the retransmission status is “no retransmission” and the radio quality is “poor”, then the reported sequence number is SN“4”, which is the first sequence number for which an Ack signal does not be received. If the retransmission status is “retransmission”, then the sequence number SN“4” is reported, regardless of the radio quality.

In the present operational example, consequently, similarly to the first and second operational examples, if the radio quality is judged to be “good”, then the base station 200a judges that the data under processing could be received correctly in the terminal 100 and sets the data awaiting processing as the forwarding data. Therefore, the base station 200b of the handover destination does not transmit the data under processing in a duplicated fashion, and the terminal 100 does not receive the data under processing in a duplicated fashion from the handover destination base station 200b.

Furthermore, if the retransmission is performed, or if the retransmission does not be performed and the radio quality is “poor”, then the serving base station 200a judges that the data under processing could not be received correctly in the terminal 100, and sets the data under processing and the data awaiting processing as the forwarding data. Consequently, since the data under processing in the handover source base station 200a is transmitted to the terminal 100 by the handover destination base station 200b, then there is no loss of data in the terminal 100.

<2. Combination of First Operational Example and Third Operational Example>

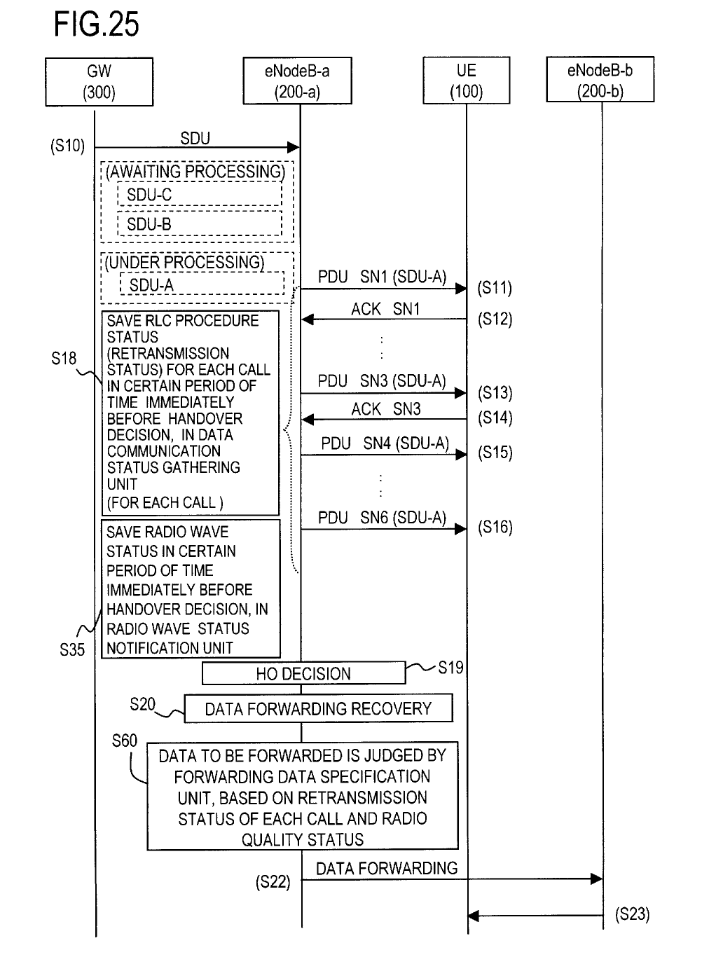

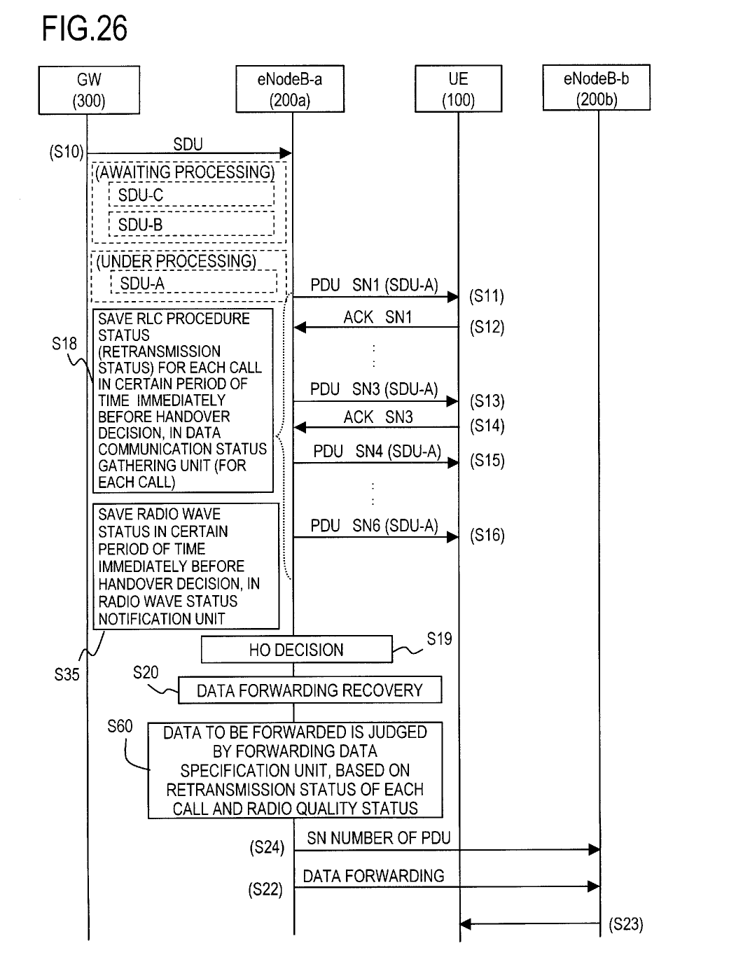

Next, a fourth operational example, in other words, a combination of the first operational example and the third operational example will be described. FIG. 25 is a diagram illustrating a sequence example according to this operational example and FIG. 26 is a diagram illustrating a sequence example in a case where a sequence number is reported.

In this operational example, similarly to the first operational example, the serving base station 200a holds the retransmission status for each call during a monitoring period, for example, in the retransmission information table 231 (see FIG. 6, for example) (S18). Furthermore, similarly to the third operational example, the serving base station 200a holds the radio wave condition during the monitoring period, for example, in the radio wave condition table 233 (see FIG. 17A, for example) (S35).

The serving base station 200a then decides handover (S19), performs data recovery (S20), and determines the forwarding data based on the retransmission information table 231 and the radio wave condition table 233 (S60). The forwarding data determination process is, for example, similar to that described in the combination of the first and second operational examples which was explained above. More specifically, as illustrated in FIG. 21, if no retransmission is performed to the terminal 100 being handed over (“no retransmission” at S401) and if the radio quality of the handover destination cell is “good” (“good” at S402), then the forwarding data determination unit 243 sets as the “SDUs awaiting processing” as the forwarding data (S403). On the other hand, if retransmission is performed (“retransmission” at S401) or retransmission is not performed but the radio quality is “poor” (“poor” at S402), then the forwarding data determination unit 243 sets the “SDU under processing and the SDUs awaiting processing” as the forwarding data (S404). The fact that the forwarding data is determined by using the radio wave condition table 233 differs from the combination of the first and second operational examples described above. A sequence example relating to a case where a sequence number is reported is illustrated in FIG. 26, but the kind of sequence number reported is similar to the combination of the first and second operational examples described above.

In the present operational example, consequently, similarly to the first and third operational examples, if the radio quality is judged to be “good”, the base station 200a judges that the data under processing could be received correctly in the terminal 100 and sets the data awaiting processing as the forwarding data. Therefore, the base station 200b of the handover destination does not transmit the data under processing in a duplicated fashion, and the terminal 100 does not receive the data under processing in a duplicated fashion from the handover destination base station 200b.

Furthermore, if the retransmission does not be performed but the radio quality is “poor”, or if the retransmission is performed, then the serving base station 200a judges that the data under processing could not be received correctly in the terminal 100, and sets the data under processing and the data awaiting processing as the forwarding data. Consequently, since the data under processing in the handover source base station 200a is transmitted to the terminal 100 by the handover destination base station 200b, then there is no loss of data in the terminal 100.

### Third Embodiment

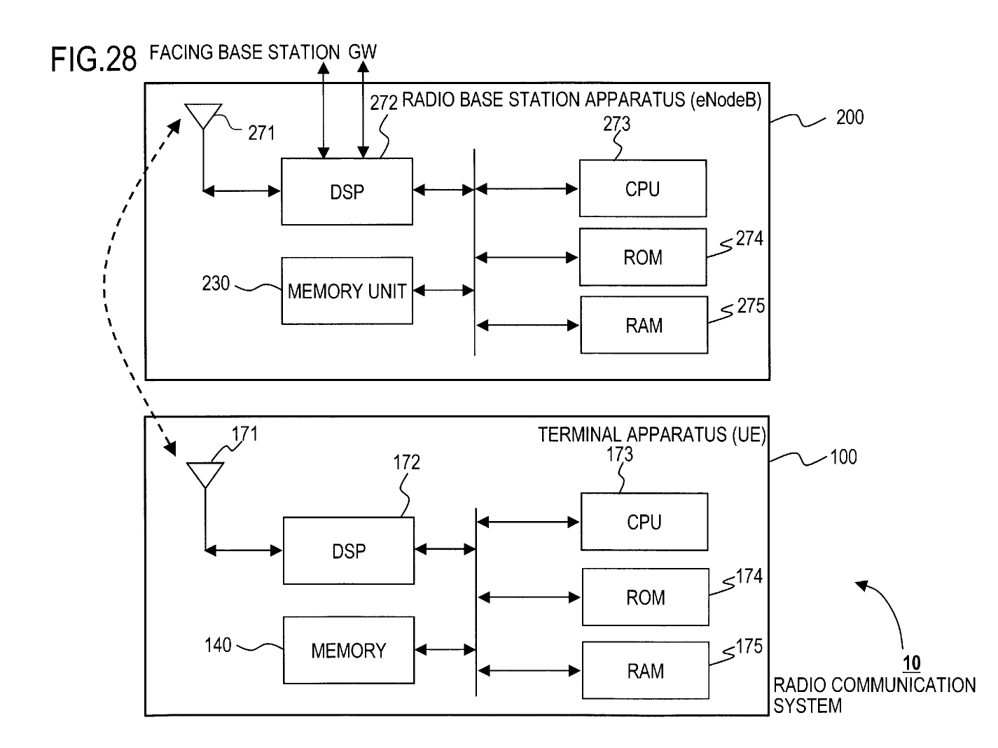

Next, a third embodiment of the invention will be described. FIG. 28 is a diagram illustrating a further example of the composition of a base station 200 and a terminal 100.

The base station 200 includes an antenna 271, a DSP (Digital Signal Processing unit) 272, a CPU 273, a ROM (Read Only Memory) 274, a RAM (Random Access Memory) 275, and a memory unit 230.

For example, the functions of the call control unit 240 of the base station 200 (see FIG. 3, for example) in the second embodiment can be achieved by coordinated operation of the CPU 273, the ROM 274 and the RAM 275. Moreover, for example, the functions of the facing ENB IF unit 250 in the second embodiment can be achieved by causing the DSP 272 to operate by transmitting an instruction to the DSP 272 from the CPU 273. Moreover, the functions of the radio transmission and reception unit 210 in the second embodiment can be achieved by operation of the DSP 272 and the antenna 271, for example. The functions of the RLC protocol control unit 220 according to the second embodiment can be achieved by coordinated operation of the CPU 273, the ROM 274 and the RAM 275, or by operation of the DSP 272.

On the other hand, the terminal 100 includes an antenna 171, a DSP 172, a CPU 173, a ROM 174, a RAM 175 and a memory unit 140.

For example, the functions of the call control unit 120 of the terminal 100 (see FIG. 4, for example) in the second embodiment are achieved by coordinated operation of the CPU 173, the ROM 174 and the RAM 175. Moreover, for example, the functions of the radio transmission and reception unit 110 in the second embodiment can be achieved by causing the DSP 172 and the antenna 171 to operate by transmitting an instruction to the DSP 172 from the CPU 173. The functions of the RLC protocol control unit 130 according to the second embodiment can be achieved by coordinated operation of the CPU 173, the ROM 174 and the RAM 175, or by operation of the DSP 172.

Consequently, in the base station 200 and the terminal 100 illustrated in FIG. 28, it is possible to achieve the respective first to fourth operational examples described above, similarly to the second embodiment.

### Fourth Embodiment

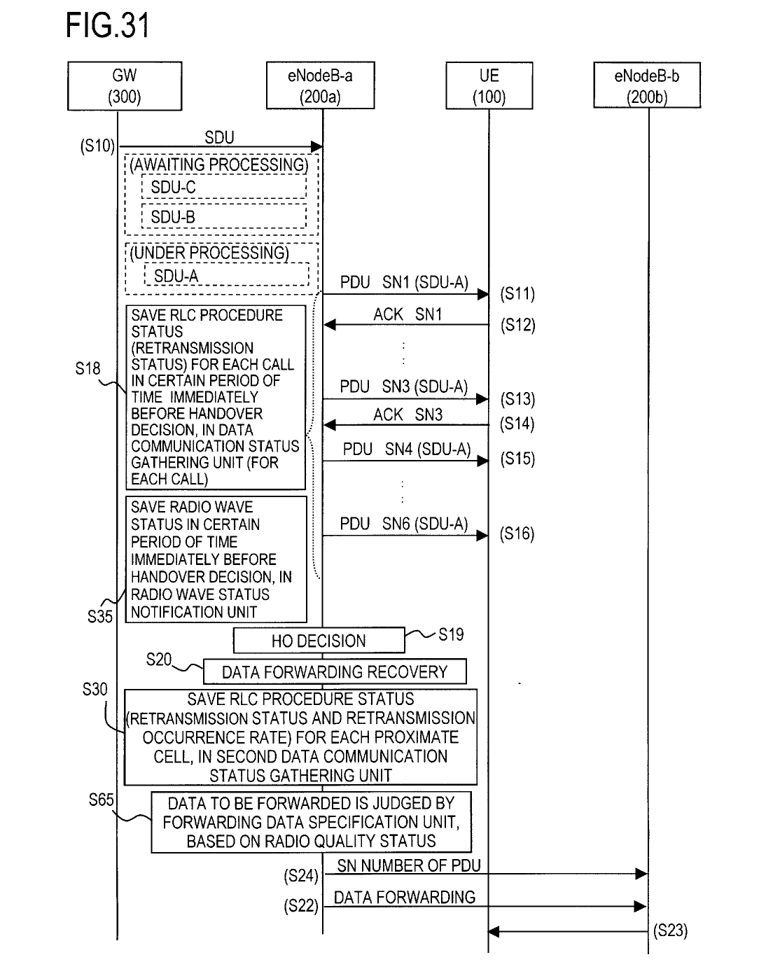

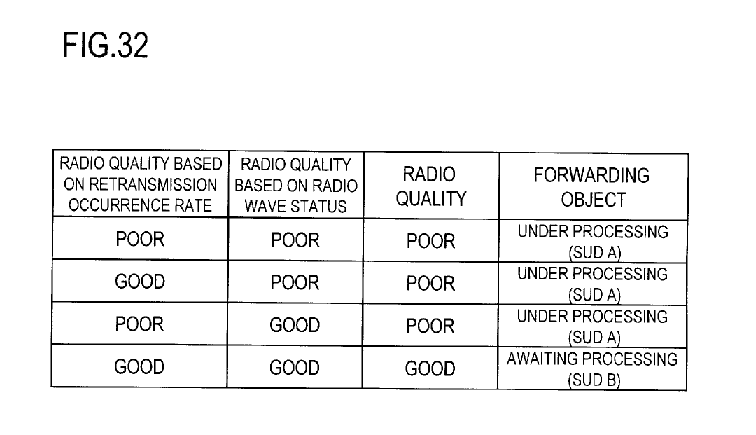

Next, a fourth embodiment of the invention will be described. The fourth operational example of the second embodiment was described by way of examples of a combination of the first operational example and the second operational example (for example, FIG. 20 to FIG. 24) and a combination of the first operational example and the third operational example (for example, FIG. 25 and FIG. 26). In this fourth embodiment, an operational example using a combination of the second operational example and the third operational example is described. FIG. 31 illustrates a sequence example of the fourth embodiment, and FIG. 32 illustrates an example of SDUs which are forwarded, in the fourth embodiment.

The respective compositional examples of the base stations 200a and 200b, and the terminal 100 are similar to those of the second embodiment (see FIG. 3 and FIG. 4, for example). Furthermore, the conditions under which the terminal 100 performs handover from the serving base station 200a to the target base station 200b are also similar to the second embodiment.

Furthermore, in FIG. 31, processes which are the same as those of the second embodiment are labeled with the same numbers. As illustrated in FIG. 31, the serving base station 200a receives SDU-A to SDU-C as data from the gateway 300, and transmits PDUs having sequence numbers SN1 to SN6 which are contained in SDU-A, to the terminal 100. Of these PDUs, the serving base station 200a receives an Ack signal corresponding to the PDUs having sequence numbers SN1 to SN3, and does not receive an Ack signal corresponding to the PDUs having sequence numbers SN4 to SN6 (S11 to S16).

In communication conditions of this kind, the serving base station 200a holds the retransmission status for each call, in the retransmission information table 231 (S18), similarly to the second operational example of the second embodiment. For instance, the first data communication condition gathering unit 221 stores the presence or absence of the retransmission in the retransmission information table 231.

Furthermore, the serving base station 200a stores the radio quality in the radio wave condition table 233, similarly to the third operational example of the second embodiment (S35). For instance, the radio wave condition notification unit 211 stores the radio quality included in a Measurement Report received from the terminal 100, or a radio quality measured based on a radio signal received from the terminal 100, in the radio wave condition table 233. For example, the radio wave condition notification unit 211 stores values in the “radio wave condition” and “quality judgment” items of the radio wave condition table 233 (see FIG. 17A, for example).

Next, the serving base station 200a decides to carry out handover (S19), and recovers data forwarding (S20). The serving base station 200a then stores the retransmission status and the retransmission occurrence rate for each adjacent cell in the statistical information table 232 (S30). For example, the second data communication condition gathering unit 242 stores values, or the like, in the respective items, “RLC procedure status” (the count value of “retransmission” or “no retransmission”), “retransmission occurrence rate” and “quality judgment”, of the statistical information table 232 (for example, FIG. 13A), based on the retransmission information table 231.

Thereupon, the serving base station 200a judges the forwarding data based on the radio quality status (S65). For example, the forwarding data determination unit 243 judges forwarding data based on the statistical information table 232 and the radio wave condition table 233 stored in the memory unit 230. In this case, the forwarding data determination unit 243 judges the forwarding data based on the “quality judgment” in the statistical information table 232 and the “quality judgment” in the radio wave status table 233.

FIG. 32 illustrates an example of judging the “radio quality” based on this combination. For example, if the “quality judgment” in the statistical information table 232 (the “retransmission occurrence rate” in FIG. 32) is “good”, and the “quality judgment” in the radio wave condition table 233 (the “radio wave condition” in FIG. 32) is “good”, then the forwarding data determination unit 243 judges that the radio quality is “good”. In the case of combinations other than this, the forwarding data determination unit 243 judges the radio quality to be “poor”.

The forwarding data is determined by applying this judgment result of the radio quality to the “radio quality of the handover destination cell” (S301) in the forwarding data determination process (see FIG. 9B, for example), similarly to the second embodiment.

For example, under communication conditions such as those illustrated in FIG. 31, if the radio quality is “good” (“good” at S301), then SDU-B and SDU-C which are awaiting processing are set as forwarding data, and if the radio quality is “poor” (“poor” at S301), then SDU-A which is under processing and SDU-B and SDU-C which are awaiting processing are set as forwarding data (see FIG. 32, for example).

In this way, if the radio quality is good, the serving base station 200a judges that the data transmitted to the terminal 100 (for example, the PDUs having sequence numbers SN4 to SN6) is received in the terminal 100, even if an Ack signal does not be received in respect of that data. In situations such as this, the serving base station 200a sets the “SDUs awaiting processing” (for example, the SDU-B onwards) as forwarding data.

Consequently, the serving base station 200a does not transmit the “SDU under processing” to the target base station 200b, and hence the target base station 200b does not transmit the data under processing to the terminal 100 in a duplicated fashion, and the terminal 100 does not receive the data under processing in a duplicated fashion.

On the other hand, the serving base station 200a sets the “SDU under processing” and the “SDUs awaiting processing” as the forwarding data, if an Ack signal does not be received within a threshold time period in respect of the data transmitted to the terminal 100 (if the “retransmission occurrence rate” is “poor”) or if the radio quality is less than a threshold value (if the “radio wave condition” is “poor”).

Consequently, the serving base station 200a transmits the data under processing to the terminal 100, and therefore the terminal 100 is also able to receive data which could not be received correctly, and data loss does not occur.

As illustrated in FIG. 32, for example, in the fourth embodiment, the overall “quality judgment” is judged to be “good”, if the “quality judgment” is “good” in both the statistical information table 232 and the radio wave condition table 233. Consequently, the reliability when the overall “quality judgment” is “good” can be raised compared to the case of the second operational example or the third operational example of the second embodiment.

In FIG. 31, the processing from the determination of forwarding data (S65) onwards involves the same processing as the second embodiment (S22, S23). In this case, the serving base station 200a may report the sequence number of the PDU from which the target base station 200b starts transmission (S24).

### Fifth Embodiment

Next, a fifth embodiment of the invention will be described. The second to fourth embodiments were described with reference to an example where a serving base station 200a decides handover after all of the PDUs included in an SDU is transmitted. In the example relating to the fifth embodiment, the serving base station 200a makes a handover decision before transmitting all of the PDUs contained in an SDU, and hence there are PDUs awaiting transmission (or PDUs which does not yet be transmitted).

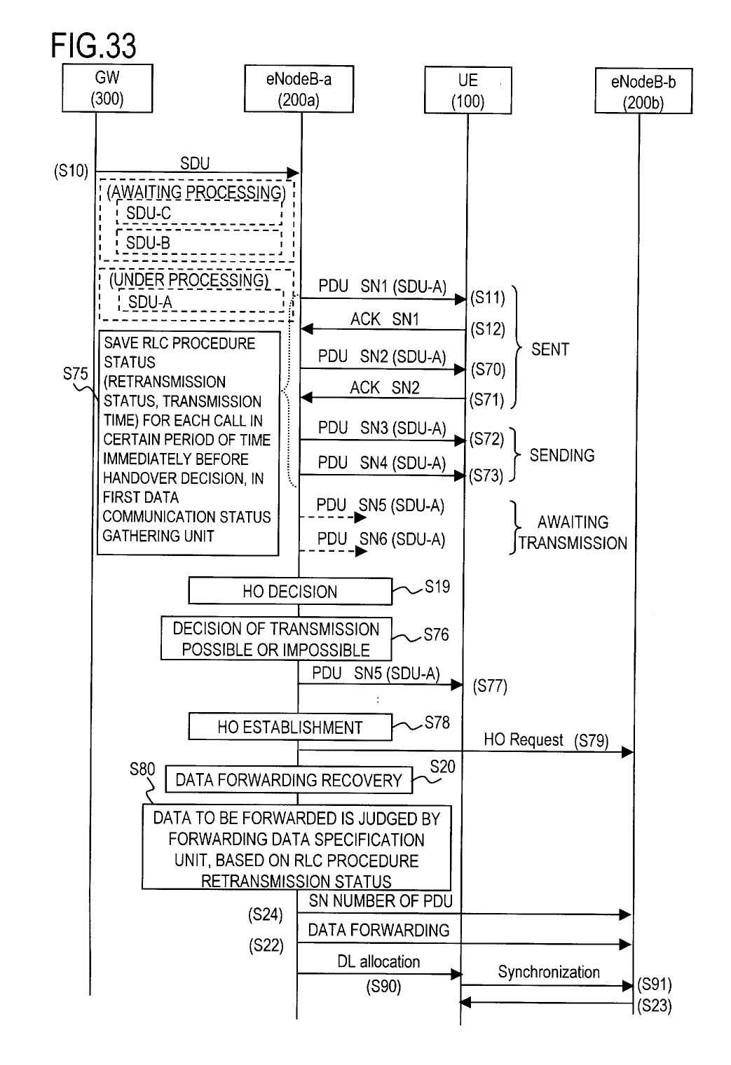

FIG. 33 illustrates a sequence example according to the fifth embodiment, and although the details thereof are described below, the following communication conditions can be envisaged, for instance. More specifically, the serving base station 200a receives SDU-A to SDU-C from the gateway as data addressed to the terminal 100. The serving base station 200a transmits the PDUs having sequence numbers SN1 to SN4 which are included in SDU-A, to the terminal 100 (S11 to S73), and then decides to carry out handover (S19). In this case, the PDUs having sequence numbers SN5 to SN6 included in SDU-A are awaiting transmission (or does not yet be transmitted). The compositional examples of the SDU and the PDU are the same as those of the second embodiment, for instance.

In this case, if the serving base station 200a determines that transmission is possible in the transmission possible/not possible judgment step (S76), then the serving base station 200a transmits the sequence numbers SN5 to SN6 which are awaiting transmission, to the terminal 100 (S77). In this situation, the serving base station 200a forwards SDU-B and SDU-C which have sequence numbers from SN7 onwards, to the target base station 200b, as forwarding data (S22).

In this way, if there is data awaiting transmission (for example, data which has not yet been transmitted), and the serving base station 200a according to the fifth embodiment is capable of transmitting this data, then the serving base station 200a transmits the data awaiting transmission to the terminal 100 and does not forward the data awaiting transmission to the target base station 200b.

By this means, data awaiting transmission (for example, PDUs having sequence numbers SN5 to SN6) is not transmitted to the terminal 100 from the target base station 200b, and the target base station 200b does not transmit the data awaiting transmission to the terminal 100 in a duplicated fashion, as well as the serving base station 200a. Furthermore, in this case, the terminal 100 does not receive the data awaiting transmission (for example, sequence numbers SN5 to SN6) from the two base stations 200a and 200b, and hence there is no duplicated reception.

Moreover, since the data awaiting transmission (for example, sequence numbers SN5 to SN6) is transmitted from the serving base station 200a (for example, in step S77), then it is possible to avoid situations where the data awaiting transmission is not transmitted and a data loss occurs.

This is described in detail below. FIG. 33 to FIG. 44 are diagrams illustrating operational examples according to the fifth embodiment, and the like. The compositional examples of the radio communication system 10, the serving base station 200a, the target base station 200b, and the terminal 100 are the same as those of the second to fourth embodiments (for example, see FIG. 2 to FIG. 4, etc.)

Furthermore, the compositional examples of the SDUs and the PDUs, and the like, are also similar to the second to fourth embodiments; for instance, the SDU-A includes PDUs having sequence numbers SN1 to SN6. Moreover, SDU-B includes PDUs having sequence numbers SN7 to SN12, and SDU-C includes PDUs having sequence numbers SN13 to SN18.

The operational example according to the fifth embodiment includes the following four patterns, similarly to the second embodiment.

1) When forwarding data is determined based on the retransmission status which is held for each call;

2) When forwarding data is determined based on a data communication condition, such as the retransmission occurrence rate, which is held for each adjacent cell;

3) When forwarding data is determined based on the radio wave condition between the serving base station 200a and the terminal 100; and

4) A combination of 1) to 3) above.

Below, four operational examples (first to fourth operational examples) are described, similarly to the second embodiment.

<First Operational Example>

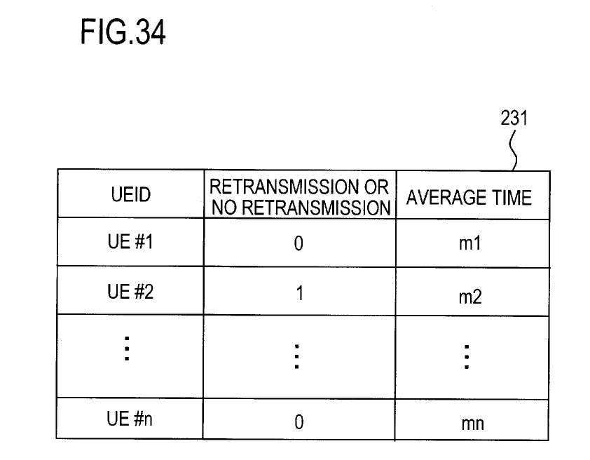

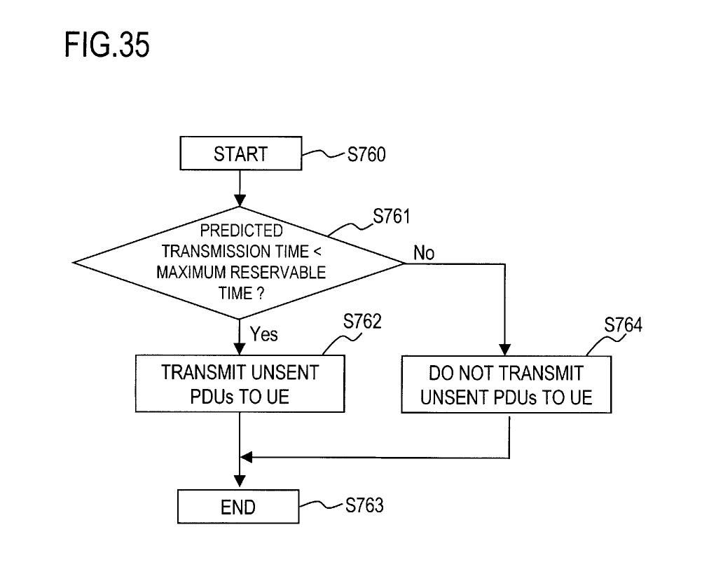

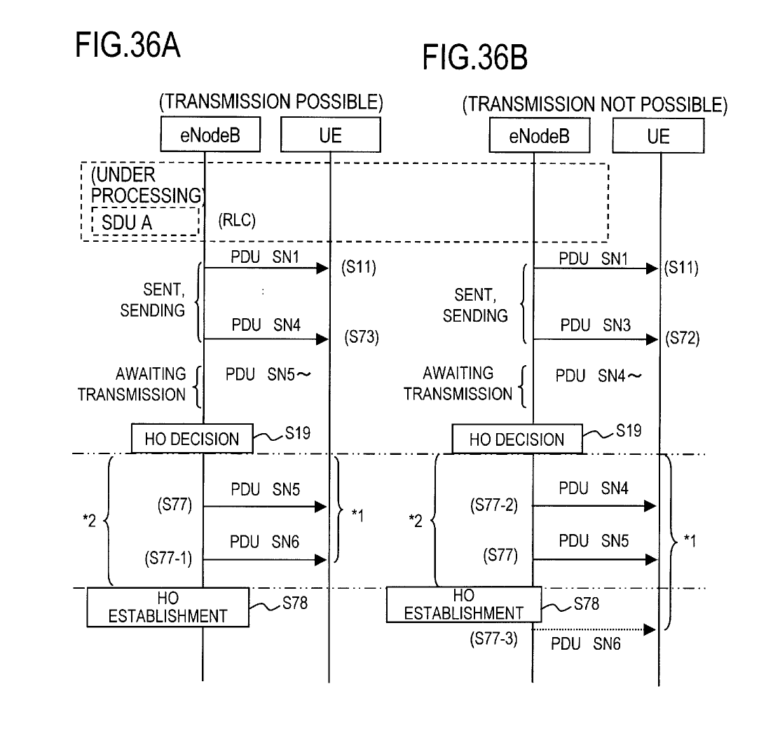

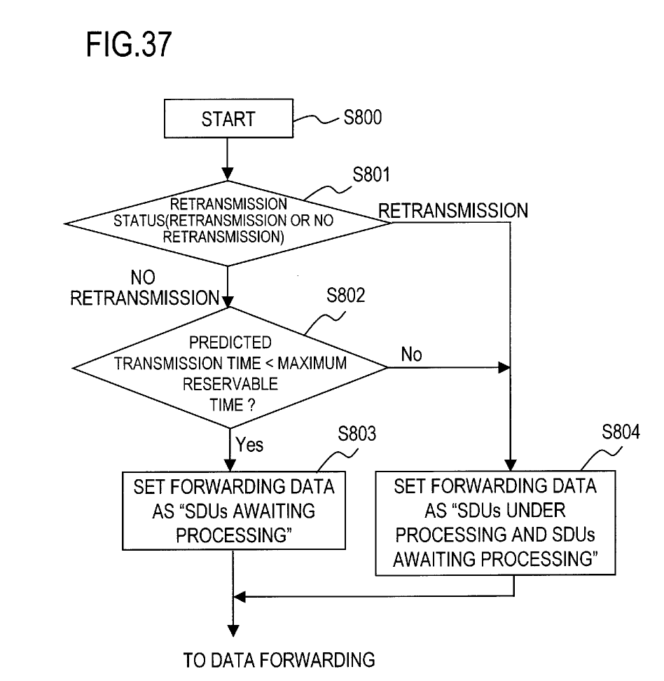

In the first operational example of the fifth embodiment, a handover decision is made when there is data awaiting transmission, and furthermore the forwarding data is determined based on the retransmission status. FIG. 33 illustrates a sequence example of the first operational example; FIG. 34 illustrates an example of the retransmission information table 231 in the first operational example; and FIG. 35 illustrates an example of transmission possible/not possible judgment processing in the first operational example. Furthermore, FIG. 36A and FIG. 36B respectively illustrate a sequence example in the first operational example, and FIG. 37 illustrates an example of a forwarding data determination process according to the first operational example. In FIG. 33 and other drawings, processes which are the same as the first operational example of the second embodiment, and the like, are labeled with the same reference numerals.

As described above, conditions of the following kinds can be envisaged as the communication condition. More specifically, the serving base station 200a receives the data from SDU-A to SDU-C, from the gateway 300, and transmits the data from sequence number SN1 to SN4 which is included in SDU-A, to the terminal 100 (S11 to S73). Of these, the serving base station 200a receives from the terminal 100 an Ack signal in respect of the PDUs having sequence numbers SN1 and SN2, and does not receive an Ack signal in respect of the PDUs having sequence numbers SN3 and SN4. The serving base station 200a decides to perform handover of the terminal 100 (S19), and the PDUs having sequence numbers SN5 and SN6 are awaiting transmission.

In communication conditions of this kind, the serving base station 200a stores the retransmission status and transmission time of each call in the retransmission information table 231 (S75). For example, the first data communication condition gathering unit 221 detects the presence or absence of a retransmission for each call (for instance, for each terminal 100), and also detects the transmission time of each call.

For instance, the first data communication condition gathering unit 221 is able to detect the transmission time by measuring the transmission interval between the PDUs transmitted from the radio transmission and reception unit 210. In the example in FIG. 33, the first data communication condition gathering unit 221 measures the transmission time by measuring the time from the transmission of the PDU having sequence number SN1 until the transmission of the PDU having sequence number SN2. The transmission time can be found by the first data communication condition gathering unit 221 by, for instance, measuring an average time from the transmission times of a plurality of PDUs or by finding the longest or shortest time taken to transmit one PDU.

FIG. 34 is a diagram illustrating a configuration example of the retransmission information table 231 according to the fifth embodiment. The example of the retransmission information table 231 illustrated in FIG. 34 has an “average time” item for the transmission time, and the first data communication condition gathering unit 221 stores a value in this “average time”.

Returning to FIG. 33, after deciding to carry out handover (S19), the serving base station 200a decides whether or not transmission is possible (S76). The serving base station 200a judges whether or not it is possible to transmit the PDUs having sequence numbers SN5 and SN6, which are awaiting transmission, by carrying out a transmission possible/not possible judgment process, for example.

FIG. 35 is a flowchart illustrating an example of a transmission possible/not possible judgment process. The transmission possible/not possible judgment process is carried out by the forwarding data determination unit 243 or the handover decision unit 241, for instance.

Upon starting the transmission possible/not possible judgment process (S760), the serving base station 200a judges whether or not the predicted transmission time is longer then the maximum reservable time (S761). Here, the predicted transmission time and the maximum reservable time will be described.

FIG. 36A and FIG. 36B are diagrams for respectively describing the predicted transmission time and the maximum reservable time.

The predicted transmission time is a time period based on the number of PDUs awaiting transmission, for instance, and is the time taken to complete transmission of the last PDU awaiting transmission after the handover decision (S19). For example, in the examples in FIG. 36A and FIG. 36B, the predicted transmission time is the time from the handover decision (S19) until the end of transmission of the PDU having sequence number SN6, which is the last PDU awaiting transmission (*1).

On the other hand, the maximum reservable time is, for example, the time from the handover decision (S19) until handover is established (S78). Establishment of handover (S78) means a state immediately before reporting a handover request to the handover destination base station 200b, when a handover destination is determined by a handover decision. Consequently, the maximum reservable time is, for example, the time from the handover decision (S19) until immediately before transmitting a handover request (S78) (*2).

The predicted transmission time may also be a time period which changes in accordance with the number of PDUs awaiting transmission or the transmission time taken to transmit one PDU. For example, the forwarding data determination unit 243 is able to calculate the predicted transmission time by reading out the “average time” in the retransmission information table 231 (for example, FIG. 34) and multiplying by the number of PDUs awaiting transmission.

On the other hand, the maximum reservable time is a process which is carried out within a prescribed time period, for example, from the handover decision until the transmitting of a handover request. For example, the maximum reservable time is stored in the memory unit 230 and the forwarding data determination unit 243 is able to read out the maximum reservable time stored in the memory unit 230.

As illustrated in FIG. 36A, when the predicted transmission time (*1) is less than the maximum reservable time (*2), then in this case, there is sufficient time to transmit the sequence numbers SN5 and SN6 awaiting transmission to the terminal 100.

On the other hand, if the predicted transmission time (*1) is equal to or greater than the maximum reservable time (*2), as illustrated in FIG. 36B, then the maximum reservable time (*2) would be exceeded if the PDU having sequence number SN6 which is awaiting transmission are transmitted, and therefore transmission within the maximum reservable time period (*2) is not possible.

Consequently, as illustrated in FIG. 35, if the predicted transmission time is less than the maximum reservable time (Yes at S761), then the forwarding data determination unit 243 can decide to transmit the PDUs awaiting transmission, since there is sufficient time to be able to transmit the PDUs awaiting transmission (S762).

On the other hand, if the predicted transmission time is equal to or greater than the maximum reservable time (No at S761), then there is not sufficient time to transmit the PDUs awaiting transmission within the maximum reservable time, and therefore the forwarding data determination unit 243 can decide not to transmit the PDUs awaiting transmission (S764). For example, it is possible to avoid the occurrence of data loss due to the handover source base station and the terminal 100 becoming unable to communicate before the terminal 100 receives the untransmitted PDUs.

When the forwarding data determination unit 243 determines whether or not transmission is possible (S762 or S764), the transmission possible or not possible judgment process is terminated (S763).

By means of the foregoing, the transmission possible or not possible judgment is made (S76) and it is determined whether or not transmission of the PDUs awaiting transmission is possible, for example.

Returning to FIG. 33, upon carrying out the transmission possible or not possible judgment process (S76), the serving base station 200a either transmits the data awaiting transmission or does not transmit the data awaiting transmission, to the terminal 100, in accordance with this judgment. The example in FIG. 33 is one where the PDUs having sequence numbers SN5 and SN6 which are awaiting transmission are transmitted (S77).

Next, the serving base station 200a establishes handover (S78) and transmits a handover request to the target base station 200b (S79). For example, the handover decision unit 241 generates a handover request to the handover destination base station 200b (or the target base station 200b), in accordance with the handover decision (S19), and is able to transmit this request to the target base station 200b via the facing E-Node IF 250.

The serving base station 200a then performs recovery of data forwarding (S20) and determines the forwarding data (S80).

FIG. 37 is a flowchart illustrating an operational example of a forwarding data determination process. The serving base station 200a is able to determine the forwarding data by carrying out a forwarding data determination process.

Upon starting the forwarding data determination process (S800), the forwarding data determination unit 243 judges the retransmission status (S801).

For example, the forwarding data determination unit 243 determines that the retransmission is performed to the terminal 100 and returns a “retransmission” judgment, when the “retransmission or no retransmission” item is on for the terminal 100 in question, in the retransmission information table 231 (see FIG. 34, for example). On the other hand, the forwarding data determination unit 243 returns a “no retransmission” judgment when the “retransmission or no retransmission” item is off for the terminal 100 in question.

The forwarding data determination unit 243 sets the “SDU under processing” and the “SDUs awaiting processing” as forwarding data, if the judgment is “retransmission” for the terminal 100 which is being handed over (“retransmission” at S801) (S804).

For example, there are also cases where the retransmission is performed again when the serving base station 200a is performed the retransmission in respect of the PDUs having sequence numbers SN3 and SN4 in the example of communication conditions illustrated in FIG. 33. In a case of this kind, SDU-A which includes the PDUs having sequence numbers SN3 and SN4, and also SDU-B and SDU-C which are awaiting processing, are set as forwarding data.

On the other hand, if the retransmission status is judged to be “no retransmission” (“no retransmission” at S801), then the forwarding data determination unit 243 judges whether or not the predicted transmission time is less than the maximum reservable time (S802). This judgment involves the same processing as S761 in the transmission possible/not possible judgment process (S76), for example, judging whether or not there is sufficient time to be able to transmit all of the PDUs awaiting transmission (see FIG. 36A, for instance), or judging whether or not the PDUs awaiting transmission is all transmitted by the judgment process in S761.

Consequently, the forwarding data determination unit 243 judges that there is sufficient time to be able to transmit all of the PDUs awaiting transmission, or judges that all of the PDUs awaiting transmission is transmitted, and sets the “SDUs awaiting processing” as the forwarding data (S803), if the predicted transmission time is less than the maximum reservable time (Yes at S802).

For example, the PDUs having sequence numbers SN5 and SN6 which are awaiting transmission are transmitted to the terminal 100 (S77) in accordance with the transmission possible or not possible process (S76), and if the predicted transmission time is less than the maximum reservable time (Yes at S802), then SDU-B and SDU-C are set as the forwarding data.

On the other hand, if the predicted transmission time is equal to or greater than the maximum reservable time (No at S802), then the forwarding data determination unit 243 sets the “SDUs under processing” and the “SDUs awaiting processing” as the forwarding data (S804). For example, if the predicted transmission time is equal to or greater than the maximum reservable time, the PDUs awaiting transmission are not transmitted to the terminal 100 (see FIG. 36B, for example). Consequently, in order to prevent data loss, for example, the SDU-A which includes PDUs having sequence numbers SN5 and SN6, and the SDU-B and SDU-C which are awaiting processing, are set as forwarding data.

The serving base station 200a determines the forwarding data by the forwarding data determination process (S80) described above. Returning to FIG. 33, the serving base station 200a transmits the forwarding data to the target base station 200b in accordance with the decision made in the forwarding data determination process (S22).

In this case, similarly to the second embodiment, the serving base station 200a may report the sequence number of the PDU at which the target base station 200b starts transmission to the terminal 100 (S24). For example, in the example in FIG. 33, the serving base station 200a can report the sequence number SN7 (if Yes at S802) or the sequence number SN5 (if No at S802). Furthermore, if there is the retransmission in respect of the sequence numbers SN3 and SN4 in the example in FIG. 33, for instance (Yes at S801), then the serving base station 200a can report the sequence number SN3. By reporting a sequence number, it is possible to further prevent duplicated transmission, duplicated reception, and data loss, similarly to the first operational example in the second embodiment.

Thereupon, the serving base station 200a transmits resource allocation information (DL allocation) for the downlink direction (the direction from the base stations 200a and 200b to the terminal 100), to the terminal 100 (S90). This allocation information may include, for instance, identification information for the target base station 200b which is the handover destination of the terminal 100.

The terminal 100 carries out synchronization processing with the target base station 200b (S91), and the target base station 200b becomes the serving base station and is able to receive forwarding data (S23). In this case, if a sequence number is reported (S24), for example, then the terminal 100 is able to receive the PDUs from the reported sequence number onwards, and if a sequence number is not reported, then the terminal 100 is able to receive the PDUs from the PDU having the first sequence number, of the PDUs included in the SDU.

<Second Operational Example>

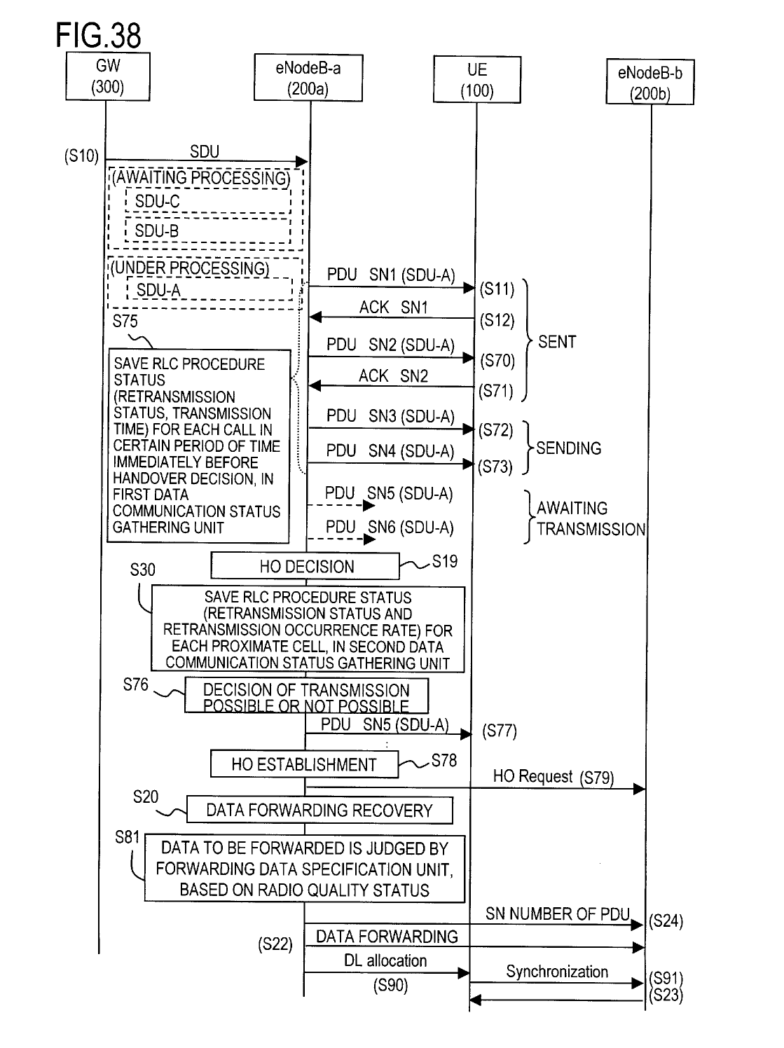

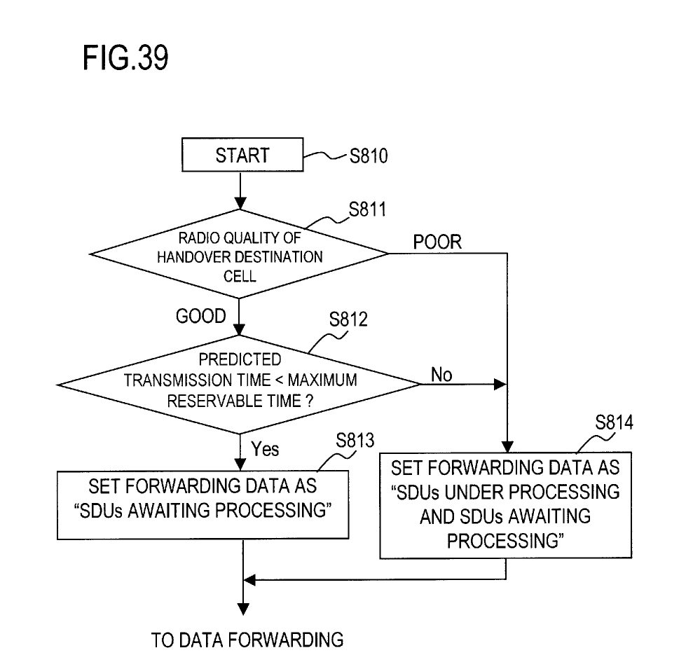

Next, a second operational example will be described. The second operational example is an example where, for example, a handover decision is made when there is data awaiting transmission, and the forwarding data is determined based on the retransmission occurrence rate, and the like. FIG. 38 illustrates a sequence example relating to the second operational example. Furthermore, FIG. 39 is a flowchart illustrating an operational example of a forwarding data determination process according to the second operational example.

As illustrated in FIG. 38, in respect of the communication conditions, similarly to the first operational example, the serving base station 200a transmits PDUs having sequence numbers SN1 to SN4 to the terminal 100, and of these, receives Ack signals corresponding to the PDUs having sequence numbers SN1 and SN2 (S11 to S73). Furthermore, the serving base station 200a makes a handover decision before transmitting the sequence numbers SN5 and SN6 (S19), and therefore the PDUs having sequence numbers SN5 and SN6 are awaiting transmission.

In communication conditions of this kind, similarly to the first operational example, the serving base station 200a holds the retransmission status for each call, and the transmission time, in the retransmission information table 231 (S75). For instance, the first data communication condition gathering unit 221 stores the presence or absence of the retransmission for each call (for each terminal 100, for instance), and the transmission time, during the monitoring period before a handover decision, in the retransmission information table 231 (see FIG. 34, for example).

Thereupon, the serving base station 200a decides to carry out handover (S19) and stores the retransmission status and the retransmission occurrence rate for each adjacent cell in the statistical information table 232 (S30).

Similarly to the second embodiment, for example, the second data communication condition gathering unit 242 writes the count value of the “RLC procedure status” (either “retransmission” or “no retransmission”) in the statistical information table 232 (see FIG. 13A, for example), based on the retransmission information table 231 (see FIG. 34, for example). The second data communication condition gathering unit 242 calculates the retransmission occurrence rate based on the count value, and stores the calculated value as the “retransmission occurrence rate” item in the statistical information table 232. The second data communication condition gathering unit 242 makes a quality judgment based on the “retransmission occurrence rate” in the statistical information table 232, and stores either “good” or “poor” as the “quality judgment” item in the statistical information table 232.

Thereupon, the serving base station 200a carries out transmission possible/not possible judgment (S76). The transmission possible/not possible judgment process is the same as that of the first operational example according to the fifth embodiment (see FIG. 35, for example). For instance, the forwarding data determination unit 243 decides that the PDUs awaiting transmission can be transmitted to the terminal 100 if the predicted transmission time is less than the maximum reservable time (Yes at S761 in FIG. 35). On the other hand, the forwarding data determination unit 243 decides not to transmit the PDUs awaiting transmission (S764), if the predicted transmission time is equal to or greater than the maximum reservable time (No at S761).

Returning to FIG. 38, the serving base station 200a transmits the PDUs awaiting transmission to the terminal 100 (S77), if it is judged that transmission is possible in the transmission possible/not possible judgment.

Next, the serving base station 200a establishes handover (S78) and transmits a handover request for the terminal 100, to the target base station 200b (S79). The target base station 200b is able to transmit a response to the handover request, to the serving base station 200a.

The serving base station 200a then performs recovery of data forwarding (S20) and determines the forwarding data based on the radio quality status (S81).

FIG. 39 is a flowchart illustrating an operational example of a forwarding data determination process according to the second operational example. For example, the forwarding data determination unit 243 determines the forwarding data by using the statistical information table 232 stored in the memory unit 230.

Upon starting the forwarding data determination process (S810), the forwarding data determination unit 243 judges the radio quality of the handover destination cell (S811). The forwarding data determination unit 243 reads out and assesses the “quality judgment” relating to the target base station 200b in the statistical information table 232.

The forwarding data determination unit 243 sets the “SDU under processing” and the “SDUs awaiting processing” as the forwarding data (S814), if the “quality judgment” for the target base station 200b is “poor” (“poor” at step S811).

For example, since no Ack signal is received from the terminal 100 in respect of the PDUs having sequence numbers SN3 and SN4, and the radio quality is “poor”, then the possibility that the PDUs having these sequence numbers is correctly received in the terminal 100 is lower than in a case where the radio quality is “good”. Therefore, in a case of this kind, the forwarding data determination unit 243 sets the “SDU under processing” and the “SDUs awaiting processing” as the forwarding data.

On the other hand, if the “quality judgment” for the target base station 200b is “good” (“good” at S811), then the forwarding data determination unit 243 judges whether or not the predicted transmission time is less than the maximum reservable time (S812).

Similarly to the judgment in the first operational example (S802 in FIG. 37, for example), this judgment involves determining whether or not it is possible to transmit the PDUs awaiting transmission, for example, (or whether or not the PDUs awaiting transmission is transmitted). In the second operational example, if it is judged that the PDUs awaiting transmission can be transmitted, in the transmission possible or not possible judgment processing (S76), then the PDUs awaiting transmission are transmitted (S77), and if the PDUs awaiting transmission is transmitted, then transmission of these PDUs to the target base station 200b can be omitted.

Consequently, if the predicted transmission time is less than the maximum reservable time (Yes at S812), then the forwarding data determination unit 243 sets the “SDUs awaiting processing” as the forwarding data (S813). For example, if the PDUs having sequence numbers SN5 and SN6 which are awaiting transmission can be transmitted (or is transmitted), then the forwarding data determination unit 243 can determine SDU-B and SDU-C, which are “SDUs awaiting processing”, as the forwarding data.

On the other hand, if the predicted transmission time is equal to or greater than the maximum reservable time (No at S812), then the forwarding data determination unit 243 sets the “SDUs under processing” and the “SDUs awaiting processing” as the forwarding data (S814). For example, if the PDUs having sequence numbers SN5 and SN6 which are awaiting processing cannot be transmitted (or is transmitted), then the forwarding data determination unit 243 can determine SDU-A, which is an “SDU under processing”, and SDU-B and SDU-C, which are “SDUs awaiting processing”, as the forwarding data. By means of the foregoing, the serving base station 200a is able to determine the forwarding data.

Returning to FIG. 38, the serving base station 200a forwards the determined forwarding data to the target base station 200b (S22). In this case, similarly to the first operational example, the serving base station 200a may report the sequence number of the PDU from which the target base station 200b starts transmission (S24).

The serving base station 200a then transmits the downlink allocation information (DL allocation) to the terminal 100 (S90), and the terminal 100 carries out synchronization processing with the target base station 200b, which is the handover destination (S91). The terminal 100 is able to receive the forwarded data from the base station 200b which was the serving base station (S23).

<Third Operational Example>

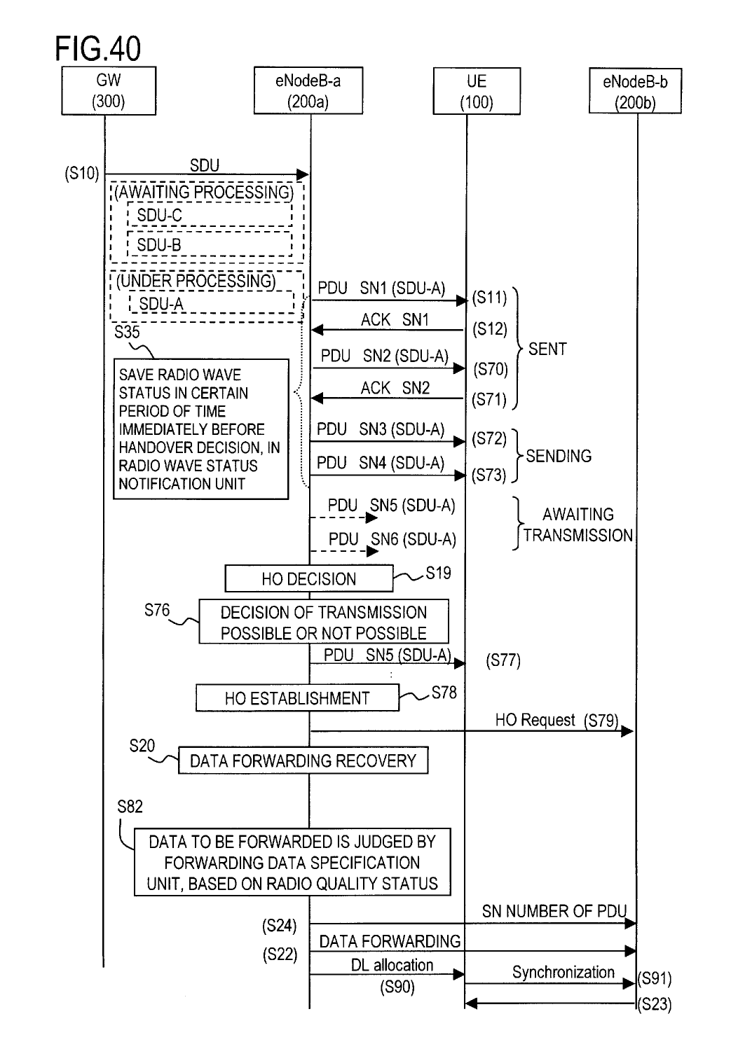

Next, a third operational example of the fifth embodiment will be described. The third operational example is an example where, for example, a handover decision is made when there is data awaiting transmission, and the forwarding data is determined based on the radio wave condition, and the like. For example, FIG. 39 and FIG. 40 illustrate a sequence example, or the like, according to this third operational example.

FIG. 40 is a diagram illustrating a sequence example according to the third operational example. In this third operational example, the serving base station 200a transmits PDUs having sequence numbers SN1 to SN4, to the terminal 100, and of these, receives Ack signals in relation to the PDUs having sequence numbers SN1 and SN2 (S11 to S73). Furthermore, the serving base station 200a makes a handover decision before transmitting the sequence numbers SN5 and SN6 (S19), and therefore the PDUs having sequence numbers SN5 and SN6 are awaiting transmission.

In communication conditions of this kind, the serving base station 200a holds the radio wave condition for a prescribed period of time (S35). Similarly to the third operational example in the second embodiment, the radio wave status notification unit 211 measures the reception power of an Ack signal received from the terminal 100, or the noise in relation to the reception power, or the like, as the radio quality, and stores this as the radio wave condition in the radio wave condition table 233. FIG. 17A is a diagram illustrating an example of a radio wave condition table 233. Similarly to the third operational example in the second embodiment, the radio wave condition notification unit 211 stores a radio quality value in the item “radio wave condition” of the radio wave condition table 233, and stores “good” or “poor” in the “quality judgment” item by means of threshold value judgment, or the like (see FIG. 17B, for example). The value stored as the “radio wave condition” may be an average value of a plurality of measurements, similarly to the third operational example in the second embodiment, or alternatively, the latest value may be stored or the maximum or minimum value within a certain period, or the like, may be stored.

After the handover decision (S19), the serving base station 200a carries out transmission possible/not possible judgment (S76). For example, similarly to the first operational example, the forwarding data determination unit 243 or the handover decision unit 241 judges whether or not it is possible to transmit the data awaiting transmission, by finding out whether or not the predicted transmission time is less than the maximum reservable time (S761) in the flowchart illustrated in FIG. 35.

Returning to FIG. 40, the serving base station 200a is able to transmit the PDUs awaiting transmission (S77) if it is judged by the transmission possible/not possible judgment (S76) that the PDUs awaiting transmission can be transmitted. In the example in FIG. 40, the serving base station 200a judges that the PDUs having sequence numbers SN5 and SN6 which are awaiting transmission can be transmitted, and transmits these PDUs. On the other hand, if it is judged that the data awaiting transmission cannot be transmitted, then the serving base station 200a does not transmit the data awaiting transmission.

Next, the serving base station 200a establishes handover (S78) and transmits a handover request to the target base station 200b (S79).

The serving base station 200a then performs recovery of data forwarding (S20) and determines the forwarding data based on the radio quality status (S82).

The forwarding data determination process can be executed according to the flowchart illustrated in FIG. 39, similarly to the second operational example in the fifth embodiment, for instance. For example, the forwarding data determination unit 243 determines the forwarding data by using the radio wave condition table 233 stored in the memory unit 230.

When the forwarding data determination process starts (S810), the forwarding data determination unit 243 judges the radio quality of the handover destination cell (S811). Similarly to the third operational example in the second embodiment, for example, the forwarding data determination unit 243 is able to read out and assess the “quality judgment” for the target base station 200b in the radio wave condition table 233.

The forwarding data determination unit 243 sets the “SDU under processing” and the “SDUs awaiting processing” as the forwarding data (S814), if the radio quality of the handover destination cell is “poor” (“poor” at step S811). In the example in FIG. 33, if the radio quality is “poor”, then in the forwarding data, the “SDU under processing” is SDU-A and the “SDUs awaiting processing” are SDU-B and SDU-C.

On the other hand, if the radio quality of the handover destination cell is “good” (“good” at S811), then the forwarding data determination unit 243 judges whether or not the predicted transmission time is less than the maximum reservable time (S812). Similarly to the second operational example, the forwarding data determination unit 243 judges whether or not the PDUs awaiting transmission can be transmitted (or whether or not the PDUs awaiting transmission is transmitted), for instance. In the third operational example, if it is judged that the PDUs awaiting transmission can be transmitted, in the transmission possible or not possible judgment process (S76), then the PDUs awaiting transmission are transmitted (S76), and if the PDUs awaiting transmission is transmitted, then transmission of these PDUs to the target base station 200b can be omitted.

Consequently, if the predicted transmission time is less than the maximum reservable time (Yes at S812), then the forwarding data determination unit 243 sets the “SDUs awaiting processing” as the forwarding data (S813). For example, if the PDUs having sequence numbers SN5 and SN6 which are awaiting transmission can be transmitted (or is transmitted), then the forwarding data determination unit 243 can determine SDU-B and SDU-C, which are “SDUs awaiting processing”, as the forwarding data.

On the other hand, if the predicted transmission time is equal to or greater than the maximum reservable time (No at S812), then the forwarding data determination unit 243 sets the “SDUs under processing” and the “SDUs awaiting processing” as the forwarding data (S814). For example, if the PDUs having sequence numbers SN5 and SN6 which are awaiting processing cannot be transmitted (or does not be transmitted), then the forwarding data determination unit 243 can determine SDU-A, which is an “SDU under processing”, and SDU-B and SDU-C, which are “SDUs awaiting processing”, as the forwarding data. By means of the foregoing, the serving base station 200a is able to determine the forwarding data.

Returning to FIG. 40, the serving base station 200a forwards the forwarding data to the target base station 200b (S22). In this case, similarly to the first operational example and the like, the serving base station 200a may report the sequence number of the PDU from which transmission is started in the target base station 200b (S24).

The serving base station 200a then transmits the downlink allocation information (DL allocation) to the terminal 100 (S90), and the terminal 100 carries out synchronization processing with the target base station 200b, which is the handover destination (S91). The terminal 100 is able to receive the forwarded data from the base station 200b which becomes the serving base station (S23).

<Fourth Operational Example>

Next, a fourth operational example, in other words, a combination of the first to third operational examples will be described. Firstly, a combination of the first operational example (the retransmission status for each call) and the second operational example (the radio quality based on the retransmission occurrence rate) will be described, whereupon a combination of the first operational example and the third operational example (radio quality based on the radio wave condition) will be described, and finally a combination of the second operational example and the third operational example will be described.

<1. Combination of First Operational Example and Second Operational Example>

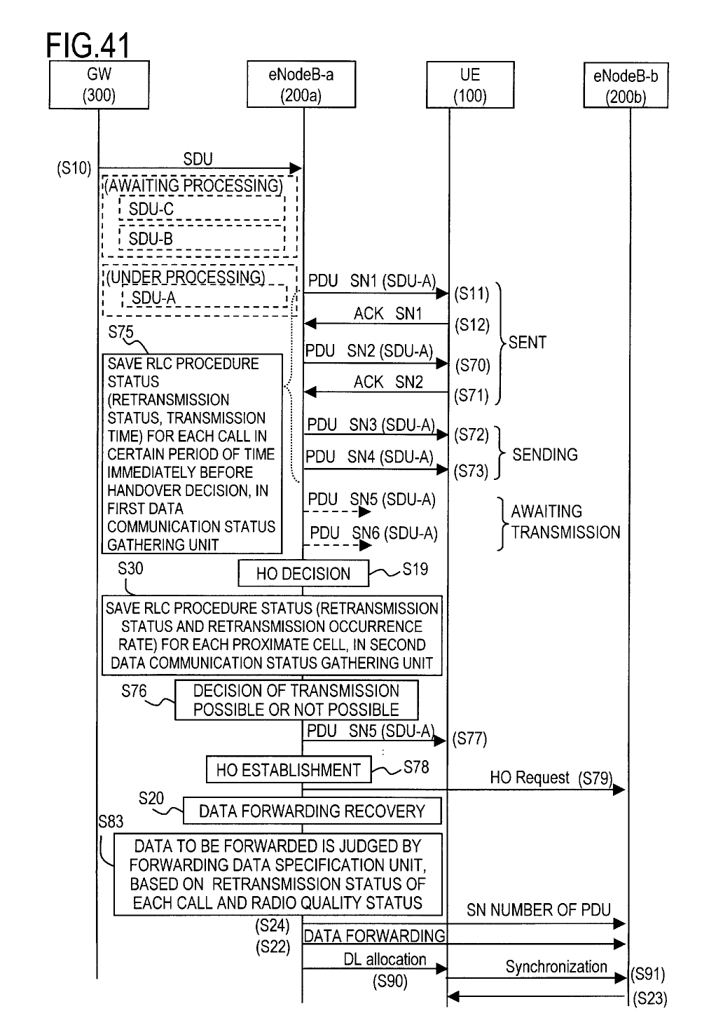

Firstly, a combination of the first operational example and the second operational example according to the fifth embodiment will be described. FIG. 41 to FIG. 43 are diagrams illustrating a sequence example, and the like, according to this operational example. Parts which perform the same processing as the first operational example and the second operational example are labeled with the same reference numerals.

Of these, FIG. 41 is a diagram illustrating a sequence example, and the like, according to this operational example. In respect of the communication condition, similarly to the first operational example, and the like, the serving base station 200a transmits PDUs having sequence numbers SN1 to SN4 to the terminal 100, and of these, receives Ack signals corresponding to the PDUs having sequence numbers SN1 and SN2. Furthermore, the serving base station 200a makes a handover decision before transmitting the sequence numbers SN5 and SN6 (S19), and therefore the PDUs having sequence numbers SN5 and SN6 are awaiting transmission.

In a communication condition of this kind, similarly to the first operational example, the serving base station 200a holds the retransmission status for each call, and the transmission time, in the retransmission information table 231 (see FIG. 34, for example) (S75). For instance, the first data communication condition gathering unit 221 stores the retransmission status and the transmission time in the retransmission information table 231.

Thereupon, the serving base station 200a decides to carry out handover (S19) and, similarly to the second operational example, stores the retransmission status and the retransmission occurrence rate for each adjacent cell, in the statistical information table 232 (S30). For instance, the second data communication condition gathering unit 242 stores values, or the like, in the respective items of the statistical information table 232 (see FIG. 13A, for example), based on the retransmission information table 231.

Thereupon, the serving base station 200a determines whether or not it is possible to transmit the PDUs awaiting transmission (S76). For example, similarly to the first operational example according to the fifth embodiment, and the like, the handover decision unit 241 or forwarding data determination unit 243 carries out a transmission possible/not possible judgment process (see FIG. 35, for example) and decides whether or not transmission is possible, by judging whether or not the predicted transmission time is less than the maximum reservable time (S761 in FIG. 35, for example).

The serving base station 200a transmits the PDUs awaiting transmission (S77) if it is judged by the transmission possible/not possible judgment (S76) that the PDUs awaiting transmission can be transmitted. On the other hand, if it is judged by the transmission possible/not possible judgment (S76) that the PDUs awaiting transmission cannot be transmitted, then the serving base station 200a does not transmit these PDUs.

Next, the serving base station 200a establishes handover (S78) and transmits a handover request to the target base station 200b (S79).

The serving base station 200a then performs recovery of data forwarding (S20) and determines the forwarding data based on the radio quality status (S83).

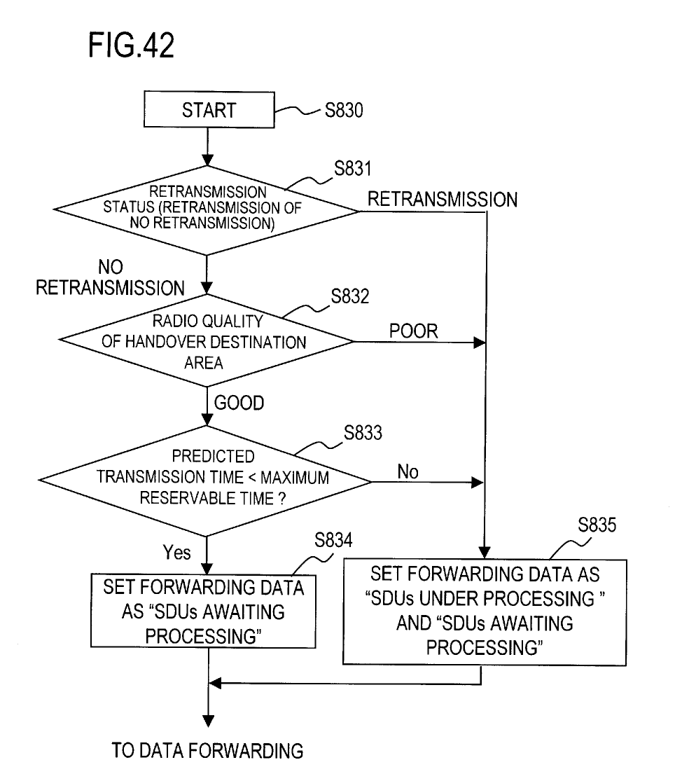

FIG. 42 is a flowchart illustrating an example of a forwarding data determination process according to the present operational example. For example, the forwarding data determination unit 243 is able to determine forwarding data by using the retransmission information table 231 (see FIG. 34, for example) and the statistical information table 232 (see FIG. 13A, for example) which are stored in the memory unit 230.

Upon starting the forwarding data determination process (S830), the forwarding data determination unit 243 judges the retransmission status (S831). For example, similarly to the first operational example of the fifth embodiment, the forwarding data determination unit 243 is able to judge the retransmission status based on the presence or absence of the retransmission, which is stored in the retransmission information table 231.

The forwarding data determination unit 243 sets the “SDU under processing” and the “SDUs awaiting processing” as forwarding data, if the judgment is “retransmission” for the terminal 100 which is being handed over (“retransmission” at S831) (S835). For example, if the serving base station 200a performs the retransmission in respect of the PDUs having sequence numbers SN3 and SN4 in the example in FIG. 33, then it is possible to determine the forwarding data as the “SDU under processing”, which is SDU-A that includes the PDUs having these sequence numbers, and the “SDUs awaiting processing”, which are SDU-B and SDU-C.

On the other hand, the forwarding data determination unit 243 judges the radio quality in the handover destination area (S832), when there is a “no retransmission” judgment (“no retransmission” at S831) in respect of the terminal 100 which is being handed over. The radio quality is judged, for example, by means of the forwarding data determination unit 243 reading out the “quality judgment” item in respect of the target base station 200b in the statistical information table 232.

The forwarding data determination unit 243 sets the “SDU under processing” and the “SDUs awaiting processing” as the forwarding data (S835), if the radio quality of the handover destination area is “poor” (“poor” at step S832).

For example, even if the serving base station 200a does not be carried out the retransmission in respect of the PDUs (“no retransmission” at S831), when the radio quality in relation to the target base station 200b is “poor” (“poor” at S833), then the possibility that the terminal 100 correctly receives the PDU under processing is low compared to a case where the radio quality is “good”. Therefore, in a case of this kind, the forwarding data determination unit 243 sets the “SDU under processing” and the “SDUs awaiting processing” as the forwarding data.

On the other hand, if the radio quality of the handover destination area is “good” (“good” at S832), then the forwarding data determination unit 243 judges whether or not the predicted transmission time is less than the maximum reservable time (S833). Similarly to the judgment in the first operational example (S802 in FIG. 37, for example), this judgment involves determining whether or not it is possible to transmit the PDUs awaiting transmission, for example, (or whether or not the PDUs awaiting transmission could be transmitted).

Consequently, if the predicted transmission time is less than the maximum reservable time (Yes at S833), then the forwarding data determination unit 243 sets the “SDUs awaiting processing” as the forwarding data (S834).

For example, if no retransmission is performed (“no retransmission” at S831) and the radio quality is “good” (“good” at S832), and if the PDUs awaiting transmission can be transmitted (or is transmitted) (Yes at S833), then the possibility that the PDUs awaiting transmission is correctly received in the terminal 100 is higher than cases where the radio quality is “poor”. In cases such as this, the forwarding data determination unit 243 can omit the SDU including the PDUs awaiting transmission (or the “SDU under processing”) from the forwarding data. By omitting the SDU including PDUs awaiting transmission, from the forwarding data, it is possible to prevent situations where the PDUs awaiting transmission are transmitted to the terminal 100 from the target base station 200b despite the fact that the PDUs awaiting transmission is transmitted (S76), and therefore duplicated transmission and duplicated reception can be prevented. In the example in FIG. 33, if no retransmission is performed, if the radio quality in relation to the target base station 200b is “good”, and if the PDUs having sequence numbers SN3 and SN4 which are awaiting transmission is transmitted (S77), then the forwarding data is SDU-B and SDU-C, which are the “SDUs awaiting processing”.

On the other hand, if the predicted transmission time is equal to or greater than the maximum reservable time (No at S833), then the forwarding data determination unit 243 sets the “SDUs under processing” and the “SDUs awaiting processing” as the forwarding data (S835).

For example, if no retransmission is performed (“no retransmission” at S831), if the radio quality is “good” (“good at S832), and if the PDUs awaiting transmission cannot be transmitted (Yes at S833), then the PDUs awaiting transmission are not transmitted from the serving base station 200a to the terminal 100. In cases such as this, in order to prevent data loss in the terminal 100, the forwarding data determination unit 243 sets the “SDU under processing” which includes PDUs awaiting transmission and the “SDUs awaiting processing” as the forwarding data.

By means of the foregoing, a forwarding data determination process (S83 in FIG. 41) is carried out, and the serving base station 200a then forwards the forwarding data determined by the forwarding data determination process (S22). In this case, similarly to the first operational example and the like, the serving base station 200a may report the sequence number of the PDU from which transmission is to be started (S24).

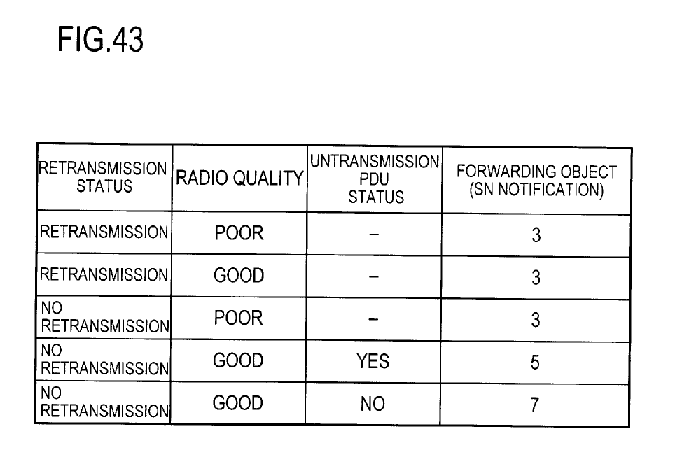

FIG. 43 is a diagram illustrating an example of forwarding data in the example in FIG. 41. As illustrated in FIG. 43, if the retransmission status is “no retransmission”, the radio quality is “good” and there are no untransmitted PDUs (the PDUs awaiting transmission is transmitted (S77) or can be transmitted), then the sequence number SN7 is reported. On the other hand, if the retransmission status is “no retransmission”, the radio quality is “good” and there are untransmitted PDUs (the PDUs awaiting transmission is transmitted or cannot be transmitted), then the sequence number SN5 of the PDU awaiting transmission is reported. In other situations, the sequence number SN3 of the PDU under transmission for which an Ack signal does not be received, is reported.

The serving base station 200a then transmits the downlink allocation information (AL allocation) to the terminal 100 (S90), and the terminal 100 carries out synchronization processing with the target base station 200b, which is the handover destination (S91), and is able to receive the forwarded data (S23).

<2. Combination of First Operational Example and Third Operational Example>

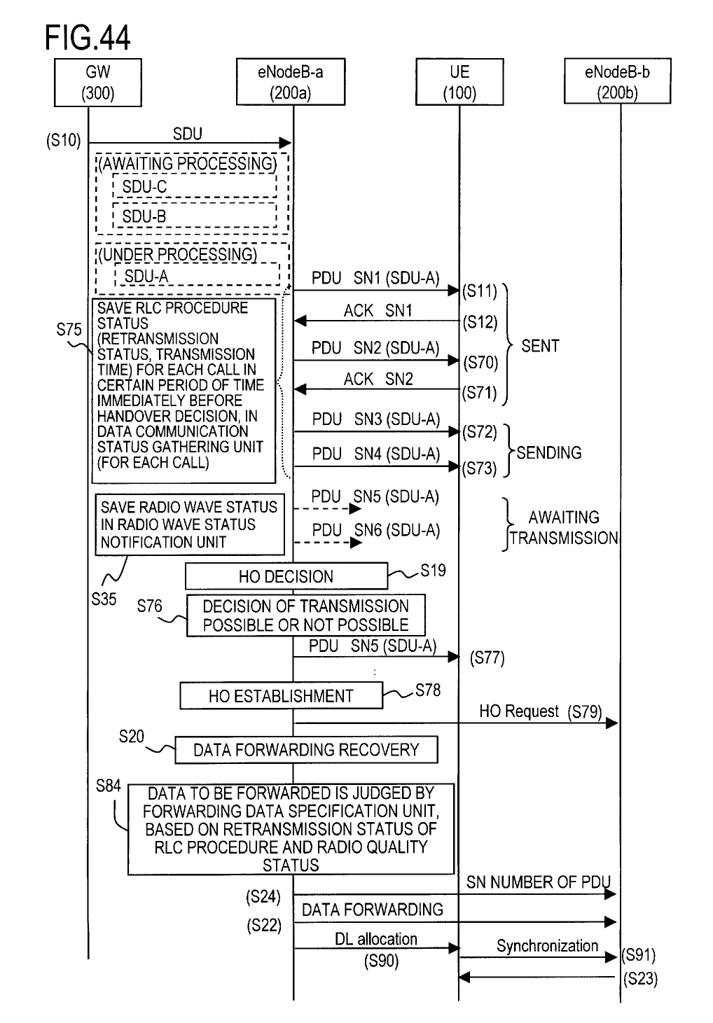

Next, a fourth operational example is described, which is an operational example that combines the first operational example (the retransmission status for each call) and the third operational example (the radio quality based on the radio wave status). FIG. 44 is a diagram illustrating a sequence example according to this operational example.

Similarly to the first operational example, the serving base station 200a holds the retransmission status for each call, and the transmission time, in the retransmission information table 231 (see FIG. 34, for example) (S75). Furthermore, similarly to the third operational example, the serving base station 200a holds the radio wave condition in the radio wave condition table 233 (see FIG. 17A, for example) (S35).

Next, the serving base station 200a decides to carry out handover (S19), and carries out transmission possible/not possible judgment (S76). The serving base station 200a is able to transmit the PDUs awaiting transmission to the terminal 100 (S77), if it is determined by the transmission possible/not possible judgment (S76 in FIG. 35, for example) that the PDUs awaiting transmission can be transmitted. On the other hand, the serving base station 200a does not transmit the PDUs awaiting transmission if it is judged by the transmission possible/not possible judgment (S76) that the PDUs awaiting transmission cannot be transmitted.

Next, the serving base station 200a establishes handover (S78) and transmits a handover request to the target base station 200b (S79).

The serving base station 200a then performs recovery of data forwarding (S20) and determines the forwarding data based on the radio quality status (S84). The forwarding data determination process according to this operational example can be implemented by the flow in FIG. 42, similarly to the combination of the first operational example and the second operational example, for instance. In this case, the radio quality of the handover destination area in FIG. 42 is judged by the “good” or “poor” value stored in the “radio quality” item of the radio wave status table 233.

In the forwarding data determination process according to the present operational example also, if the retransmission status is “no retransmission” (“no retransmission” at S831), the radio quality is “good” (“good” at S832), and the PDUs awaiting transmission can be transmitted (or is transmitted) (Yes at S833), then the “SDUs awaiting processing” are set as forwarding data (S834). By this means, for example, it is possible to prevent duplicated transmission and duplicated reception.

On the other hand, in other circumstances relating to the retransmission status, the radio quality and the PDUs awaiting transmission (“retransmission” at S831, “poor” at S832 or “No” at S833), then the “SDU under processing” and the “SDUs awaiting processing” are set as the forwarding data (S835). By this means, for example, it is possible to prevent data loss.

Returning to FIG. 44, the serving base station 200a transmits the forwarding data determined by the forwarding data determination process (S84), to the target base station 200b (S22). In this case, the serving base station 200a is also able to report the sequence number (S24). FIG. 43 illustrates an example of a sequence number which is reported in the present operational example, similarly to an example where the first operational example and the second operational example are combined.

Thereafter, the serving base station 200a transmits allocation information (DL allocation) (S90), and the terminal 100 carries out synchronization processing (S91) and is able to receive forwarding data from the base station 200b which becomes the serving base station (S23).

<3. Combination of Second Operational Example and Third Operational Example>

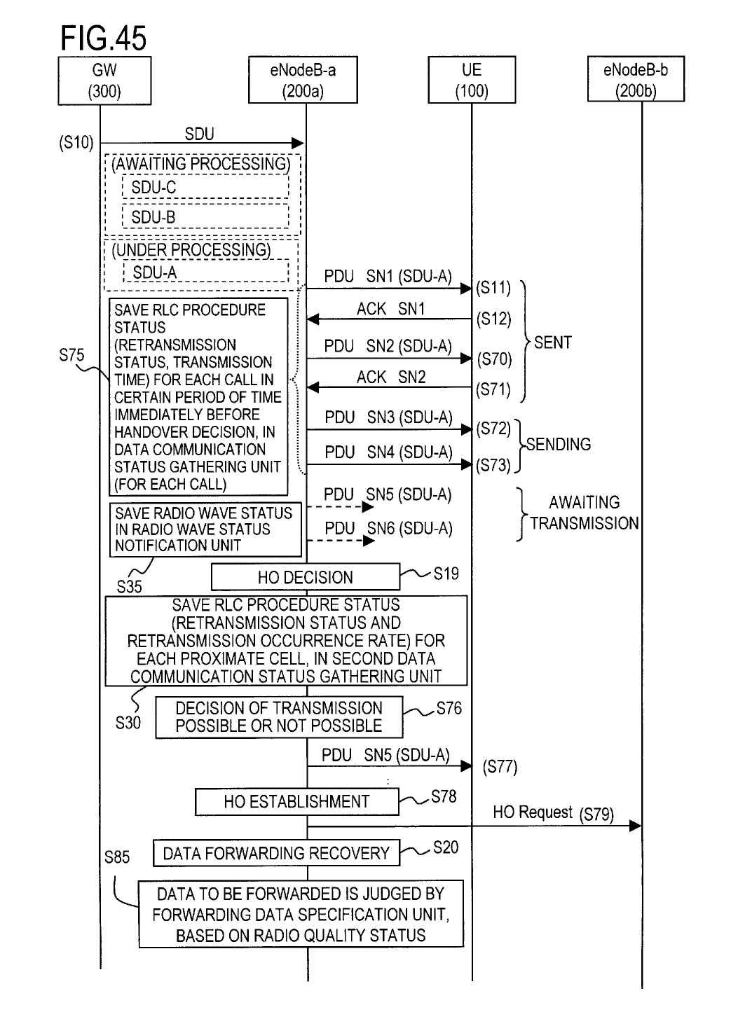

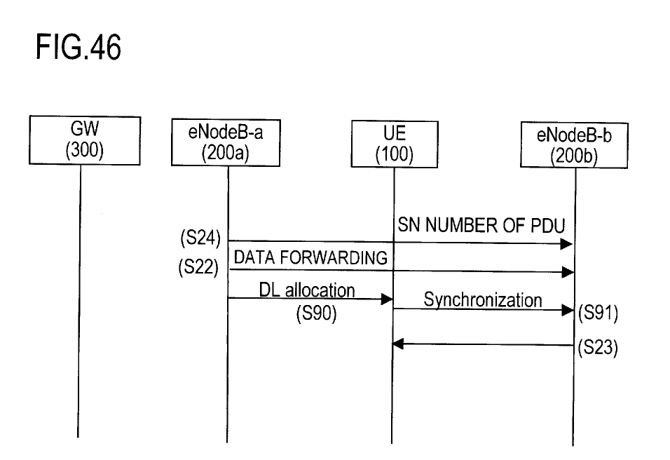

Next, a combination of the second operational example (radio quality based on the retransmission occurrence rate) and the third operational example (radio quality based on radio wave status) will be described. FIG. 45 and FIG. 46 respectively illustrate sequence examples according to the present operation.

Similarly to the first or second operational example, the serving base station 200a holds the retransmission status for each call, and the transmission time, in the retransmission information table 231 (see FIG. 34, for example) (S75). Furthermore, similarly to the third operational example, the serving base station 200a holds the radio wave condition in the radio wave condition table 233 (see FIG. 17A, for example) (S35).

Thereupon, when the serving base station 200a decides to carry out handover (S19), similarly to the second operational example, it stores the retransmission status and the retransmission occurrence rate for each adjacent cell, in the statistical information table 232 (S30). For instance, the second data communication condition gathering unit 242 stores values, or the like, in the respective items of the statistical information table 232 (see FIG. 13A, for example), based on the retransmission information table 231.

Thereupon, the serving base station 200a decides whether or not the PDUs awaiting transmission can be transmitted (S76), transmits the PDUs awaiting transmission if the PDUs awaiting transmission can be transmitted according to the transmission possible/not possible judgment (S76), and does not transmit these PDUs if they cannot be transmitted.

Next, the serving base station 200a establishes handover (S78) and transmits a handover request to the target base station 200b (S79).

The serving base station 200a then performs recovery of data forwarding (S20) and determines the forwarding data (S85). Similarly to the fourth embodiment, the forwarding data determination process according to this operational example determines the final “radio quality” based on a combination of two radio qualities, namely, the “radio quality” in the statistical information table 232 and the “radio quality” in the radio wave condition table 233 (see FIG. 32, for example). Processing is then implemented by applying the determined “radio quality” as the “radio quality of the handover destination cell” (S811 in FIG. 39) in the forwarding data determination process (see FIG. 39, for example).

For example, as illustrated in FIG. 32, if the “radio quality” in the statistical information table 232 (the radio quality based on the retransmission occurrence rate” in FIG. 32) is “good” and the “radio quality” in the radio wave condition table 233 (the “radio quality based on the radio wave condition” in FIG. 32) is “good”, then the final radio quality can be determined as “good”. In this case, in the forwarding data determination process (FIG. 39, for example), the radio quality of the handover destination cell is judged to be “good” (“good” at S811). On the other hand, if the “radio quality” of the two tables 232 and 233 is not “good” in both cases, then the final radio quality is judged to be “poor” (see FIG. 32, for example), and the radio quality of the handover destination cell is judged to be “poor” (“poor” at S811).

In the operational examples below, similarly to the fifth embodiment, the forwarding data can be determined by means of a forwarding data determination process (see FIG. 39, for example).

Returning to FIG. 45, when the forwarding data is determined (S85), the serving base station 200a is able to carry out data forwarding (S22 in FIG. 46) and also report a sequence number (S24). The processing thereafter can be carried out similarly to the third operational example, or the like.

### Sixth Embodiment

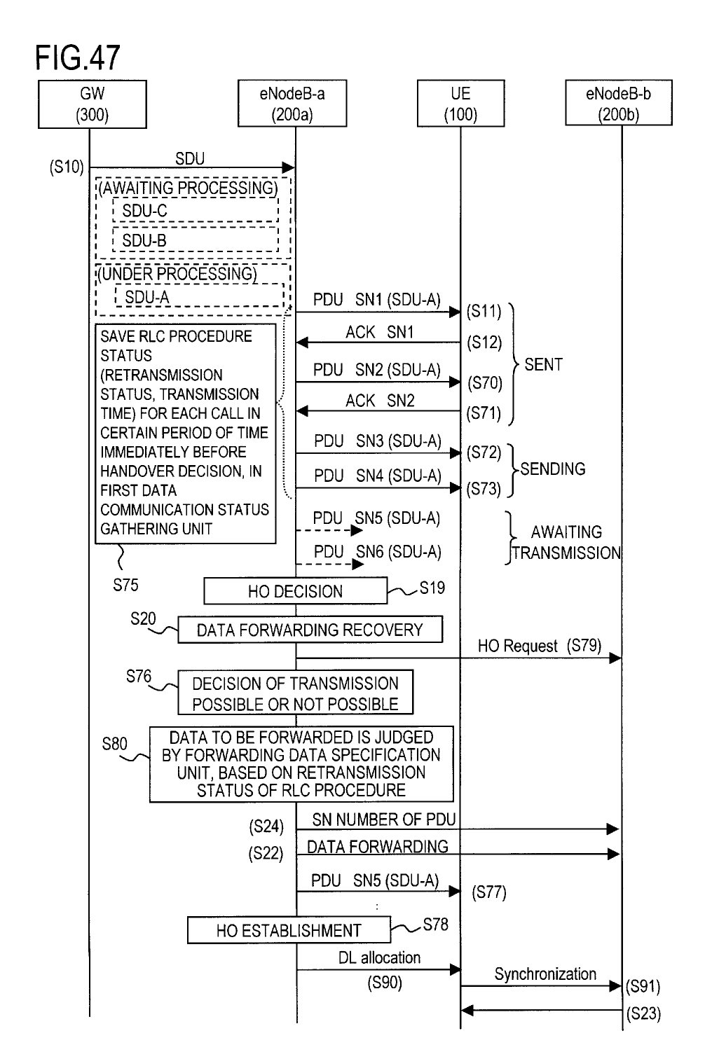

Next, a sixth embodiment of the invention will be described. The fifth embodiment was described with reference to an example where the forwarding data is determined after transmitting PDUs awaiting transmission, when there are PDUs awaiting transmission. The sixth embodiment is described in relation to an example where the forwarding data is determined in advance, and PDUs awaiting transmission are transmitted subsequently. FIG. 47 to FIG. 55 are diagrams which respectively illustrate sequence examples, and the like, according to the sixth embodiment.

The respective compositional examples of the radio communication system 10, the base stations 200a and 200b, and the terminal 100, are similar to the second embodiment, for instance, which are illustrated respectively in FIG. 2 to FIG. 4. Furthermore, the communication conditions and the compositional examples of the SDUs and PDUs, and the like, are similar to the second embodiment.

The operational example according to the sixth embodiment includes the following four patterns, similarly to the second embodiment or the fifth embodiment.

1) When forwarding data is determined based on the retransmission status which is held for each call;

2) When forwarding data is determined based on a data communication condition, such as the retransmission occurrence rate which is held for each adjacent cell;

3) When forwarding data is determined based on the radio wave condition between the serving base station 200a and the terminal 100; and

4) A combination of 1) to 3) above.

Below, four operational examples (first to fourth operational examples) are described successively, similarly to the second embodiment.

<First Operational Example>

The first operational example is an example where, for instance, a handover decision is made when there is data awaiting transmission, and furthermore the forwarding data is determined based on the retransmission status. FIG. 47 is a diagram illustrating a sequence example of a first operational example according to the sixth embodiment. Processes which are the same as the first operational example of the fifth embodiment, and the like, are labeled with the same reference numerals.

In this sixth embodiment, the serving base station 200a carries out transmission possible/not possible judgment (S76) and determines the forwarding data (S80). For example, the serving base station 200a is able to carry out the same processing as the fifth embodiment (see FIG. 35 and FIG. 37, for example) in relation to the transmission possible/not possible judgment process and the forwarding data determination process.

The serving base station 200a forwards the forwarding data (S22) which is determined by the forwarding data determination process (S80), and then transmits PDUs awaiting transmission (S77) if it is decided to transmit the PDUs awaiting transmission by the transmission possible/not possible judgment (S76).

Here, the forwarding data determination unit 243 (or the handover decision unit 241) judges whether or not the predicted transmission time is less than the maximum reservable time, in relation to the transmission possible/not possible judgment process (S76, see FIG. 35 for example), but the maximum reservable time is different to that of the fifth embodiment. For example, in FIG. 36A or FIG. 36B, the maximum reservable time (*2) is from the handover decision (S19) until immediately before handover is established (S78), similarly to the fifth embodiment, but the handover is established by the transmission of downlink allocation information. The downlink allocation information includes identification information relating to the handover destination base station, for example, and therefore in the sixth embodiment, the serving base station 200a establishes handover by transmitting this allocation information.

For example, similarly to the second embodiment, the maximum reservable time can be stored in the memory unit 230, or the like, and read out as and when appropriate by the transmission possible/not possible judgment process (S76) or a forwarding data determination process (S80), or the like.

Furthermore, similarly to the fifth embodiment, the predicted transmission time (*1) is the time from the handover decision until the end of transmission of the PDUs awaiting transmission, and this time can be calculated by the forwarding data determination unit 243, or the like, based on the number of PDUs awaiting transmission and the transmission time.

In the sixth embodiment, the transmission possible/not possible judgment process (see FIG. 35, for example) can be implemented similarly to the fifth embodiment, apart from the fact that the maximum reservable time is different. Furthermore, the forwarding data determination process (FIG. 37, for example) can be implemented similarly to the fifth embodiment, apart from the fact that the maximum reservable time is different.

If the retransmission is occurred, for example (“retransmission” at S801 in FIG. 37), then SDU-A which includes a PDU having sequence number SN3 can be set as the forwarding data. Furthermore, even if no retransmission is occurred, if the data awaiting transmission cannot be transmitted (No at S802 in FIG. 37), then SDU-A which includes the PDU having sequence number SN5 can be set as the forwarding data. Moreover, if no retransmission is occurred and if the data awaiting transmission can be transmitted (Yes at S802 in FIG. 37), then SDU-B which includes the PDU having sequence number SN7 can be set as the forwarding data. The serving base station 200a can also report the sequence number determined in this way, to the target base station 200b (S24).

Thereupon, the serving base station 200a establishes handover (S78), and transmits downlink allocation information to the terminal 100 (S90). Thereafter, the processing is the same as the fifth embodiment.

In this first operational example, after a handover decision (S19), the serving base station 200a recovers data forwarding (S20), and then transmits a handover request to the target base station 200b. The handover request can be transmitted between the handover decision (S19) and the recovery of data forwarding (S20), for example.

<Second Operational Example and Third Operational Example>

The sixth embodiment differs from the fifth embodiment in that, as described in the first operational example above, a forwarding data determination process is carried out (S80 in FIG. 47) and then data awaiting transmission is transmitted (S77), but the processing apart from this is virtually the same as the fifth embodiment.

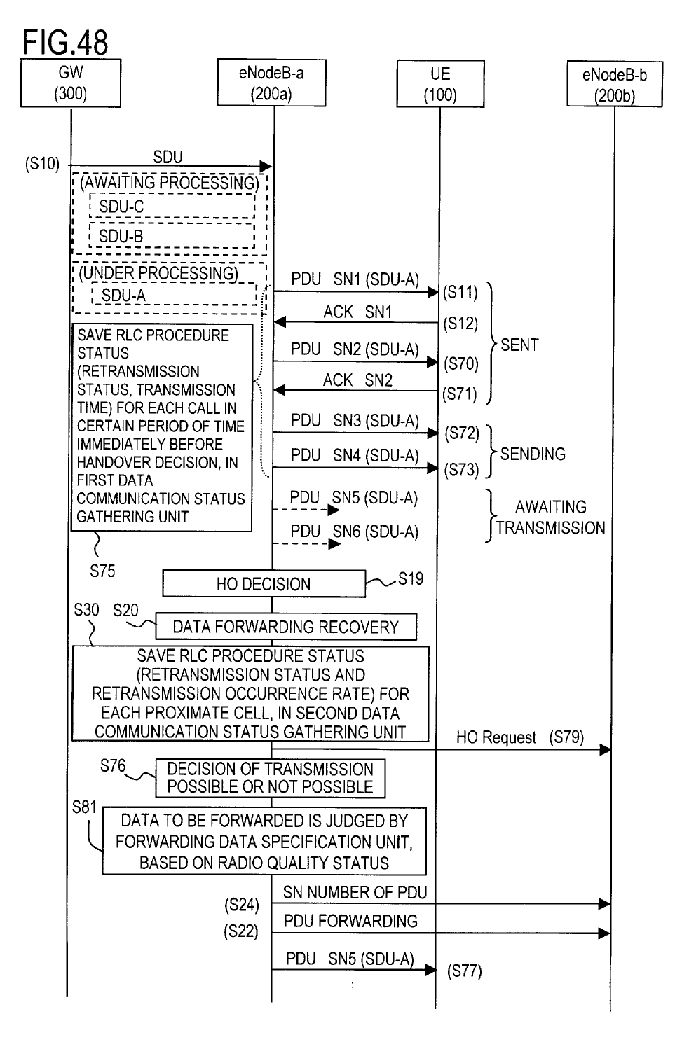

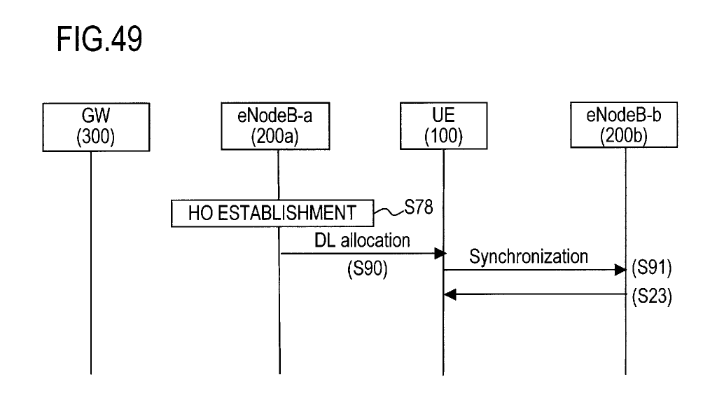

FIG. 48 and FIG. 49 respectively illustrate sequence examples according to the second operational example, for instance. Similarly to the second operational example of the fifth embodiment, the serving base station 200a holds the retransmission status (or the presence or absence of the retransmission), and the transmission time, in the retransmission information table 231 (S75), calculates the retransmission occurrence rate, and the like, and stores this information in the statistical information table 232 (S30).

The serving base station 200a judges whether or not transmission is possible in respect of the PDUs awaiting transmission (S76), and determines the forwarding data based on the statistical information table 232 (S81). The transmission possible/not possible judgment process and the forwarding data determination process can also be carried out similarly to the second operational example of the fifth embodiment (see FIG. 35 and FIG. 39, for example).

However, similarly to the first operational example, the serving base station 200a establishes handover (S78) immediately before transmitting the downlink allocation information, and the maximum reservable time is a different time to that of the fifth embodiment.

The serving base station 200a transmits the forwarding data to the target base station 200b (S22), and if the PDUs awaiting transmission can be transmitted, transmits these PDUs (S77). Thereupon, the serving base station 200a establishes handover (S78 in FIG. 49), and transmits downlink allocation information (DL allocation) to the terminal 100. Thereafter, the processing carried out is the same as the first operational example in the sixth embodiment.

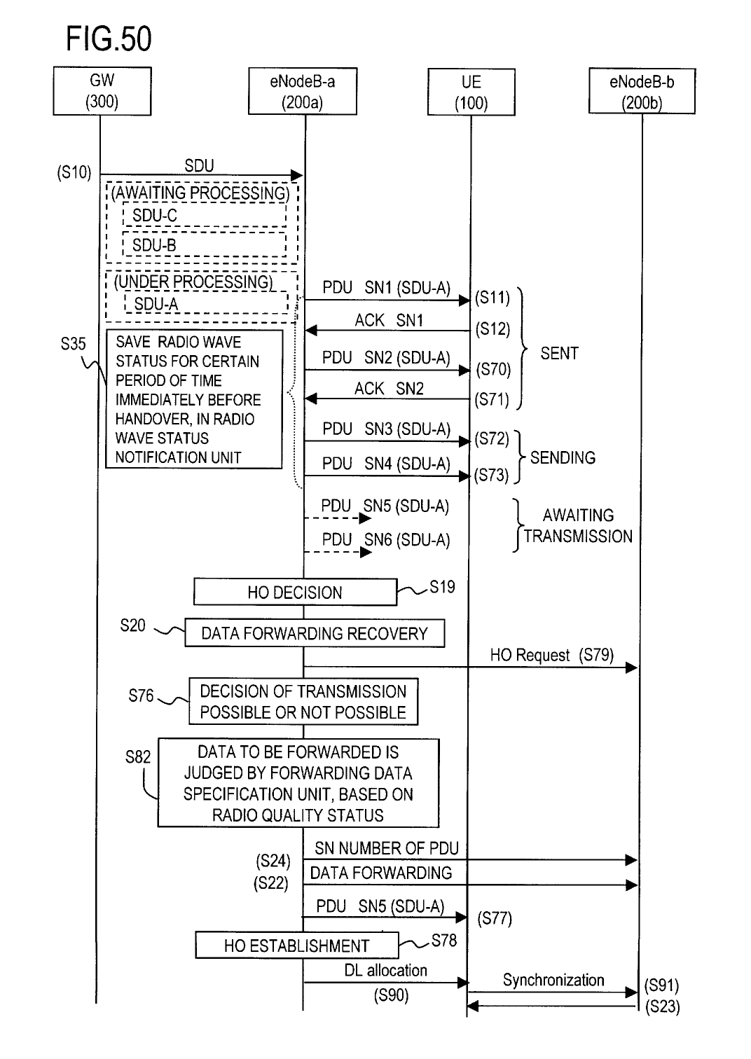

Next, a third operational example will be described. FIG. 50 is a diagram illustrating a sequence example according to the third operational example. The serving base station 200a saves the radio wave condition in the radio wave condition table 233 (S35), and after deciding whether or not transmission is possible (S76), determines the forwarding data based on the saved radio wave condition table 233 (S82).

The serving base station 200a transmits the forwarding data to the target base station 200b, and if the PDUs awaiting transmission can be transmitted, transmits these PDUs (S77). Thereupon, the serving base station 200a establishes handover (S78), and transmits downlink allocation information (DL allocation) to the terminal 100 (S90). Thereafter, the processing carried out is the same as the first operational example in the sixth embodiment.

<Fourth Operational Example>

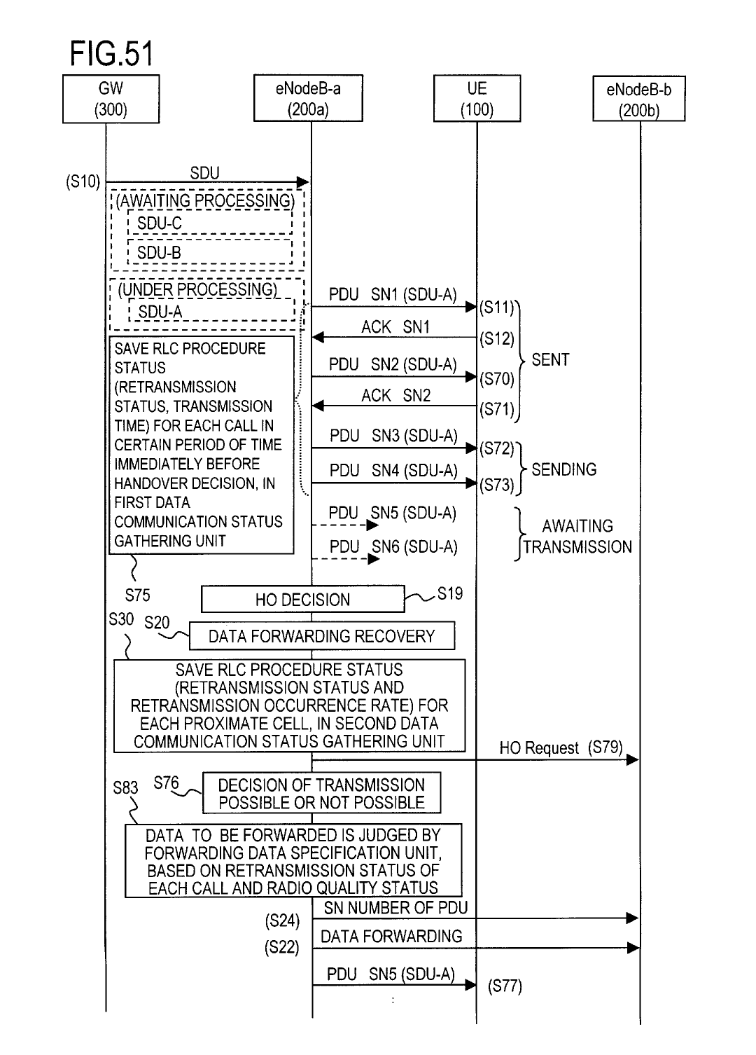

Next, operational examples which combine the first to third operational examples will be described. In these respective cases, the processing differs from the fifth embodiment in that a forwarding data determination process is carried out (S83 in FIG. 51, for example), whereupon the data awaiting transmission is transmitted (S77), and the processing apart from this is virtually the same as the fifth embodiment.

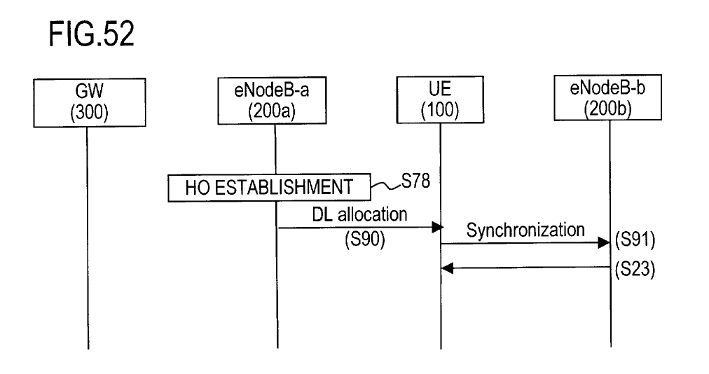

FIG. 51 and FIG. 52 are diagrams illustrating sequence examples of a case where a first operational example (retransmission status for each call) and a second operational example (radio quality based on retransmission occurrence rate) are combined. Similarly to the fourth operational example of the fifth embodiment, the serving base station 200a holds the retransmission status (or the presence or absence of the retransmission), and the transmission time, in the retransmission information table 231 (S75), calculates the retransmission occurrence rate, and the like, and stores this information in the statistical information table 232 (S30).

The serving base station 200a judges whether or not transmission is possible in respect of the PDUs awaiting transmission (S76), and determines the forwarding data based on the retransmission status and the radio quality, and the like (S83). FIG. 42 illustrates a sequence example of a forwarding data determination process in this fourth operational example, for instance, and apart from the fact that the maximum reservable time differs from that of the fifth embodiment, processing can be implemented similarly to the fifth embodiment.

After determining the forwarding data, the serving base station 200a transmits the forwarding data to the target base station 200b (S22), and if it is decided by the transmission possible/not possible judgment (S76) that the PDUs awaiting transmission can be transmitted, then these PDUs are transmitted to the terminal 100 (S77).

Thereupon, the serving base station 200a establishes handover (S78 in FIG. 52), and transmits downlink allocation information (DL allocation) to the terminal 100 (S90). Thereafter, the processing carried out is the same as the first operational example in the sixth embodiment.

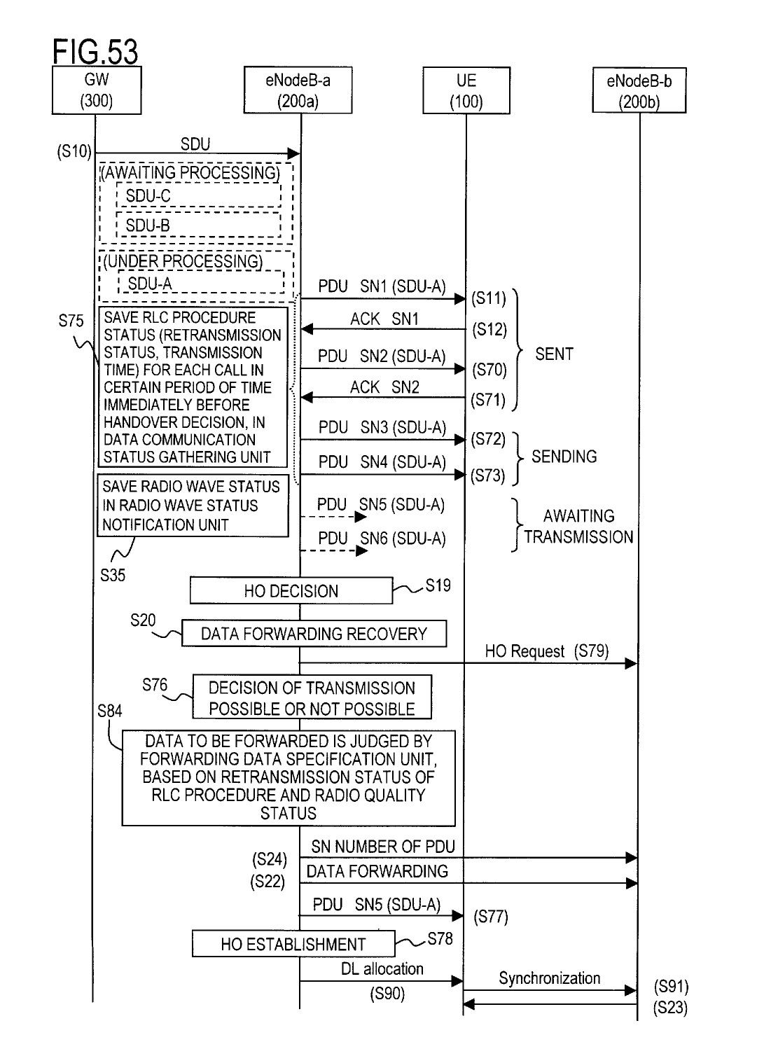

FIG. 53 is a diagram illustrating a sequence example of a case where the first operational example (retransmission status for each call) and the third operational example (radio quality based on radio wave condition) are combined. Similarly to the fourth operational example of the fifth embodiment, the serving base station 200a holds the retransmission status (or the presence or absence of the retransmission), and the transmission time, in the retransmission information table 231 (S75), and stores the radio wave condition in the radio wave condition table 233 (S35).

The serving base station 200a judges whether or not transmission is possible in respect of the PDUs awaiting transmission (S76), and determines the forwarding data based on the retransmission information table 231 and the radio wave condition table 233, and the like (S84). The forwarding data determination process can be implemented in the same manner as the fourth operational example according to the fifth embodiment (see FIG. 42, for example).

After determining the forwarding data, the serving base station 200a transmits the forwarding data to the target base station 200b (S22), and if it is decided by the transmission possible/not possible judgment (S76) that the PDUs awaiting transmission can be transmitted, then these PDUs are transmitted to the terminal 100 (S77). Thereupon, the serving base station 200a establishes handover (S78), and transmits downlink allocation information (DL allocation) to the terminal 100 (S90). Thereafter, the processing carried out is the same as the first operational example in the sixth embodiment.

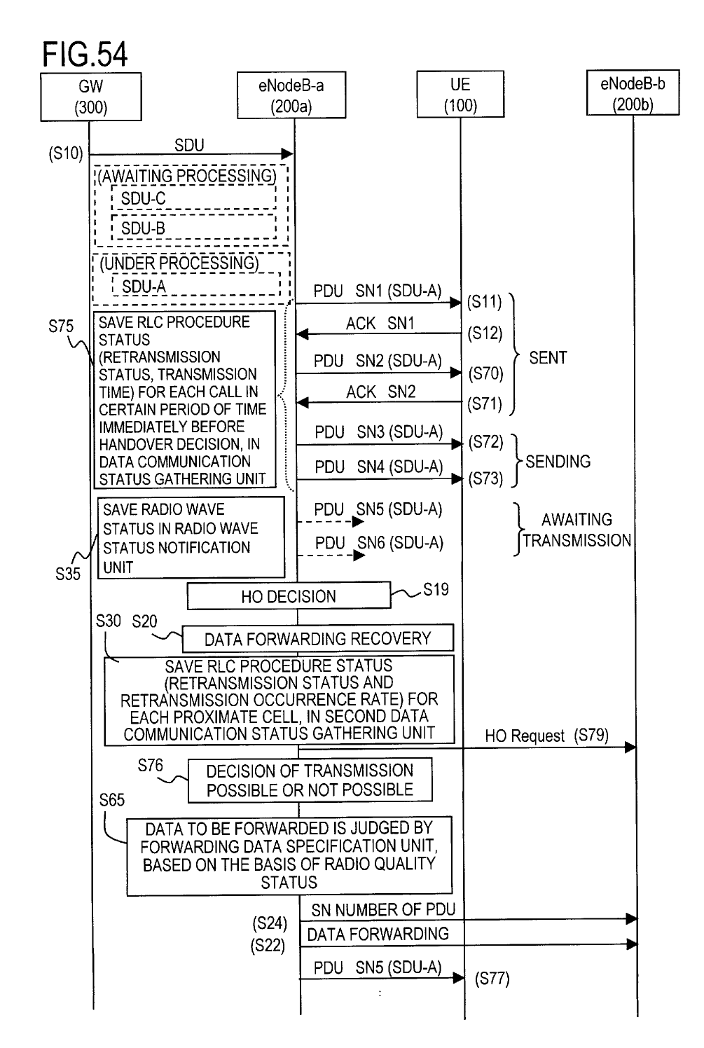

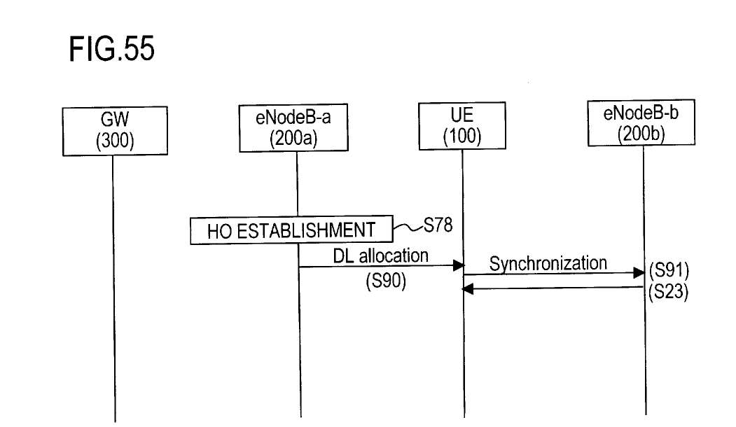

FIG. 54 and FIG. 55 are diagrams illustrating sequence examples of a case where the second operational example and the third operational example are combined. Similarly to the fourth operational example of the fifth embodiment, the serving base station 200a holds the retransmission status (or the presence or absence of the retransmission), and the transmission time, in the retransmission information table 231 (S75), and stores the radio wave condition in the radio wave condition table 233 (S35). Furthermore, the serving base station 200a calculates the retransmission occurrence rate based on the retransmission information table 231 and holds the retransmission status, the retransmission occurrence rate, and the like, in the statistical information table 232 (S30).

The serving base station 200a judges whether or not transmission is possible in respect of the PDUs awaiting transmission (S76), and determines the forwarding data based on the statistical information table 232 and the radio wave condition table 233, and the like (S65). Thereafter, the processing carried out is the same as the first operational example in the sixth embodiment.

First to fourth operational examples relating to the sixth embodiment were described above, but similarly to the fifth embodiment, the serving base station 200a according to the sixth embodiment also transmits data awaiting transmission to the terminal 100, if there is data awaiting transmission and this data can be transmitted. The serving base station 200a does not forward the data awaiting transmission to the target base station 200b.

By this means, data awaiting transmission (for example, PDUs having sequence numbers SN5 to SN6) is not transmitted to the terminal 100 from the target base station 200b, and the target base station 200b does not transmit the data awaiting transmission to the terminal 100 in a duplicated fashion, as well as the serving base station 200a. Furthermore, in this case, the terminal 100 does not receive the data awaiting transmission (for example, sequence numbers SN5 to SN6) from two base stations 200a and 200b, and hence there is no duplicated transmission.

Moreover, since the data awaiting transmission (for example, sequence numbers SN5 to SN6) is transmitted from the serving base station 200a (for example, in step S77), then it is possible to avoid situations where the data awaiting transmission is not transmitted and a data loss occurs.

### Seventh Embodiment

In the second embodiment described above,

1) In a first operational example, for instance, forwarding data is determined based on the retransmission status (presence or absence of the retransmission) which is held by the serving base station 200a for each call.
2) Furthermore, in a second operational example, for instance, forwarding data is determined based on a data communication condition, such as the retransmission occurrence rate, which is held by the serving base station 200a for each adjacent cell.
3) Moreover, in a third operational example, forwarding data is determined based on a radio wave condition between the serving base station 200a (for example, the handover source base station) and the terminal 100.

The second embodiment is described with respect to an example of a combination of the first operational example and the second operational example, and an example of a combination of the first operational example and the third operational example.

Furthermore, in the fourth embodiment, a combination of the second operational example and the third operational example is also described.

In this seventh embodiment, an example of a combination of the first operational example, the second operational example and the third operational example is described. The sequence according to the seventh embodiment can be carried out according to FIG. 31 which was described in the fourth embodiment, for instance.

More specifically, similarly to the fourth operational example, the serving base station 200a holds the retransmission status for each call, in the retransmission information table 231 (S18). FIG. 6 illustrates an example of the retransmission information table 231.

Furthermore, similarly to the fourth embodiment, the serving base station 200a holds the radio quality which is measured at the terminal 100 or the serving base station 200a, as the radio wave condition, in the radio wave condition table 233 (S35). FIG. 17A is a diagram illustrating an example of a radio wave condition table 233.

Moreover, similarly to the fourth operational example, the serving base station 200a stores the retransmission status and the retransmission occurrence rate for each adjacent cell, in the statistical information table 232 (S30). FIG. 13A illustrates an example of the statistical information table 232.

The serving base station 200a judges the radio quality from the held information and determines the forwarding data (S65).

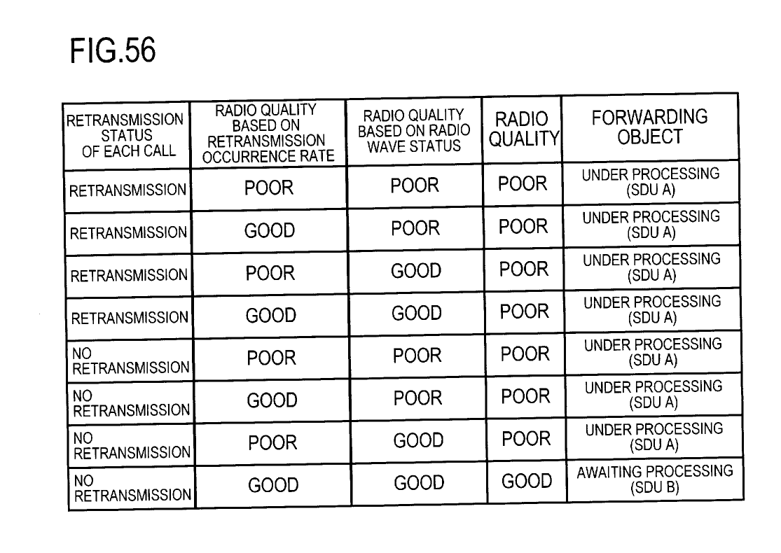

FIG. 56 illustrates judgment examples of how the “radio quality” is judged based on the combination of the three elements: the radio status of each call, the radio wave condition, and the retransmission status of each adjacent cell. For example, the retransmission status for each call which is held in the retransmission information table 231 corresponds to the “retransmission status of each call” in FIG. 56. Moreover, the radio quality based on the retransmission occurrence rate held in the statistical information table 232 corresponds to the “radio quality based on retransmission occurrence rate” in FIG. 56. Furthermore, the radio quality based on the radio wave condition held in the radio wave condition table 233 corresponds to the “radio quality based on radio wave condition” in FIG. 56.

For example, the forwarding data determination unit 243 of the serving base station 200a respectively reads out the retransmission status for each call, the radio quality based on the retransmission occurrence rate and the radio quality based on the radio wave condition, respectively from the three tables 231, 232 and 233 stored in the memory unit 230. The forwarding data determination unit 243 judges that the radio quality is “good” if, as illustrated in FIG. 56, for example, the “retransmission status for each call” is “no” (=no retransmission), and if the “radio quality based on retransmission occurrence rate” and the “radio quality based on radio wave condition” are both “good”. In any other situation, for example, the forwarding data determination unit 243 judges that the “radio quality” is “poor”.

The forwarding data determination unit 243 determines the forwarding data by taking the judgment result for “radio quality” as the judgment result for S301 in FIG. 9B, for example (S302 and S303). In this case, if the “radio quality” is “good”, then the forwarding data determination unit 243 is able to set the “SDUs awaiting processing” (for example, the SDUs from “SDU-B” onwards) as the forwarding data (S302, FIG. 56). On the other hand, if the “radio quality” is “poor”, then the forwarding data determination unit 243 is able to set the “SDUs under processing” (for example, “SDU-A” and the SDUs from “SDU-B” onwards) as the forwarding data (S303, FIG. 56).

In this case, a final judgment of “good” for the “radio quality” also takes account of the “retransmission status for each call”, and therefore the reliability can be raised (enhanced) in comparison with an example where the second operational example and the third operational example are combined (fourth embodiment).

An example which combines all of the first to third operational examples can also be implemented in the fifth embodiment and the sixth embodiment.

For example, FIG. 45 relating to the fifth embodiment illustrates a sequence diagram of a case where there are untransmitted PDUs which does not be transmitted to the terminal 100 before the handover decision, and the forwarding data is determined (S85) after the untransmitted PDUs is transmitted to the terminal 100 (S77). In the fifth embodiment, an operational example which combines the first to third operational examples can be implemented based on FIG. 45, for example.

More specifically, the serving base station 200a stores the retransmission status and transmission time of each call in the retransmission information table 231 (S75). FIG. 34 illustrates an example of the retransmission information table 231.

Furthermore, the serving base station 200a holds the radio quality which is measured at the terminal 100 or the serving base station 200a, as the radio wave condition, in the radio wave condition table 233 (S35). FIG. 17A is a diagram illustrating an example of a radio wave condition table 233.

Moreover, the serving base station 200a then stores the retransmission status and the retransmission occurrence rate for each adjacent cell in the statistical information table 232 (S30). FIG. 13A illustrates an example of the statistical information table 232.

The serving base station 200a judges the radio quality from the held information and determines the forwarding data (S85). The forwarding data can be determined similarly to the examples described above, as illustrated in FIG. 56, for example. In this case, for instance, the forwarding data determination unit 243 can determine the forwarding data similarly to the fifth embodiment, by using the judgment results in S811 of FIG. 39 which illustrates an example of a forwarding data determination process.

Moreover, FIG. 54 in the sixth embodiment, for instance, illustrates a sequence diagram of a case where there are untransmitted PDUs which does not be transmitted to the terminal 100 before the handover decision, and the untransmitted PDUs are transmitted to the terminal 100 (S77) after the forwarding data is determined (S65). In the sixth embodiment, an operational example which combines the first to third operational examples can be implemented based on FIG. 54, for example.

More specifically, the serving base station 200a stores the retransmission status and transmission time of each call in the retransmission information table 231 (S75). FIG. 34 illustrates an example of the retransmission information table 231.

Furthermore, the serving base station 200a holds the radio quality which is measured at the terminal 100 or the serving base station 200a, as the radio wave condition, in the radio wave condition table 233 (S35). FIG. 17A is a diagram illustrating an example of a radio wave condition table 233.

Moreover, the serving base station 200a then stores the retransmission status and the retransmission occurrence rate for each adjacent cell in the statistical information table 232 (S30). FIG. 13A illustrates an example of the statistical information table 232.

The serving base station 200a judges the radio quality from the held information and determines the forwarding data (S65). The forwarding data can be determined similarly to the examples described above, as illustrated in FIG. 56, for example. In this case, for instance, the forwarding data determination unit 243 can determine the forwarding data similarly to the fifth embodiment, by using the judgment result from S811 of FIG. 39, which illustrates an example of a forwarding data determination process.

In the fifth and sixth embodiments, an operational example which combines the first to third operational examples takes account of the “radio status of each call” in the final judgment of “radio quality”, and therefore the reliability can be improved further in comparison with an example where the second and third operational examples are combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

1. A radio base station apparatus for performing radio communication with a mobile terminal apparatus, the radio base station apparatus comprising:
a forwarding data determination unit which determines forwarding data which is to be forwarded to a handover destination radio base station apparatus, based on the presence or absence of retransmission of data to the mobile terminal apparatus; and
a data forwarding processing unit which forwards the determined forwarding data to the handover destination radio base station apparatus.

2. The radio base station apparatus according to claim 1, further comprising a memory unit which stores data to be transmitted to the mobile terminal apparatus, wherein
the forwarding data determination unit determines the forwarding data when handover is decided in respect of the mobile terminal apparatus and the data is stored in the memory unit.

3. The radio base station apparatus according to claim 1, further comprising a memory unit which stores data to be transmitted to the mobile terminal apparatus, wherein
the forwarding data determination unit determines a first data group including data for which a retransmission is performed and a second data group which is stored in the memory unit as the forwarding data, when the retransmission of the data is performed, and determines the second data group which is stored in the memory unit as the forwarding data, when the retransmission of the data does not be performed, and
the data forwarding processing unit forwards the first data group and the second data group to the handover destination radio base station apparatus when the retransmission of the data is performed, and forwards the second data group to the handover destination radio base station apparatus when the retransmission of the data does not be performed.

4. The radio base station apparatus according to claim 1, wherein the forwarding data determination unit determines the forwarding data based on the presence or absence of the retransmission of the data during a monitoring period.

5. The radio base station apparatus according to claim 1, wherein
the forwarding data determination unit determines a sequence number of the data at which transmission from the handover destination radio base station apparatus to the mobile terminal apparatus is to be started, when a data group having one or a plurality of data is determined to be the forwarding data, and
the data forwarding processing unit notifies the determined sequence number to the handover destination radio base station apparatus.

6. The radio base station apparatus according to claim 1, wherein the forwarding data determination unit calculates a retransmission occurrence rate based on the presence or absence of data retransmission, for each handover destination radio base station apparatus, and determines the forwarding data based on a radio quality corresponding to the retransmission occurrence rate.

7. The radio base station apparatus according to claim 6, further comprising a memory unit which stores data to be transmitted to the mobile terminal apparatus, wherein
the forwarding data determination unit judges the retransmission occurrence rate, which is equal to or greater than a threshold value, as a first radio quality and judges the retransmission occurrence rate, which is lower than the threshold value, to be a second radio quality, and determines, to be the forwarding data, a first data group including data which is transmitted to the mobile terminal apparatus and a second data group which is stored in the memory unit when judged that the first radio quality takes effect, and determines, to be the forwarding data, the second data group which is stored in the memory unit when judged that the second radio quality takes effect, and
the data forwarding processing unit forwards the first data group and the second data group to the handover destination radio base station apparatus, when the radio quality is judged to be the first radio quality, and forwards the second data group to the handover destination radio base station apparatus when the radio quality is judged to be the second radio quality.

8. The radio base station apparatus according to claim 6, wherein
the forwarding data determination unit determines a sequence number of the data at which transmission from the handover destination radio base station apparatus to the mobile terminal apparatus is to be started, when a data group having one or a plurality of data elements is determined to be the forwarding data, and
the data forwarding processing unit reports the determined sequence number to the handover destination radio base station apparatus.

9. A radio base station apparatus for performing radio communication with a mobile terminal apparatus, the radio base station apparatus comprising:
a forwarding data determination unit which determines forwarding data to be forwarded to a handover destination radio base station apparatus, based on a radio quality between the radio base station apparatus and the mobile terminal apparatus; and
a data forwarding processing unit which forwards the determined forwarding data to the handover destination radio base station apparatus.

10. The radio base station apparatus according to claim 9, further comprising a memory unit which stores data to be transmitted to the mobile terminal apparatus, wherein
the forwarding data determination unit determines the forwarding data when execution of handover is decided in respect of the mobile terminal apparatus and the data is stored in the memory unit.

11. The radio base station apparatus according to claim 9, wherein the forwarding data determination unit calculates a retransmission occurrence rate based on the presence or absence of a retransmission of the data, for each handover destination radio base station apparatus, and determines the forwarding data based on a radio quality which corresponds to the retransmission occurrence rate.

12. The radio base station apparatus according to claim 11, further comprising a memory unit which stores data to be transmitted to the mobile terminal apparatus, wherein
the forwarding data determination unit judges the radio quality to be a first radio quality when the retransmission occurrence rate is equal to or greater than a threshold value and judges the radio quality to be a second radio quality when the retransmission occurrence rate is lower than the threshold value, and determines a first data group including data which is transmitted to the mobile terminal apparatus and a second data group which is stored in the memory unit, as the forwarding data when judged that the first radio quality takes effect, and determines the second data group which is stored in the memory unit, as the forwarding data, when judged that the second radio quality takes effect, and
the data forwarding processing unit forwards the first data group and the second data group to the handover destination radio base station apparatus, when the radio quality is judged to be the first radio quality, and forwards the second data group to the handover destination radio base station apparatus when the radio quality is judged to be the second radio quality.

13. The radio base station apparatus according to claim 11, wherein
the forwarding data determination unit determines a sequence number of the data at which transmission from the handover destination radio base station apparatus to the mobile terminal apparatus is to be started, when a data group having one or a plurality of data elements is determined to be the forwarding data, and
the data forwarding processing unit reports the determined sequence number to the handover destination radio base station apparatus.

14. The radio base station apparatus according to claim 9, further comprising a memory unit which stores data to be transmitted to the mobile terminal apparatus, wherein
the forwarding data determination unit judges the radio quality to be a third radio quality when the radio quality measured in the mobile terminal apparatus or the radio base station apparatus is equal to or greater than a threshold value and judges the radio quality to be a fourth radio quality when the measured radio quality is lower than the threshold value, and determines a third data group including data which is transmitted to the mobile terminal apparatus and a fourth data group which is stored in the memory unit, as the forwarding data when judged that the third radio quality takes effect, and determines the fourth data group which is stored in the memory unit, as the forwarding data when judged that the fourth radio quality takes effect, and
the data forwarding processing unit forwards the third data group and the fourth data group to the handover destination radio base station apparatus, when the radio quality is judged to be the third radio quality, and forwards the fourth data group to the handover destination radio base station apparatus, when the radio quality is judged to be the fourth radio quality.

15. A radio base station apparatus for performing radio communication with a mobile terminal apparatus, the radio base station apparatus comprising:
a forwarding data determination unit which determines forwarding data to be forwarded to a handover destination radio base station apparatus, based on the presence or absence of a data retransmission to the mobile terminal apparatus and a radio quality between radio base station apparatus and the mobile terminal apparatus; and
a data forwarding processing unit which forwards the determined forwarding data to the handover destination radio base station apparatus.

16. A data forwarding method for a radio base station apparatus for performing radio communication with a mobile terminal apparatus, the method comprising:
determining forwarding data to be forwarded to a handover destination radio base station apparatus, based on the presence or absence of a data retransmission to the mobile terminal apparatus; and
forwarding the determined forwarding data to the handover destination radio base station apparatus.

17. A data forwarding method for a radio base station apparatus for performing radio communication with a mobile terminal apparatus, the method comprising:
determining forwarding data to be forwarded to a handover destination radio base station apparatus, based on a radio quality between the radio base station apparatus and the mobile terminal apparatus; and
forwarding the determined forwarding data to the handover destination radio base station apparatus.

18. A data forwarding method for a radio base station apparatus for performing radio communication with a mobile terminal apparatus, the method comprising:
determining forwarding data to be forwarded to a handover destination radio base station apparatus, based on the presence or absence of a data retransmission to the mobile terminal apparatus and a radio quality between the radio base station apparatus and the mobile terminal apparatus; and
forwarding the determined forwarding data to the handover destination radio base station apparatus.

19. The radio base station apparatus according to claim 9, wherein the forwarding data determination unit determines the forwarding data, based on a first radio quality which corresponds to a retransmission occurrence rate in the handover destination radio base station apparatus that is calculated based on the presence or absence of data retransmission, and a second radio quality which is measured in the mobile terminal apparatus or the radio base station apparatus.

20. The radio base station apparatus according to claim 1, further comprising a memory unit which stores data to be transmitted to the mobile terminal apparatus, wherein
the forwarding data determination unit transmits a first data of data included in the first data group which is stored in the memory unit, to the mobile terminal apparatus when execution of handover of the mobile terminal apparatus to the handover destination radio base station apparatus is decided, and determines the forwarding data based on the presence or absence of a retransmission in respect of the first data, and based on whether or not transmission of a second data included in the first data is possible, when the second data does not be transmitted to the mobile terminal apparatus.
